(19) United States
(12) Patent Application Publication
(10) Pub. No.: US 2024/0120980 A1
(43) Pub. Date: Apr. 11, 2024

(54) CODEBOOK SUBSET RESTRICTION FOR COHERENT JOINT TRANSMISSION

(71) Applicant: Samsung Electronics Co., Ltd., Suwon-si (KR)

(72) Inventors: Gilwon Lee, McKinney, TX (US); Md. Saifur Rahman, Plano, TX (US); Eko Onggosanusi, Coppell, TX (US)

(21) Appl. No.: 18/331,848

(22) Filed: Jun. 8, 2023

Related U.S. Application Data
(60) Provisional application No. 63/352,918, filed on Jun. 16, 2022.
(60) Provisional application No. 63/459,121, filed on Apr. 13, 2023.
(60) Provisional application No. 63/459,901, filed on Apr. 17, 2023.
(60) Provisional application No. 63/461,116, filed on Apr. 21, 2023.
(60) Provisional application No. 63/471,435, filed on Jun. 6, 2023.

(51) Int. Cl. H04B 7/06

(52) U.S. Cl. CPC H04B 7/0626; H04B 7/063

(57) ABSTRACT

Apparatuses and methods for codebook subset restriction for coherent joint transmission in wireless networks. A method includes receiving information about a channel state information (CSI) report associated with N_{TRP}>1 groups of antenna ports. The information indicates (i) a coherent joint transmission (CJT) codebook, (ii) a rank restriction, and (iii) N_{TRP} codebook subset restrictions (CBSRs). The method further includes identifying, based on the rank restriction, a set S₁ of one or more rank values allowed for the CSI report; identifying, based on the N_{TRP} CBSRs, sets S_{2,1}, . . . , S_{2,N}_{_{TRP}}; determining the CSI report associated with the N_{TRP} groups of antenna ports based on the CJT codebook, the set S₁, and the sets S_{2,1}, . . . , S_{2,N}_{_{TRP}}; and transmitting the CSI report. For n=1, . . . , N_{TRP}, the set S_{2,n} is associated with n-th groups of antenna ports of the N_{TRP} groups of antenna ports. The set S_{2,n} includes spatial-domain (SD) basis vectors that are allowed for the CSI report.

### CROSS-REFERENCE TO RELATED APPLICATION AND CLAIM OF PRIORITY

This application claims priority under 35 U.S.C. § 119(e) to U.S. Provisional Patent Application No. 63/352,918 filed on Jun. 16, 2022, U.S. Provisional Patent Application No. 63/459,121 filed on Apr. 13, 2023, U.S. Provisional Patent Application No. 63/459,901 filed on Apr. 17, 2023, U.S. Provisional Patent Application No. 63/461,116 filed on Apr. 21, 2023. and U.S. Provisional Patent Application No. 63/471,435 filed on Jun. 6, 2023. The above-identified provisional patent applications are hereby incorporated by reference in their entirety.

### TECHNICAL FIELD

The present disclosure relates generally to wireless communication systems and, more specifically, to electronic devices and methods for codebook subset restriction for coherent joint transmission (C-JT) in wireless networks.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for codebook subset restriction for coherent joint transmission.

In one embodiment, a user equipment (UE) is provided. The UE includes a transceiver configured to receive information about a channel state information (CSI) report associated with N_{TRP}>1 groups of antenna ports. The information indicates (i) a coherent joint transmission (CJT) codebook, (ii) a rank restriction, and (iii) N_{TRP} codebook subset restrictions (CBSRs). The UE further includes a processor operably coupled to the transceiver. The processor is configured to identify, based on the rank restriction, a set S₁ of one or more rank values allowed for the CSI report, identify, based on the N_{TRP} CBSRs, sets S_{2,1}, . . . , S_{2,N}_{_{TRP}}, and determine the CSI report associated with the N_{TRP} groups of antenna ports based on the CJT codebook, the set S₁, and the sets S_{2,1}, . . . , S_{2,N}_{_{TRP}}. For n=1, . . . , N_{TRP}, the set S_{2,n} is associated with n-th groups of antenna ports of the N_{TRP} groups of antenna ports. The set S_{2,n} includes spatial-domain (SD) basis vectors that are allowed for the CSI report. The transceiver is further configured to transmit the CSI report.

In another embodiment, a base station (BS) is provided. The BS includes a processor configured to identify information about a CSI report associated with N_{TRP}>1 groups of antenna ports. The information indicates (i) a CJT codebook, (ii) a rank restriction, and (iii) N_{TRP} CBSRs. The BS further includes a transceiver operably coupled to the processor. The transceiver is configured to transmit the information to the CSI report and receive the CSI report. The rank restriction indicates a set S₁ of one or more rank values allowed for the CSI report. The N_{TRP} CBSRs indicate sets S_{2,1}, . . . , S_{2,N}_{_{TRP}}. For n=1, . . . , N_{TRP}, the set S_{2,n} is associated with n-th groups of antenna ports of the N_{TRP} groups of antenna ports. The set S_{2,n} includes SD basis vectors that are allowed for the CSI report. The CSI report is associated with the N_{TRP} groups of antenna ports and is based on the CJT codebook, the set S₁, and the sets S_{2,1}, . . . , S_{2,N}_{_{TRP}}.

In yet another embodiment, a method performed by a UE is provided. The method includes receiving information about a CSI report associated with N_{TRP}>1 groups of antenna ports. The information indicates (i) a CJT codebook, (ii) a rank restriction, and (iii) N_{TRP} CBSRs. The method further includes identifying, based on the rank restriction, a set S₁ of one or more rank values allowed for the CSI report; identifying, based on the N_{TRP} CBSRs, sets S_{2,1}, . . . , S_{2,N}_{_{TRP}}, determining the CSI report associated with the N_{TRP} groups of antenna ports based on the CJT codebook, the set S₁, and the sets S_{2,1}, . . . , S_{2,N}_{_{TRP}}; and transmitting the CSI report. For n=1, . . . , N_{TRP}, the set S_{2,n} is associated with n-th groups of antenna ports of the N_{TRP} groups of antenna ports. The set S_{2,n} includes SD basis vectors that are allowed for the CSI report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of. A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIG. 4 illustrates an example antenna blocks or arrays forming beams according to embodiments of the present disclosure;

FIG. 5 illustrates an example distributed multiple-input multiple-output (MIMO) system according to embodiments of the present disclosure;

FIG. 6 illustrates an example distributed MIMO system according to embodiments of the present disclosure;

FIG. 7 illustrates an example antenna port layout according to embodiments of the present disclosure;

FIG. 8 illustrates a 3D grid of oversampled discrete Fourier transform (DFT) beams according to embodiments of the present disclosure;

FIG. 9 illustrates two new codebooks according to embodiments of the present disclosure; and

FIG. 10 illustrates an example method performed by a UE in a wireless communication system according to embodiments of the present disclosure.

### DETAILED DESCRIPTION

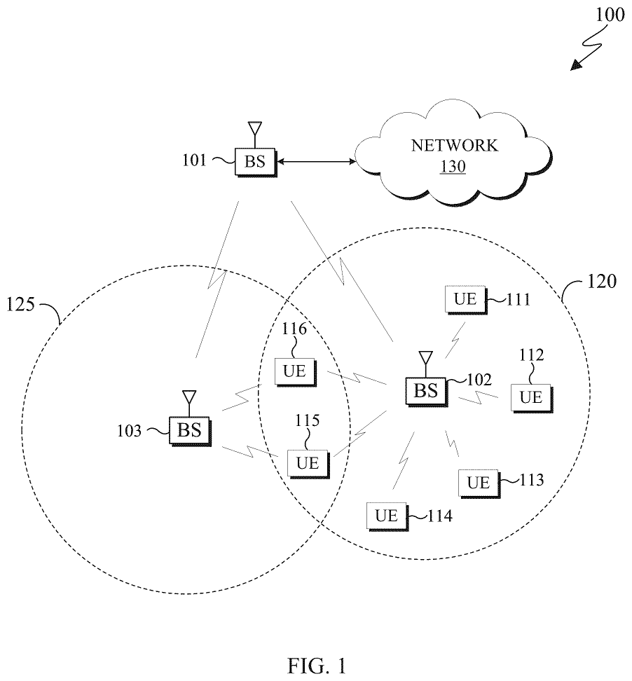

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.2.0, “E-UTRA, Physical channels and modulation” (herein “REF 1”); 3GPP TS 36.212 v17.1.0, “E-UTRA, Multiplexing and Channel coding” (herein “REF 2”); 3GPP TS 36.213 v17.2.0, “E-UTRA, Physical Layer Procedures” (herein “REF 3”); 3GPP TS 36.321 v17.1.0, “E-UTRA, Medium Access Control (MAC) protocol specification” (herein “REF 4”); 3GPP TS 36.331 v17.1.0, “E-UTRA, Radio Resource Control (RRC) Protocol Specification” (herein “REF 5”); 3GPP TS 38.211 v17.2.0, “NR, Physical channels and modulation” (herein “REF 6”); 3GPP TS 38.212 v17.2.0, “NR, Multiplexing and Channel coding” (herein “REF 7”); 3GPP TS 38.213 v17.2.0, “NR, Physical Layer Procedures for Control” (herein “REF 8”); 3GPP TS 38.214 v17.2.0, “NR, Physical Layer Procedures for Data” (herein “REF 9”); 3GPP TS 38.215 v17.1.0, “NR, Physical Layer Measurements” (herein “REF 10”); 3GPP TS 38.321 v17.1.0, “NR, Medium Access Control (MAC) protocol specification” (herein “REF 11”); 3GPP TS 38.331 v17.1.0, “NR, Radio Resource Control (RRC) Protocol Specification” (herein “REF 12”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting codebook subset restriction for coherent joint transmission. In certain embodiments, one or more of the BSs 101-103 include circuitry, programing, or a combination thereof for supporting codebook subset restriction for coherent joint transmission.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

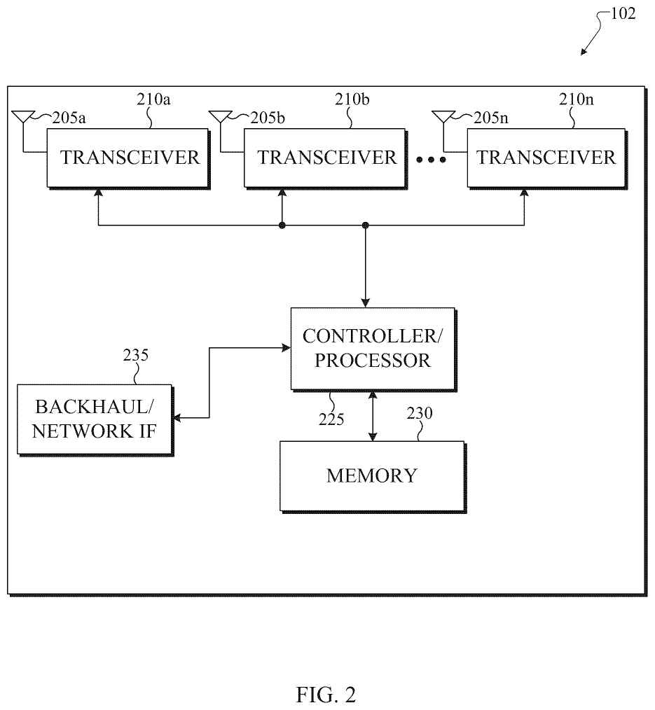

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting codebook subset restriction for coherent joint transmission. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

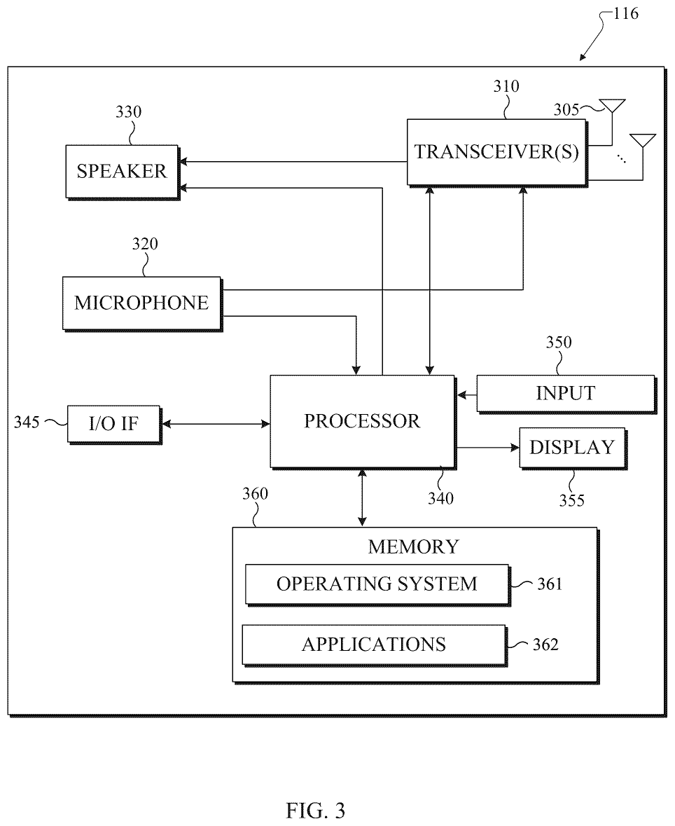

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. As another example, the processor 340 could support methods for codebook subset restriction for coherent joint transmission. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

The 3GPP NR specification supports up to 32 CSI-RS antenna ports which enable a gNB to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase.

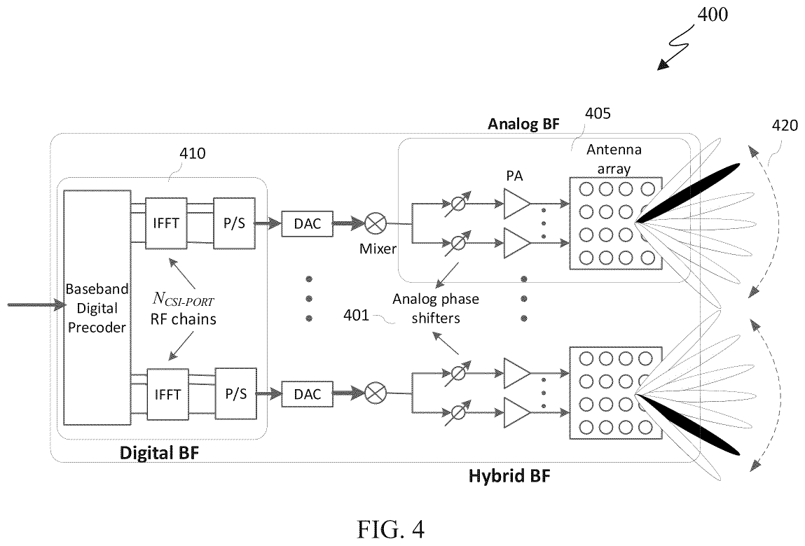

FIG. 4 illustrates an example antenna blocks or arrays 400 according to embodiments of the present disclosure. The embodiment of the antenna blocks or arrays 400 illustrated in FIG. 4 is for illustration only. FIG. 4 does not limit the scope of this disclosure to any particular implementation of the antenna blocks or arrays.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 4. In this case, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes. The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

At lower frequency bands such as <1 GHz, on the other hand, the number of antenna elements may not be large in a given form factor due to the large wavelength. As an example, for the case of the wavelength size (λ) of the center frequency 600 MHz (which is 50 cm), it desires 4 m for uniform-linear-array (ULA) antenna panel of 16 antenna elements with the half-wavelength distance between two adjacent antenna elements. Considering a plurality of antenna elements is mapped to one digital port in practical cases, the desirable size for antenna panel(s) at gNB to support a large number of antenna ports such as 32 CSI-RS ports becomes very large in such low frequency bands, and it leads the difficulty of deploying 2-D antenna element arrays within the size of a conventional form factor. This results in a limited number of CSI-RS ports that can be supported at a single site and limits the spectral efficiency of such systems.

Various embodiments of the present disclosure recognize that for a cellular system operating in a sub-1 GHz frequency range (e.g., less than 1 GHz), supporting large number of CSI-RS antenna ports (e.g., 32) at a single location or remote radio head (RRH) or TRP is challenging due to that a larger antenna form factor size is needed at these frequencies than a system operating at a higher frequency such as 2 GHz or 4 GHz. At such low frequencies, the maximum number of CSI-RS antenna ports that can be co-located at a single site (or TRP/RRH) can be limited, for example to 8. This limits the spectral efficiency of such systems. In particular, the MU-MIMO spatial multiplexing gains offered due to large number of CSI-RS antenna ports (such as 32) can't be achieved.

One way to operate a sub-1 GHz system with large number of CSI-RS antenna ports is based on distributing antenna ports at multiple locations (or TRP/RRHs). The multiple sites or TRPs/RRHs can still be connected to a single (common) base unit, hence the signal transmitted/received via multiple distributed TRPs/RRHs can still be processed at a centralized location. This is called distributed MIMO or multi-TRP coherent joint transmission (C-JT).

Various embodiments of the present disclosure recognize that CSI enhancement described in Rel-18 MIMO considers Rel-16/17 Type-II CSI codebook refinements to support mTRP coherent joint transmission (C-JT) operations by considering performance-and-overhead trade-off. Various embodiments of the present disclosure recognize that utilizing codebook subset restriction (CBSR) is one of the ways to manage CSI feedback overhead. Especially, in multi-TRP C-JT scenarios, CBSR could be useful in terms of reducing overhead.

Accordingly, various embodiments of the present disclosure provide mechanisms for CBSR for multi-TRP C-JT scenarios.

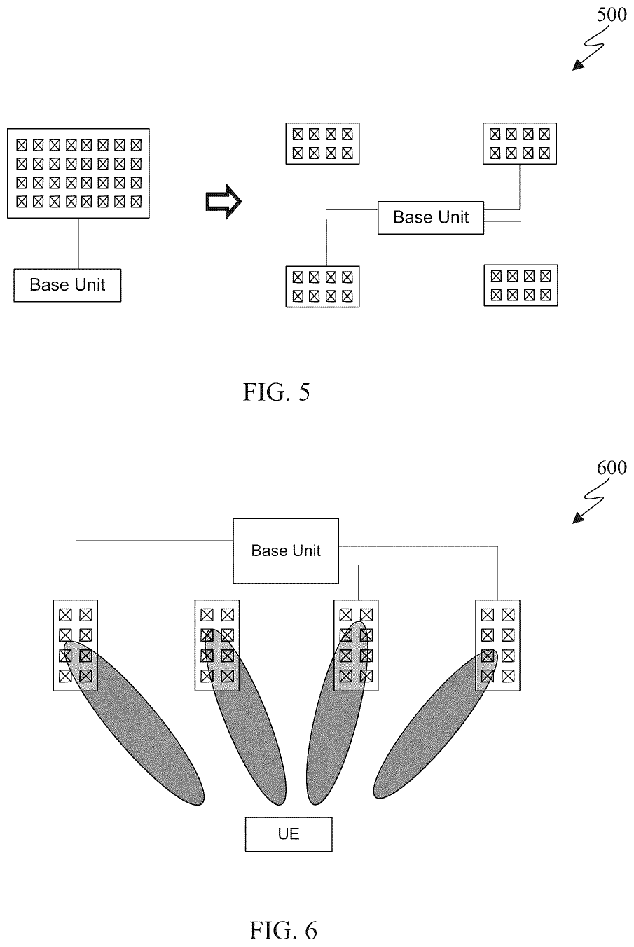

FIG. 5 illustrates an example distributed MIMO system 500 according to embodiments of the present disclosure. The embodiment of the distributed MIMO system 500 illustrated in FIG. 5 is for illustration only. FIG. 5 does not limit the scope of this disclosure to any particular implementation of the distributed MIMO system 500.

One possible approach to resolving the issue is to form multiple TRPs (multi-TRP) or RRHs with a small number of antenna ports instead of integrating all of the antenna ports in a single panel (or at a single site) and to distribute the multiple panels in multiple locations/sites (or TRPs, RRHs). This approach is shown in FIG. 5.

FIG. 6 illustrates an example distributed MIMO system 600 according to embodiments of the present disclosure. The embodiment of the distributed MIMO system 600 illustrated in FIG. 6 is for illustration only. FIG. 6 does not limit the scope of this disclosure to any particular implementation of the distributed MIMO system 600.

As illustrated in FIG. 6, the multiple TRPs at multiple locations can still be connected to a single base unit, and thus the signal transmitted/received via multiple distributed TRPs can be processed in a centralized manner through the single base unit.

Note that although the present disclosure has mentioned low frequency band systems (sub-1 GHz band) as a motivation for distributed MIMO (or mTRP), the distributed MIMO technology is frequency-band-agnostic and can be useful in mid- (sub-6 GHz) and high-band (above-6 GHz) systems in addition to low-band (sub-1 GHz) systems.

The terminology “distributed MIMO” is used as an illustrative purpose, it can be considered under another terminology such as multi-TRP, mTRP, cell-free network, and so on.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

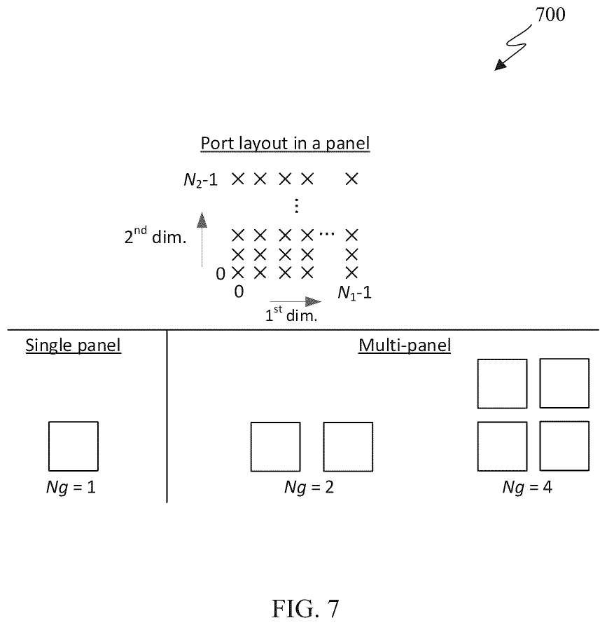

FIG. 7 illustrates an example antenna port layout 700 according to embodiments of the present disclosure. The embodiment of the antenna port layout 700 illustrated in FIG. 13 is for illustration only. FIG. 7 does not limit the scope of this disclosure to any particular implementation of the antenna port layout.

As illustrated in FIG. 7, N₁ and N₂ are the number of antenna ports with the same polarization in the first and second dimensions, respectively. For 2D antenna port layouts, N₁>1, N₂>1, and for 1D antenna port layouts N₁>1 and N₂=1. Therefore, for a dual-polarized antenna port layout, the total number of antenna ports is 2N₁N₂ when each antenna maps to an antenna port. An illustration is shown in FIG. 7 where “X” represents two antenna polarizations. In this disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Let N_{g} be a number of antenna panels at the gNB. When there are multiple antenna panels (N_{g}>1), we assume that each panel is dual-polarized antenna ports with N₁ and N₂ ports in two dimensions. This is illustrated in FIG. 7. Note that the antenna port layouts may or may not be the same in different antenna panels.

In one example, the antenna architecture of a D-MIMO or CJT (coherent joint-transmission) system is structured. For example, the antenna structure at each RRH (or TRP) is dual-polarized (single or multi-panel as shown in FIG. 7. The antenna structure at each RRH/TRP can be the same. Alternatively, the antenna structure at an RRH/TRP can be different from another RRH/TRP. Likewise, the number of ports at each RRH/TRP can be the same. Alternatively, the number of ports at one RRH/TRP can be different from another RRH/TRP. In one example, N_{g}=N_{RRH}, a number of RRHs/TRPs in the D-MIMO transmission.

In another example, the antenna architecture of a D-MIMO or CJT system is unstructured. For example, the antenna structure at one RRH/TRP can be different from another RRH/TRP.

The remainder of the present disclosure assumes a structured antenna architecture. For simplicity, in the remainder of the present disclosure it is assumed that each RRH/TRP is equivalent to a panel, although, an RRH/TRP can have multiple panels in practice. The present disclosure however is not restrictive to a single panel assumption at each RRH/TRP, and can easily be extended (covers) the case when an RRH/TRP has multiple antenna panels.

In one embodiment, an RRH constitutes (or corresponds to or is equivalent to) at least one of the following:
In one example, an RRH corresponds to a TRP.
In one example, an RRH or TRP corresponds to a CSI-RS resource. A UE is configured with K=N_{RRH}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure.
In one example, an RRH or TRP corresponds to a CSI-RS resource group, where a group comprises one or multiple NZP CSI-RS resources. A UE is configured with K≥N_{RRH}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure. In particular, the K CSI-RS resources can be partitioned into N_{RRH} resource groups. The information about the resource grouping can be provided together with the CSI-RS resource setting/configuration, or with the CSI reporting setting/configuration, or with the CSI-RS resource configuration.
In one example, an RRH or TRP corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an RRH/TRP. The information about the subsets of ports or grouping of ports can be provided together with the CSI-RS resource setting/configuration, or with the CSI reporting setting/configuration, or with the CSI-RS resource configuration.
In one example, an RRH or TRP corresponds to one or more examples described above depending on a configuration. For example, this configuration can be explicit via a parameter (e.g., an RRC parameter). Alternatively, it can be implicit.
   In one example, when implicit, it could be based on the value of K. For example, when K>1 CSI-RS resources, an RRH corresponds to one or more examples described above, and when K=1 CSI-RS resource, an RRH corresponds to one or more examples described above.
   In another example, the configuration could be based on the configured codebook. For example, an RRH corresponds to a CSI-RS resource or resource group when the codebook corresponds to a decoupled codebook (modular or separate codebook for each RRH), and an RRH corresponds to a subset (or a group) of CSI-RS ports when codebook corresponds to a coupled (joint or coherent) codebook (one joint codebook across TRPs/RRHs).

In one example, when RRH or TRP maps (or corresponds to) a CSI-RS resource or resource group, and a UE can select a subset of RRHs (resources or resource groups) and report the CSI for the selected TRPs/RRHs (resources or resource groups), the selected TRPs/RRHs can be reported via an indicator. For example, the indicator can be a CRI or a PMI (component) or a new indicator.

In one example, when RRH or TRP maps (or corresponds to) a CSI-RS port group, and a UE can select a subset of TRPs/RRHs (port groups) and report the CSI for the selected TRPs/RRHs (port groups), the selected TRPs/RRHs can be reported via an indicator. For example, the indicator can be a CRI or a PMI (component) or a new indicator.

In one example, when multiple (K>1) CSI-RS resources are configured for N_{RRH} TRPs/RRHs, a decoupled (modular) codebook is used/configured, and when a single (K=1) CSI-RS resource for N_{RRH} TRPs/RRHs, a joint codebook is used/configured.

As described in U.S. Pat. No. 10,659,118, issued May 19, 2020, and entitled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination-based Type II CSI reporting framework is extended to include a frequency dimension in addition to the first and second antenna port dimensions.

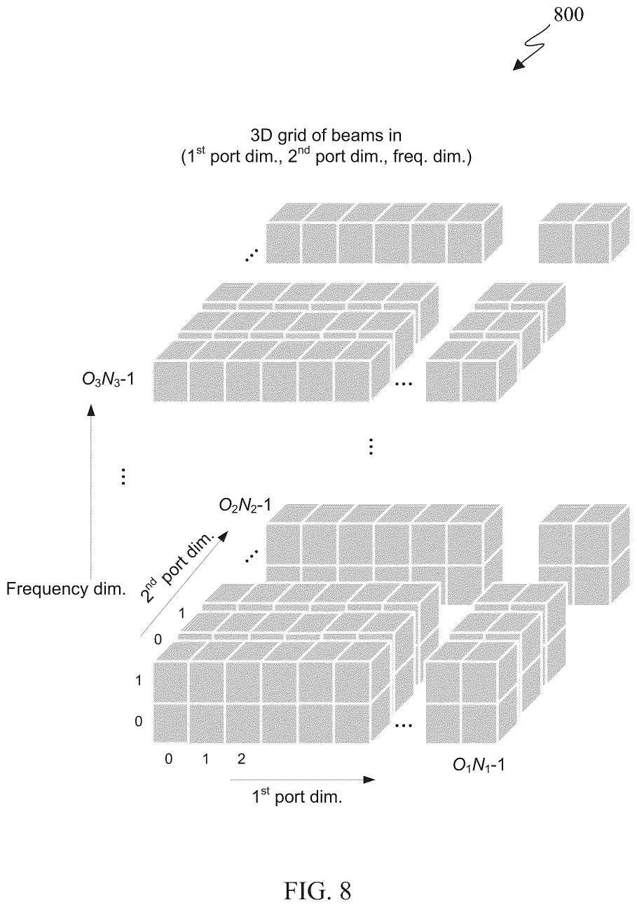

FIG. 8 illustrates a 3D grid of oversampled DFT beams 800 according to embodiments of the present disclosure. The embodiment of the 3D grid of oversampled DFT beams 800 illustrated in FIG. 8 is for illustration only. FIG. 8 does not limit the scope of this disclosure to any particular implementation of the 3D grid of oversampled DFT beams.

As illustrated, FIG. 8 shows a 3D grid 800 of the oversampled DFT beams (1st port dim., 2nd port dim., freq. dim.) in which
a 1st dimension is associated with the 1st port dimension,
a 2nd dimension is associated with the 2nd port dimension, and
a 3rd dimension is associated with the frequency dimension.

The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In one example, O₁=O₂=4 and O₃=1. In another example, the oversampling factors Oᵢ belongs to {2, 4, 8}. In yet another example, at least one of O₁, O₂, and O₃ is higher layer configured (via RRC signaling).

As explained in Section 5.2.2.2.6 of REF8, a UE is configured with higher layer parameter codebookType set to ‘typeII-PortSelection-r16’ for an enhanced Type II CSI reporting in which the pre-coders for all SBs and for a given layer l=1, . . . , v, where v is the associated RI value, is given by either

$${W}^{l} = A {C}_{l} {B}^{H} = {[ {a}_{0} {a}_{1} … {a}_{L - 1} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ {b}_{0} {b}_{1} … {b}_{M - 1} ]}^{H} = {\sum }_{f = 0}^{{M - 1}_{}} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) , \qquad ( Eq . 1 )$$

$$or$$

$${W}^{l} = [ \begin{matrix}A & 0 \\ 0 & A\end{matrix} ] {C}_{l} {B}^{H} = [ \begin{matrix}{a}_{0} {a}_{1} … {a}_{L - 1} & 0 \\ 0 & {a}_{0} {a}_{1} … {a}_{L - 1}\end{matrix} ] {[ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ {b}_{0} {b}_{1} … {b}_{M - 1} ]}^{H} = [ \begin{matrix}{\sum }_{f = 0}^{{M - 1}_{}} {\sum }_{i = 0}^{L - 1} {c}_{l , i , f} ( {a}_{i} {b}_{f}^{H} ) \\ {\sum }_{f = 0}^{{M - 1}_{}} {\sum }_{i = 0}^{L - 1} {c}_{l , i + L , f} ( {a}_{i} {b}_{f}^{H} )\end{matrix} ] , \qquad ( Eq . 2 )$$

where:
N₁ is a number of antenna ports in a first antenna port dimension (having the same antenna polarization),
N₂ is a number of antenna ports in a second antenna port dimension (having the same antenna polarization),
P_{CSI-RS} is a number of CSI-RS ports configured to the UE,
N₃ is a number of SBs for PMI reporting or number of FD units or number of FD components (that comprise the CSI reporting band) or a total number of precoding matrices indicated by the PMI (one for each FD unit/component),
aᵢ is a 2N₁N₂×1 (Eq. 1) or N₁N₂×1 (Eq. 2) column vector, or aᵢ is a P_{CSIRS}×1 (Eq. 1) or

$$\frac{{P}_{CSIRS}}{2} \times 1$$

port selection column vector, where a port selection vector is a defined as a vector which contains a value of 1 in one element and zeros elsewhere,
b_{f} is a N₃×1 column vector,
c_{l,i,f} is a complex coefficient.

In a variation, when the UE reports a subset K<2LM coefficients (where K is either fixed, configured by the gNB or reported by the UE), then the coefficient c_{l,i,f} in precoder equations Eq. 1 or Eq. 2 is replaced with x_{l,i,f}×c_{l,i,f}, where
x_{l,i,f}=1 if the coefficient c_{l,i,f} is reported by the UE according to some embodiments of this disclosure.
x_{l,i,f}=0 otherwise (i.e., c_{l,i,f} is not reported by the UE).

The indication whether x_{l,i,f}=1 or 0 is according to some embodiments of this disclosure. For example, it can be via a bitmap.

In a variation, the precoder equations Eq. 1 or Eq. 2 are respectively generalized to

$${W}^{l} = {\sum }_{i = 0}^{L - 1} {\sum }_{f = 0}^{{M}_{i} - 1} {c}_{l , i , f} ( {a}_{i} {b}_{i , f}^{H} ) \qquad ( Eq . 3 )$$

$$and$$

$${W}^{l} = [ \begin{matrix}{\sum }_{i = 0}^{L - 1} {\sum }_{f = 0}^{{M}_{i} - 1} {c}_{l , i , f} ( {a}_{i} {b}_{i , f}^{H} ) \\ {\sum }_{i = 0}^{L - 1} {\sum }_{= 0}^{{M}_{i} - 1} {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ} or Σ Mᵢ is either fixed, configured by the gNB or reported by the UE).

The columns of W^{l} are normalized to norm one. For rank R or R layers (υ=R), the pre-coding matrix is given by

$${W}^{( R )} = \frac{1}{\sqrt{R}} [ \begin{matrix}{W}^{1} & {W}^{2} & … & {W}^{R} ] .\end{matrix}$$

Eq. 2 is assumed in the rest of the disclosure. The embodiments of the disclosure, however, are general and are also application to Eq. 1, Eq. 3 and Eq. 4.

Here

$$L \leq \frac{{P}_{CSI - RS}}{2}$$

### and M≤N₃. If

$$L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=w_{f}, where the quantity w_{f} is given by

$${w}_{f} = {[ \begin{matrix}1 & {e}^{j \frac{2 π {n}_{3 , l}^{( f )}}{{O}_{3} {N}_{3}}} & {e}^{j \frac{2 π \text{.2} {n}_{3 , l}^{( f )}}{{O}_{3} {N}_{3}}} & … & {e}^{j \frac{2 π . ( {N}_{3} - 1 ) {n}_{3 , l}^{( f )}}{{O}_{3} {N}_{3}}}\end{matrix} ]}^{T} .$$

When O₃=1, the FD basis vector for layer l∈{1, . . . , v} (where v is the RI or rank value) is given by

w_{f}[y_{0,l}^{(f)} y_{1,l}^{(f)} . . . y_{N}_{₃}_{-1,l}^{(f)}]^{T},

where

$${y}_{t , l}^{( f )} = {e}^{j \frac{2 π {tn}_{3 , l}^{( f )}}{{N}_{3}}}$$

and n_{3,l}=[n_{3,l}⁽⁰⁾, . . . , n_{3,l}^{(M-1)}] where n_{3,l}^{(f)}∈{0, 1, . . . , N₃−1}.

In another example, discrete cosine transform DCT basis is used to construct/report basis B for the 3^{rd} dimension. The m-th column of the DCT compression matrix is simply given by

$${[ {W}_{f} ]}_{nm} = \{ \begin{matrix}\frac{1}{\sqrt{K}} , & n = 0 \\ \sqrt{\frac{2}{K}} cos \frac{π ( 2 m + 1 ) n}{2 K} , & n = 1 , ... K - 1\end{matrix} , \\ and K = {N}_{3} , and m = 0 , ... , {N}_{3} - 1.$$

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W^{l} can be described as follows.

W=AₗCₗBₗ^{H}=W₁\tilde{W}₂W_{f}^{H}, (Eq. 5)

where A=W₁ corresponds to the Rel. 15 W₁ in Type II CSI codebook [REF8], and B=W_{f}.

The Cₗ=\tilde{W}₂ matrix consists of all the required linear combination coefficients (e.g., amplitude and phase or real or imaginary). Each reported coefficient (c_{l,i,f}=p_{l,i,f}ϕ_{l,i,f}) in \tilde{W}₂ is quantized as amplitude coefficient (p_{l,i,f}) and phase coefficient (ϕ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as p_{l,i,f}=p_{l,i,f}⁽¹⁾p_{l,i,f}⁽²⁾ where
p_{l,i,f}⁽¹⁾ is a reference or first amplitude which is reported using an A1-bit amplitude codebook where A1 belongs to {2, 3, 4}, and
p_{l,i,f}⁽²⁾ is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i∈{0, 1, . . . , 2L−1} and frequency domain (FD) basis vector (or beam) f∈{0, 1, . . . , M−1} as c_{l,i,f}, and the strongest coefficient as c_{l,i*,f*}. The strongest coefficient is reported out of the K_{NZ} non-zero (NZ) coefficients that is reported using a bitmap, where K_{NZ}≤K₀=┌β×2LM┐<2LM and β is higher layer configured. The remaining 2LM−K_{NZ} coefficients that are not reported by the UE are assumed to be zero. The following quantization scheme is used to quantize/report the K_{NZ} NZ coefficients.
UE reports the following for the quantization of the NZ coefficients in \tilde{W}₂
   A X-bit indicator for the strongest coefficient index (i*, f*), where X=┌log₂ K_{NZ}┐ or ┌log₂ 2L┐.
      i. Strongest coefficient c_{l,i*,f*}=1 (hence its amplitude/phase are not reported)
   Two antenna polarization-specific reference amplitudes is used.
      i. For the polarization associated with the strongest coefficient c_{l,i*,f*}=1, since the reference amplitude p_{l,i,f}⁽¹⁾=1, it is not reported
      ii. For the other polarization, reference amplitude p_{l,i,f}⁽¹⁾ is quantized to 4 bits.
         1. The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , ... , {( \frac{1}{{2}^{14}} )}^{\frac{1}{4}} \} .$$

For {c_{l,i,f} (i, f)≠(i*, f*)}:
   i. For each polarization, differential amplitudes p_{l,i,f}⁽²⁾ of the coefficients calculated relative to the associated polarization-specific reference amplitude and quantized to 3 bits.
      1. The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

2. Note: The final quantized amplitude p_{l,i,f} is given by p_{l,i,f}⁽¹⁾×p_{l,i,f}⁽²⁾
ii. Each phase is quantized to either 8PSK (Nₚₕ=8) or 16PSK (Nₚₕ=16) (which is configurable).

For the polarization r*∈{0,1} associated with the strongest coefficient c_{l,i*,f*}, we have

$${r}^{*} = ⌊ \frac{{i}^{*}}{L} ⌋$$

and the reference amplitude p_{l,i,f}⁽¹⁾=p_{l,r*}⁽¹⁾=1. For the other polarization r∈{0,1} and r≠r*, we have

$$r = ( ⌊ \frac{{i}^{*}}{L} ⌋ + 1 ) mod 2$$

and the reference amplitude p_{l,i,f}⁽¹⁾=p_{l,r}⁽¹⁾ is quantized (reported) using the 4-bit amplitude codebook mentioned above.

In Rel. 16 enhanced Type II and Type II port selection codebooks, a UE can be configured to report M FD basis vectors. In one example,

$$M = ⌈ p \times \frac{{N}_{3}}{R} ⌉ ,$$

where R is higher-layer configured from {1,2} and p is higher-layer configured from

$$\{ \frac{1}{4} , \frac{1}{2} \} .$$

In one example, the p value is higher-layer configured for rank 1-2 CSI reporting. For rank>2 (e.g., rank 3-4), the p value (denoted by v₀) can be different. In one example, for rank 1-4, (p, v₀) is jointly configured from

$$\{ ( \frac{1}{2} , \frac{1}{4} ) , ( \frac{1}{4} , \frac{1}{4} ) , ( \frac{1}{4} , \frac{1}{8} ) \} ,$$

i.e.,

$$M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting. In one example, M is replaced with Mᵥ to show its dependence on the rank value v, hence p is replaced with pᵥ, v∈{1,2} and v₀ is replaced with pᵥ, v∈{3,4}.

A UE can be configured to report Mᵥ FD basis vectors in one-step from N₃ basis vectors freely (independently) for each layer l∈{1, . . . , v} of a rank v CSI reporting. Alternatively, a UE can be configured to report Mᵥ FD basis vectors in two-step as follows.
In step 1, an intermediate set (InS) comprising N′₃<N₃ basis vectors is selected/reported, wherein the InS is common for all layers.
In step 2, for each layer l∈{1, . . . , v} of a rank v CSI reporting, Mᵥ FD basis vectors are selected/reported freely (independently) from N′₃ basis vectors in the InS.

In one example, one-step method is used when N₃≤19 and two-step method is used when N₃>19. In one example, N′₃=┌αMᵥ┐ where α>1 is either fixed (to 2 for example) or configurable.

The codebook parameters used in the DFT based frequency domain compression (Eq. 5) are (L, pᵥ for v∈{1,2}, pᵥ for v∈{3,4}, β, α, Nₚₕ). The set of values for these codebook parameters are as follows.
L: the set of values is {2,4} in general, except L∈{2,4,6} for rank 1-2, 32 CSI-RS antenna ports, and R=1.

$$( {p}_{υ} for υ ∈ \{ 1 , 2 \} , {p}_{υ} for υ ∈ \{ 3 , 4 \} ) ∈ \{ ( \frac{1}{2} , \frac{1}{4} ) , ( \frac{1}{4} , \frac{1}{4} ) , ( \frac{1}{4} , \frac{1}{8} ) \} .$$

$$β ∈ \{ \frac{1}{4} , \frac{1}{2} , \frac{3}{4} \} .$$

α=2
Nₚₕ=16.
   The set of values for these codebook parameters are as in Table 1.

TABLE 1

pᵥ

| | | v | v | |
|---|---|---|---|---|
| paramCombination | L | ∈ {1, 2} | ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

In Rel. 17 (further enhanced Type II port selecting codebook),

$$M ∈ \{ 1 , 2 \} , L = \frac{{K}_{1}}{2}$$

where K₁=α×P_{CSIRS}, and codebook parameters (M, α, β) are configured from Table 2.

TABLE 2

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

The above-mentioned framework (Eq. 5) represents the precoding-matrices for multiple (N₃) FD units using a linear combination (double sum) over 2L (or K₁) SD beams/ports and Mᵥ FD beams. This framework can also be used to represent the precoding-matrices in time domain (TD) by replacing the FD basis matrix W_{f} with a TD basis matrix Wₜ, wherein the columns of Wₜ comprises Mᵥ TD beams that represent some form of delays or channel tap locations. Hence, a precoder W^{l} can be described as follows.

W=AₗCₗBₗ^{H}=W₁\tilde{W}₂Wₜ^{H}, (Eq. 5A)

In one example, the Mᵥ TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

In one example, the codebook for the CSI report is according to at least one of the following examples.
In one example, the codebook can be a Rel. 15 Type I single-panel codebook (cf. 5.2.2.2.1, TS 38.214).
In one example, the codebook can be a Rel. 15 Type I multi-panel codebook (cf. 5.2.2.2.2, TS 38.214).
In one example, the codebook can be a Rel. 15 Type II codebook (cf. 5.2.2.2.3, TS 38.214).
In one example, the codebook can be a Rel. 15 port selection Type II codebook (cf. 5.2.2.2.4, TS 38.214).
In one example, the codebook can be a Rel. 16 enhanced Type II codebook (cf. 5.2.2.2.5, TS 38.214).
In one example, the codebook can be a Rel. 16 enhanced port selection Type II codebook (cf. 5.2.2.2.6, TS 38.214).
In one example, the codebook can be a Rel. 17 further enhanced port selection Type II codebook (cf. 5.2.2.2.7, TS 38.214).
In one example, the codebook is a new codebook for C-JT CSI reporting.
   In one example, the new codebook is a decoupled codebook comprising the following components:
      Intra-TRP: per TRP Rel. 16/17 Type II codebook components, i.e., SD basis vectors (W1), FD basis vectors (Wf), W2 components (e.g., SCI, indices of NZ coefficients, and amplitude/phase of NZ coefficients).
      Inter-TRP: co-amplitude and co-phase for each TRP.
   In one example, the new codebook is a joint codebook comprising following components:
      Per TRP SD basis vectors (W1)
      Single joint FD basis vectors (Wf)
      Single joint W2 components (e.g., SCI, indices of NZ coefficients, and amplitude/phase of NZ coefficients).

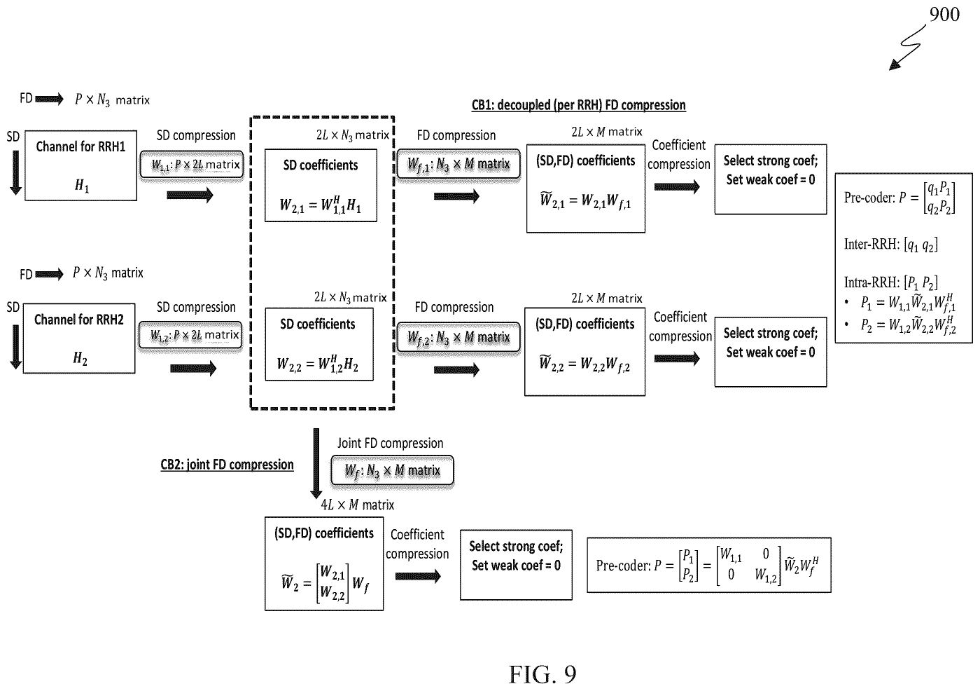

FIG. 9 illustrates two new codebooks 900 according to embodiments of the present disclosure. The embodiment of the two new codebooks 900 illustrated in FIG. 9 is for illustration only. FIG. 9 does not limit the scope of this disclosure to any particular implementation of the two new codebooks 900.

In one example, when the codebook is a legacy codebook (e.g., one of Rel. 15/16/17 NR codebooks, according to one of the examples above), then the CSI reporting is based on a CSI resource set comprising one or multiple NZP CSI-RS resource(s), where each NZP CSI-RS resource comprises CSI-RS antenna ports for all TRPs/RRHs, i.e., P=Σᵣ₌₁^{N} Pᵣ, where P is the total number of antenna ports, and Pᵣ is the number of antenna ports associated with r-th TRP. In this case, a TRP corresponds to (or maps to or is associated with) a group of antenna ports.

In one example, when the codebook is a new codebook (e.g., one of the two new codebooks above), then the CSIreporting is based on a CSI resource set comprising one or multiple NZP CSI-RS resource(s).
In one example, each NZP CSI-RS resource comprises CSI-RS antenna ports for all TRPs/RRHs. i.e., P=Σᵣ₌₁^{N} Pᵣ, where P is the total number of antenna ports, and Pᵣ is the number of antenna ports associated with r-th TRP. In this case, a TRP corresponds to (or maps to or is associated with) a group of antenna ports. A TRP group is a group of multiple TRPs.
In one example, each NZP CSI-RS resource corresponds to (or maps to or is associated with) a TRP/RRH.

In the present disclosure, we use N, N_{TRP}, N_{RRH} interchangeably for a number of TRPs/RRHs.

In one embodiment, a UE is configured with higher layer parameter codebookType set to e.g., ‘typeII-r18-cjt’ for CJT from multiple TRPs as described in this disclosure. A bit-map parameter ‘typeII-RI-Restriction-r18’ is used to indicate which RI or rank value is not allowed to be reported. For example, the bit-map parameter ‘typeII-RI-Restriction-r18’ forms the bit sequence t₃, t₂, t₁, t₀ where t₀ is the LSB and t₃ is the MSB. When tᵢ is zero, i∈{0, 1, . . . , 3}, RI reporting is not allowed to correspond to any precoder associated with v=i+1 layers. In one example, the bit-map parameter ‘typeII-RI-Restriction-r18’ is TRP-common (or TRP-group common), i.e., one common RI value for all TRPs. In one example, the bit-map parameter ‘typeII-RI-Restriction-r18’ is TRP-specific (or TRP-group specific), i.e., one RI value for each TRP.

In one embodiment, a UE is configured with higher layer parameter codebookType set to e.g., ‘typeII-r18-cjt’ for CJT from multiple TRPs as described in this disclosure. For each TRP r=1, . . . , N_{TRP} (or TRP group), a bit-map parameter ‘n1-n2-codebookSubsetRestriction-r18’ is used to indicate restrictions on vector groups and (average) coefficient amplitudes associated with the vectors in the groups.

In one example, for each TRP r=1, . . . , N_{TRP} (or TRP group), the bit-map parameter ‘n1-n2-codebookSubsetRestriction-r18’ forms the bit sequence Bᵣ=B_{1,r}B_{2,r} and configures the vector group indices g^{(k,r)} (similar to as in clause 5.2.2.2.3 of TS 38.214 [9]). Bits b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾ indicate the maximum allowed average amplitude, γ_{i+pL,r} (polarization p=0,1), with i∈{0, 1, . . . , L−1}, of the coefficients associated with the vector in group g^{(k,r)} indexed by x₁, x₂, for example, where the maximum amplitudes are given in Table 5.2.2.2.5-6 of TS 38.214 [9] and the average coefficient amplitude associated with the vector in group g^{(k,r)} is less than or equal to γ_{i+pL,r}. One example is as follows:

$$\sqrt{\frac{1}{{\sum }_{f = 0}^{{M}_{υ} - 1} {k}_{l , i + p L , f , r}^{( 3 )}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + pL , r} .$$

where k_{l,i+pL,f,r}⁽³⁾∈{0,1} is part of the bitmap indicator for TRP r, and indicates whether the corresponding coefficient is zero (when bit value=0) or non-zero (when bit value=1), p_{l,p,r}⁽¹⁾ is a (first) reference amplitude, and p_{l,i+pL,f,r}⁽²⁾ is a (second) differential amplitude coefficient, as described in 5.2.2.2.5 of TS 38.214.

For example, a UE that does not report the parameter ‘softAmpRestriction-r18’=‘supported’ in its capability signaling is not expected to be configured with b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=01 or 10.

In one example, the higher-layer parameter ‘n1-n2-codebookSubsetRestriction-r18’, a joint parameter indicating N₁, N₂, and codebook subset restrictions is TRP-specific, i.e., one parameter ‘n1-n2-codebookSubsetRestriction-r18’ for each TRP. One example for the TRP-specific higher-layer parameter ‘n1-n2-codebookSubsetRestriction-r18’ can be as follows.

| | |
|---|---|
| CodebookConfig-r18 ::= | SEQUENCE { |
| codebookType | CHOICE { |
| type2 | SEQUENCE { |

```
      ...
          n1-n2-codebookSubsetRestriction-r18-trp1 CHOICE {
```

| | |
|---|---|
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

```
          },
          ...
            n1-n2-codebookSubsetRestriction-r18-trp2 CHOICE {
```

| | |
|---|---|
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

```
          },
          ...
          ...
          n1-n2-codebookSubsetRestriction-r18-trpN CHOICE {
```

| | |
|---|---|
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

```
          },
          ...
        },
    }
  }
}
```

In another example, the parameter ‘n1-n2-codebookSubsetRestriction-r18-trp’ is replaced with ‘n1-n2-codebookSubsetRestriction-r18-SP’ (where SP stands for single panel) in the above example, which can be described as follows:

| | |
|---|---|
| CodebookConfig-r18 ::= | SEQUENCE { |
| codebookType | CHOICE { |
| type2 | SEQUENCE { |

```
      ...
          n1-n2-codebookSubsetRestriction-r18-SP#1 CHOICE {
```

| | |
|---|---|
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

```
          },
          ...
            n1-n2-codebookSubsetRestriction-r18-SP#2 CHOICE {
```

| | |
|---|---|
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

```
          },
          ...
          ...
          n1-n2-codebookSubsetRestriction-r18-SP#N CHOICE {
```

| | |
|---|---|
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

```
          },
          ...
        },
    }
  }
}
```

In another example, the parameter can be described in a structured way as a sequence of multiple restrictions (e.g., one for each TRP), which can be described as follows:

| | |
|---|---|
| CodebookConfig-r18 ::= | SEQUENCE { |
| codebookType | CHOICE { |
| type2 | SEQUENCE { |

...

| | |
|---|---|
| n1-n2-codebookSubsetRestriction-r18 | SEQUENCE (SIZE (1..maxNrofSPs)) |

```
OF n1-n2-codebookSubsetRestriction-r18-SP,
          ...
        },
    },
  }
}
...
n1-n2-codebookSubsetRestriction-r18-SP ::= CHOICE {
```

| | |
|---|---|
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

},
...

| | |
|---|---|
| maxNrofSPs | INTEGER ::= 4 |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one embodiment, a UE is configured with a codebook restriction as described herein except that there is a restriction on the configured value of (N₁, N₂). For example, the value of (N₁, N₂) is restricted to be the same pair for all TRPs.

In one example, each configured ‘n1-n2-codebookSubsetRestriction-r18’ is such that N1 and N2 values are the same for all TRPs.

In one example, the length (number of bits) for each n1-n2-codebookSubsetRestriction-r18 is the same for all TRPs.

In one example, the choice of each n1-n2-codebookSubsetRestriction-r18 is the same for all TRPs, for example, each corresponds to two-one, two-two, four-two, . . . or sixteen-one.

In one embodiment, a UE is configured with a codebook restriction as described herein except that only hard amplitude restriction is allowed to configure (not allowing to configure soft amplitude restriction), where the hard amplitude restriction refers that its associated amplitudes can be either restricted to all 0 or no restricted, (hence freely selected using the configured codebook).

For example, it is not allowed to configure b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=01 or 10 with a table such as the following table.

| | Maximum |
|---|---|
| | Average |
| | Coefficient |
| Bit | Amplitude |
| b_{2, r}^{(k, 2(N}^{₁}^{x}^{₂}^{+x}^{₁}⁾⁺¹⁾b_{2, r}^{(k, 2(N}^{₁}^{x}^{₂}^{+x}^{₁}⁾⁾ | γ_{i+pL, r} |
| 00 | 0 |
| 01 | \sqrt{¼} |
| 10 | \sqrt{½} |
| 11 | 1 |

In another example, there is no such a table since the hard restriction allows to configure either its associated amplitudes to be 0 or under no restriction (hence no equation on γ_{i+pL}). For example, a higher-layer parameter to indicate the hard restriction can be according to the following: bit ‘0’ corresponds to its associated amplitudes to be 0, and bit ‘1’ corresponds to it associated amplitudes having no restriction.

In another example, it is allowed to configure b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=0 or 1 with a table such as the following table.

| | Maximum |
|---|---|
| | Average |
| | Coefficient |
| Bit | Amplitude |
| b_{2, r}^{(k, 2(N}^{₁}^{x}^{₂}^{+x}^{₁}⁾⁺¹⁾b_{2, r}^{(k, 2(N}^{₁}^{x}^{₂}^{+x}^{₁}⁾⁾ | γ_{i+pL, r} |
| 0 | 0 |
| 1 | 1 |

In one example, for each example of higher-layer parameters (RRC signaling, or information elements) shown herein, the size of bit string can be computed based on 2-bits for B_{2,r} (instead of 4-bits for B_{2,r}).

In one example, the parameter can be described in a structured way as a sequence of multiple restrictions (e.g., one for each TRP), which can be described as follows:

| | |
|---|---|
| CodebookConfig-r18 ::= | SEQUENCE { |
| codebookType | CHOICE { |
| type2 | SEQUENCE { |

...

| | |
|---|---|
| n1-n2-codebookSubsetRestriction-r18 | SEQUENCE (SIZE (1..maxNrofSPs)) |

```
OF n1-n2-codebookSubsetRestriction-r18-SP,
          ...
        },
    }
  }
}
...
n1-n2-codebookSubsetRestriction-r18-SP ::= CHOICE {
```

| | |
|---|---|
| two-one | BIT STRING (SIZE (8)), |
| two-two | BIT STRING (SIZE (27)), |
| four-one | BIT STRING (SIZE (16)), |
| three-two | BIT STRING (SIZE (35)), |
| six-one | BIT STRING (SIZE (24)), |
| four-two | BIT STRING (SIZE (43)), |
| eight-one | BIT STRING (SIZE (32)), |
| four-three | BIT STRING (SIZE (59)), |
| six-two | BIT STRING (SIZE (59)), |
| twelve-one | BIT STRING (SIZE (48)), |
| four-four | BIT STRING (SIZE (75)), |
| eight-two | BIT STRING (SIZE (75)), |
| sixteen-one | BIT STRING (SIZE (64)) |

},
...

| | |
|---|---|
| maxNrofSPs | INTEGER ::= 4 |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, each example on higher-layer parameters described herein can be extended, similarly, with replacing the following:

| | |
|---|---|
| two-one | BIT STRING (SIZE (16)), |
| two-two | BIT STRING (SIZE (43)), |
| four-one | BIT STRING (SIZE (32)), |
| three-two | BIT STRING (SIZE (59)), |
| six-one | BIT STRING (SIZE (48)), |
| four-two | BIT STRING (SIZE (75)), |
| eight-one | BIT STRING (SIZE (64)), |
| four-three | BIT STRING (SIZE (107)), |
| six-two | BIT STRING (SIZE (107)), |
| twelve-one | BIT STRING (SIZE (96)), |
| four-four | BIT STRING (SIZE (139)), |
| eight-two | BIT STRING (SIZE (139)), |
| sixteen-one | BIT STRING (SIZE (128)) |

by the following:

| | |
|---|---|
| two-one | BIT STRING (SIZE (8)), |
| two-two | BIT STRING (SIZE (27)), |
| four-one | BIT STRING (SIZE (16)), |
| three-two | BIT STRING (SIZE (35)), |
| six-one | BIT STRING (SIZE (24)), |
| four-two | BIT STRING (SIZE (43)), |
| eight-one | BIT STRING (SIZE (32)), |
| four-three | BIT STRING (SIZE (59)), |
| six-two | BIT STRING (SIZE (59)), |
| twelve-one | BIT STRING (SIZE (48)), |
| four-four | BIT STRING (SIZE (75)), |
| eight-two | BIT STRING (SIZE (75)), |
| sixteen-one | BIT STRING (SIZE (64)) |

As shown in the example above, the bit width for B_{2,r} is changed from 2N₁N₂×4 to 2N₁N₂×2, and the bit width for B_{1,r} is maintained as 11 bits for N₂>1 or 0 bits for N₂=1.

In one embodiment, a UE is configured with higher layer parameter codebookType set to, e.g., ‘typeII-r18-cjt’. Two high-layer parameters are used, one to configure N₁, N₂ values and another to configure codebook subset restrictions, respectively. For example, a first higher-layer parameter can be denoted as ‘n1-n2’ and a second higher-layer parameter can be denoted as ‘codebookSubsetRestriction-r18’.

In one example, the first parameter ‘n1-n2’ is TRP-common (or TRP-group common), i.e., the same/common value of (N₁, N₂) for all TRPs is configured with the first parameter. The second higher-layer parameter ‘codebookSubsetRestriction-r18’ is a bit-map parameter used to indicate restrictions on vector groups and (average) coefficient amplitudes associated with the vectors in the groups. For each TRP r=1, . . . , N_{TRP} (or TRP group), the bit-map parameter ‘codebookSubsetRestriction-r18’ forms the bit sequence Bᵣ=B_{1,r}B_{2,r} and configures the vector group indices g^{(k,r)} (similar to as in clause 5.2.2.2.3 of TS 38.214 [9]). Bits b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾ indicate the maximum allowed average amplitude, γ_{i+pL,r} (p=0,1), with i∈{0, 1, . . . , L−1}, of the coefficients associated with the vector in group g^{(k,r)} indexed by x₁, x₂, for example, where the maximum amplitudes are given in Table 5.2.2.2.5-6 of TS 38.214 [9] and the average coefficient amplitude associated with the vector in group g^{(k,r)} is less than or equal to γ_{i+pL,r}. One example is as follows:

$$\sqrt{\frac{1}{{\sum }_{f = 0}^{{M}_{υ} - 1} {k}_{l , i + p L , f , r}^{( 3 )}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + pL , r} .$$

where k_{l,i+pL,f,r}⁽³⁾∈{0,1} is part of the bitmap indicator for TRP r, and indicates whether the corresponding coefficient is zero (when bit value=0) or non-zero (when bit value=1), p_{l,p,r}⁽¹⁾ is a (first) reference amplitude, and p_{l,i+pL,f,r}⁽²⁾ is a (second) differential amplitude coefficient, as described in 5.2.2.2.5 of TS 38.214.

For example, a UE that does not report the parameter ‘softAmpRestriction-r18’=‘supported’ in its capability signaling is not expected to be configured with b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=01 or 10.

In one example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |
| codebookSubsetRestriction-r18-trp1 | BIT STRING (SIZE (16)), |
| codebookSubsetRestriction-r18-trp2 | BIT STRING (SIZE (16)), |

...

| | |
|---|---|
| codebookSubsetRestriction-r18-trpN | BIT STRING (SIZE (16)), |

},

| | |
|---|---|
| two-two | SEQUENCE { |
| codebookSubsetRestriction-r18-trp1 | BIT STRING (SIZE (43)), |
| codebookSubsetRestriction-r18-trp2 | BIT STRING (SIZE (43)), |

...

| | |
|---|---|
| codebookSubsetRestriction-r18-trpN | BIT STRING (SIZE (43)), |

},

| | |
|---|---|
| four-one | SEQUENCE { |
| codebookSubsetRestriction-r18-trp1 | BIT STRING (SIZE (32)), |
| codebookSubsetRestriction-r18-trp2 | BIT STRING (SIZE (32)), |

...

| | |
|---|---|
| codebookSubsetRestriction-r18-trpN | BIT STRING (SIZE (32)), |

},

| | |
|---|---|
| three-two | SEQUENCE { |
| codebookSubsetRestriction-r18-trp1 | BIT STRING (SIZE (59)), |
| codebookSubsetRestriction-r18-trp2 | BIT STRING (SIZE (59)), |

...

| | |
|---|---|
| codebookSubsetRestriction-r18-trpN | BIT STRING (SIZE (59)), |

},

| | |
|---|---|
| six-one | SEQUENCE { |
| codebookSubsetRestriction-r18-trp1 | BIT STRING (SIZE (48)), |
| codebookSubsetRestriction-r18-trp2 | BIT STRING (SIZE (48)), |

...

| | |
|---|---|
| codebookSubsetRestriction-r18-trpN | BIT STRING (SIZE (48)), |

},

| | |
|---|---|
| four-two | SEQUENCE { |
| codebookSubsetRestriction-r18-trp1 | BIT STRING (SIZE (75)), |
| codebookSubsetRestriction-r18-trp2 | BIT STRING (SIZE (75)), |

...

| | |
|---|---|
| codebookSubsetRestriction-r18-trpN | BIT STRING (SIZE (75)), |

},

| | |
|---|---|
| eight-one | SEQUENCE { |
| codebookSubsetRestriction-r18-trp1 | BIT STRING (SIZE (64)), |
| codebookSubsetRestriction-r18-trp2 | BIT STRING (SIZE (64)), |

...

| | |
|---|---|
| codebookSubsetRestriction-r18-trpN | BIT STRING (SIZE (64)), |

},

| | |
|---|---|
| four-three | SEQUENCE { |
| codebookSubsetRestriction-r18-trp1 | BIT STRING (SIZE (107)), |
| codebookSubsetRestriction-r18-trp2 | BIT STRING (SIZE (107)), |

...

| | |
|---|---|
| codebookSubsetRestriction-r18-trpN | BIT STRING (SIZE (107)), |

},

| | |
|---|---|
| six-two | SEQUENCE { |
| codebookSubsetRestriction-r18-trp1 | BIT STRING (SIZE (107)), |
| codebookSubsetRestriction-r18-trp2 | BIT STRING (SIZE (107)), |

...

| | |
|---|---|
| codebookSubsetRestriction-r18-trpN | BIT STRING (SIZE (107)), |

},

| | |
|---|---|
| twelve-one | SEQUENCE { |
| codebookSubsetRestriction-r18-trp1 | BIT STRING (SIZE (96)), |
| codebookSubsetRestriction-r18-trp2 | BIT STRING (SIZE (96)), |

...

| | |
|---|---|
| codebookSubsetRestriction-r18-trpN | BIT STRING (SIZE (96)), |

},

| | |
|---|---|
| four-four | SEQUENCE { |
| codebookSubsetRestriction-r18-trp1 | BIT STRING (SIZE (139)), |
| codebookSubsetRestriction-r18-trp2 | BIT STRING (SIZE (139)), |

...

| | |
|---|---|
| codebookSubsetRestriction-r18-trpN | BIT STRING (SIZE (139)), |

},

| | |
|---|---|
| eight-two | SEQUENCE { |
| codebookSubsetRestriction-r18-trp1 | BIT STRING (SIZE (139)), |
| codebookSubsetRestriction-r18-trp2 | BIT STRING (SIZE (139)), |

...

| | |
|---|---|
| codebookSubsetRestriction-r18-trpN | BIT STRING (SIZE (139)), |

},

| | |
|---|---|
| sixteen-one | SEQUENCE { |
| codebookSubsetRestriction-r18-trp1 | BIT STRING (SIZE (128)), |
| codebookSubsetRestriction-r18-trp2 | BIT STRING (SIZE (128)), |

...

| | |
|---|---|
| codebookSubsetRestriction-r18-trpN | BIT STRING (SIZE (128)), |

```
          },
        },
        ...
```

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |
| codebookSubsetRestriction-r18-SP1 | BIT STRING (SIZE (16)), |
| codebookSubsetRestriction-r18-SP2 | BIT STRING (SIZE (16)), |

...

| | |
|---|---|
| codebookSubsetRestriction-r18-SPN | BIT STRING (SIZE (16)), |

},

| | |
|---|---|
| two-two | SEQUENCE { |
| codebookSubsetRestriction-r18-SP1 | BIT STRING (SIZE (43)), |
| codebookSubsetRestriction-r18-SP2 | BIT STRING (SIZE (43)), |

...

| | |
|---|---|
| codebookSubsetRestriction-r18-SPN | BIT STRING (SIZE (43)), |

},

| | |
|---|---|
| four-one | SEQUENCE { |
| codebookSubsetRestriction-r18-SP1 | BIT STRING (SIZE (32)), |
| codebookSubsetRestriction-r18-SP2 | BIT STRING (SIZE (32)), |

...

| | |
|---|---|
| codebookSubsetRestriction-r18-SPN | BIT STRING (SIZE (32)), |

},

| | |
|---|---|
| three-two | SEQUENCE { |
| codebookSubsetRestriction-r18-SP1 | BIT STRING (SIZE (59)), |
| codebookSubsetRestriction-r18-SP2 | BIT STRING (SIZE (59)), |

...

| | |
|---|---|
| codebookSubsetRestriction-r18-SPN | BIT STRING (SIZE (59)), |

},

| | |
|---|---|
| six-one | SEQUENCE { |
| codebookSubsetRestriction-r18-SP1 | BIT STRING (SIZE (48)), |
| codebookSubsetRestriction-r18-SP2 | BIT STRING (SIZE (48)), |

...

| | |
|---|---|
| codebookSubsetRestriction-r18-SPN | BIT STRING (SIZE (48)), |

},

| | |
|---|---|
| four-two | SEQUENCE { |
| codebookSubsetRestriction-r18-SP1 | BIT STRING (SIZE (75)), |
| codebookSubsetRestriction-r18-SP2 | BIT STRING (SIZE (75)), |

...

| | |
|---|---|
| codebookSubsetRestriction-r18-SPN | BIT STRING (SIZE (75)), |

},

| | |
|---|---|
| eight-one | SEQUENCE { |
| codebookSubsetRestriction-r18-SP1 | BIT STRING (SIZE (64)), |
| codebookSubsetRestriction-r18-SP2 | BIT STRING (SIZE (64)), |

...

| | |
|---|---|
| codebookSubsetRestriction-r18-SPN | BIT STRING (SIZE (64)), |

},

| | |
|---|---|
| four-three | SEQUENCE { |
| codebookSubsetRestriction-r18-SP1 | BIT STRING (SIZE (107)), |
| codebookSubsetRestriction-r18-SP2 | BIT STRING (SIZE (107)), |

...

| | |
|---|---|
| codebookSubsetRestriction-r18-SPN | BIT STRING (SIZE (107)), |

},

| | |
|---|---|
| six-two | SEQUENCE { |
| codebookSubsetRestriction-r18-SP1 | BIT STRING (SIZE (107)), |
| codebookSubsetRestriction-r18-SP2 | BIT STRING (SIZE (107)), |

...

| | |
|---|---|
| codebookSubsetRestriction-r18-SPN | BIT STRING (SIZE (107)), |

},

| | |
|---|---|
| twelve-one | SEQUENCE { |
| codebookSubsetRestriction-r18-SP1 | BIT STRING (SIZE (96)), |
| codebookSubsetRestriction-r18-SP2 | BIT STRING (SIZE (96)), |

...

| | |
|---|---|
| codebookSubsetRestriction-r18-SPN | BIT STRING (SIZE (96)), |

},

| | |
|---|---|
| four-four | SEQUENCE { |
| codebookSubsetRestriction-r18-SP1 | BIT STRING (SIZE (139)), |
| codebookSubsetRestriction-r18-SP2 | BIT STRING (SIZE (139)), |

...

| | |
|---|---|
| codebookSubsetRestriction-r18-SPN | BIT STRING (SIZE (139)), |

},

| | |
|---|---|
| eight-two | SEQUENCE { |
| codebookSubsetRestriction-r18-SP1 | BIT STRING (SIZE (139)), |
| codebookSubsetRestriction-r18-SP2 | BIT STRING (SIZE (139)), |

...

| | |
|---|---|
| codebookSubsetRestriction-r18-SPN | BIT STRING (SIZE (139)), |

},

| | |
|---|---|
| sixteen-one | SEQUENCE { |
| codebookSubsetRestriction-r18-SP1 | BIT STRING (SIZE (128)), |
| codebookSubsetRestriction-r18-SP2 | BIT STRING (SIZE (128)), |

...

| | |
|---|---|
| codebookSubsetRestriction-r18-SPN | BIT STRING (SIZE (128)), |

```
          },
        },
        ...
```

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |
| codebookSubsetRestriction-r18 | SEQUENCE (SIZE (1..maxNrofSPs)) OF |

BIT STRING (SIZE (16)),
},

| | |
|---|---|
| two-two | SEQUENCE { |
| codebookSubsetRestriction-r18 | SEQUENCE (SIZE (1..maxNrofSPs)) OF |

BIT STRING (SIZE (43)),
},

| | |
|---|---|
| four-one | SEQUENCE { |
| codebookSubsetRestriction-r18 | SEQUENCE (SIZE (1..maxNrofSPs)) OF |

BIT STRING (SIZE (32)),
},

| | |
|---|---|
| three-two | SEQUENCE { |
| codebookSubsetRestriction-r18 | SEQUENCE (SIZE (1..maxNrofSPs)) OF |

BIT STRING (SIZE (59)),
},

| | |
|---|---|
| six-one | SEQUENCE { |
| codebookSubsetRestriction-r18 | SEQUENCE (SIZE (1..maxNrofSPs)) OF |

BIT STRING (SIZE (48)),
},

| | |
|---|---|
| four-two | SEQUENCE { |
| codebookSubsetRestriction-r18 | SEQUENCE (SIZE (1..maxNrofSPs)) OF |

BIT STRING (SIZE (75)),
},

| | |
|---|---|
| eight-one | SEQUENCE { |
| codebookSubsetRestriction-r18 | SEQUENCE (SIZE (1..maxNrofSPs)) OF |

BIT STRING (SIZE (64)),
},

| | |
|---|---|
| four-three | SEQUENCE { |
| codebookSubsetRestriction-r18 | SEQUENCE (SIZE (1..maxNrofSPs)) OF |

BIT STRING (SIZE (107)),
},

| | |
|---|---|
| six-two | SEQUENCE { |
| codebookSubsetRestriction-r18 | SEQUENCE (SIZE (1..maxNrofSPs)) OF |

BIT STRING (SIZE (107)),
},

| | |
|---|---|
| twelve-one | SEQUENCE { |
| codebookSubsetRestriction-r18 | SEQUENCE (SIZE (1..maxNrofSPs)) OF |

BIT STRING (SIZE (96)),
},

| | |
|---|---|
| four-four | SEQUENCE { |
| codebookSubsetRestriction-r18 | SEQUENCE (SIZE (1..maxNrofSPs)) OF |

BIT STRING (SIZE (139)),
},

| | |
|---|---|
| eight-two | SEQUENCE { |
| codebookSubsetRestriction-r18 | SEQUENCE (SIZE (1..maxNrofSPs)) OF |

BIT STRING (SIZE (139)),
},

| | |
|---|---|
| sixteen-one | SEQUENCE { |
| codebookSubsetRestriction-r18 | SEQUENCE (SIZE (1..maxNrofSPs)) OF |

```
BIT STRING (SIZE (128)),
          },
        },
        ...
```

| | |
|---|---|
| maxNrofSPs | INTEGER ::= 4 |

In another example, the higher-layer parameters ‘n1-n2’ and ‘codebookSubsetRestriction-r18’ can be as follows.

| | |
|---|---|
| CodebookConfig-r18 ::= | SEQUENCE { |

| | |
|---|---|
| codebookType | CHOICE { |
| type2 | SEQUENCE { |

...

| n1-n2 | CHOICE { |
|---|---|
| two-one | |
| two-two | |
| four-one | |
| ... | |
| sixteen-one | |
| }, | |
| codebookSubsetRestriction-r18 | SEQUENCE (SIZE (1..maxNrofSPs)) OF |

codebookSubsetRestriction-r18-SP,

...

}

| | |
|---|---|
| codebookSubsetRestriction-r18-SP | BIT STRING (SIZE (X)), |

...

| | |
|---|---|
| maxNrofSPs | INTEGER ::= 4 |
| X :== | INTEGER (16,32,43,48,59,64,75,96,107,128,139) |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In another example, the higher-layer parameters ‘n1-n2’ and ‘codebookSubsetRestriction-r18’ can be as follows.

| CodebookConfig-r18 ::= | | SEQUENCE { |
|---|---|---|
| codebookType | CHOICE { | |
| type2 | SEQUENCE { | |
| ... | n1-n2 | CHOICE { |
| | two-one | |
| | two-two | |
| | four-one | |
| | ... | |
| | sixteen-one | |
| | }, | |
| | codebookSubsetRestriction-r18-SP1 | BIT STRING (SIZE (X)), |
| | codebookSubsetRestriction-r18-SP2 | BIT STRING (SIZE (X)), |
| | ... | |
| | codebookSubsetRestriction-r18-SPN | BIT STRING (SIZE (X)), |

...
}

| | |
|---|---|
| X :== | INTEGER (16,32,43,48,59,64,75,96,107,128,139) |

In one example, it is the same example as example as described herein except that only hard amplitude restriction is allowed to configure (not allowing to configure soft amplitude restriction), where the hard amplitude restriction refers that its associated amplitudes can be either restricted to all 0 or no restricted, (hence freely selected using the configured codebook).

For example, it is not allowed to configure b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=01 or 10 with a table such as the following table.

| | Maximum |
|---|---|
| | Average |
| | Coefficient |
| Bit | Amplitude |
| b_{2, r}^{(k, 2(N}^{₁}^{x}^{₂}^{+x}^{₁}⁾⁺¹⁾b_{2, r}^{(k, 2(N}^{₁}^{x}^{₂}^{+x}^{₁}⁾⁾ | γ_{i+pL, r} |
| 00 | 0 |
| 01 | \sqrt{¼} |
| 10 | \sqrt{½} |
| 11 | 1 |

In another example, there is no such a table since the hard restriction allows to configure either its associated amplitudes to be 0 or under no restriction (hence no equation on γ_{i+pL,r}). For example, a higher-layer parameter to indicate the hard restriction can be according to the following: bit ‘0’ corresponds to its associated amplitudes to be 0, and bit ‘1’ corresponds to it associated amplitudes having no restriction.

In another example, it is allowed to configure b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=0 or 1 with a table such as the following table.

| | Maximum |
|---|---|
| | Average |
| | Coefficient |
| Bit | Amplitude |
| b_{2, r}^{(k, 2(N}^{₁}^{x}^{₂}^{+x}^{₁}⁾⁺¹⁾b_{2, r}^{(k, 2(N}^{₁}^{x}^{₂}^{+x}^{₁}⁾⁾ | γ_{i+pL, r} |
| 0 | 0 |
| 1 | 1 |

In one example, for each example of higher-layer parameters (RRC signaling, or information elements) shown herein, the size of bit string can be computed based on 2-bits for B_{2,r} (instead of 4-bits for B_{2,r}).

In one example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |
| codebookSubsetRestriction-r18-trp1 | BIT STRING (SIZE (8)), |
| codebookSubsetRestriction-r18-trp2 | BIT STRING (SIZE (8)), |

...

| | |
|---|---|
| codebookSubsetRestriction-r18-trpN | BIT STRING (SIZE (8)), |

},

| | |
|---|---|
| two-two | SEQUENCE { |
| codebookSubsetRestriction-r18-trp1 | BIT STRING (SIZE (27)), |
| codebookSubsetRestriction-r18-trp2 | BIT STRING (SIZE (27)), |

...

| | |
|---|---|
| codebookSubsetRestriction-r18-trpN | BIT STRING (SIZE (27)), |

},

| | |
|---|---|
| four-one | SEQUENCE { |
| codebookSubsetRestriction-r18-trp1 | BIT STRING (SIZE (16)), |
| codebookSubsetRestriction-r18-trp2 | BIT STRING (SIZE (16)), |

...

| | |
|---|---|
| codebookSubsetRestriction-r18-trpN | BIT STRING (SIZE (16)), |

},

| | |
|---|---|
| three-two | SEQUENCE { |
| codebookSubsetRestriction-r18-trp1 | BIT STRING (SIZE (35)), |
| codebookSubsetRestriction-r18-trp2 | BIT STRING (SIZE (35)), |

...

| | |
|---|---|
| codebookSubsetRestriction-r18-trpN | BIT STRING (SIZE (35)), |

},

| | |
|---|---|
| six-one | SEQUENCE { |
| codebookSubsetRestriction-r18-trp1 | BIT STRING (SIZE (24)), |
| codebookSubsetRestriction-r18-trp2 | BIT STRING (SIZE (24)), |

...

| | |
|---|---|
| codebookSubsetRestriction-r18-trpN | BIT STRING (SIZE (24)), |

},

| | |
|---|---|
| four-two | SEQUENCE { |
| codebookSubsetRestriction-r18-trp1 | BIT STRING (SIZE (43)), |
| codebookSubsetRestriction-r18-trp2 | BIT STRING (SIZE (43)), |

...

| | |
|---|---|
| codebookSubsetRestriction-r18-trpN | BIT STRING (SIZE (43)), |

},

| | |
|---|---|
| eight-one | SEQUENCE { |
| codebookSubsetRestriction-r18-trp1 | BIT STRING (SIZE (32)), |
| codebookSubsetRestriction-r18-trp2 | BIT STRING (SIZE (32)), |

...

| | |
|---|---|
| codebookSubsetRestriction-r18-trpN | BIT STRING (SIZE (32)), |

},

| | |
|---|---|
| four-three | SEQUENCE { |
| codebookSubsetRestriction-r18-trp1 | BIT STRING (SIZE (59)), |
| codebookSubsetRestriction-r18-trp2 | BIT STRING (SIZE (59)), |

...

| | |
|---|---|
| codebookSubsetRestriction-r18-trpN | BIT STRING (SIZE (59)), |

},

| | |
|---|---|
| six-two | SEQUENCE { |
| codebookSubsetRestriction-r18-trp1 | BIT STRING (SIZE (59)), |
| codebookSubsetRestriction-r18-trp2 | BIT STRING (SIZE (59)), |

...

| | |
|---|---|
| codebookSubsetRestriction-r18-trpN | BIT STRING (SIZE (59)), |

},

| | |
|---|---|
| twelve-one | SEQUENCE { |
| codebookSubsetRestriction-r18-trp1 | BIT STRING (SIZE (48)), |
| codebookSubsetRestriction-r18-trp2 | BIT STRING (SIZE (48)), |

...

| | |
|---|---|
| codebookSubsetRestriction-r18-trpN | BIT STRING (SIZE (48)), |

},

| | |
|---|---|
| four-four | SEQUENCE { |
| codebookSubsetRestriction-r18-trp1 | BIT STRING (SIZE (75)), |
| codebookSubsetRestriction-r18-trp2 | BIT STRING (SIZE (75)), |

...

| | |
|---|---|
| codebookSubsetRestriction-r18-trpN | BIT STRING (SIZE (75)), |

},

| | |
|---|---|
| eight-two | SEQUENCE { |
| codebookSubsetRestriction-r18-trp1 | BIT STRING (SIZE (75)), |
| codebookSubsetRestriction-r18-trp2 | BIT STRING (SIZE (75)), |

...

| | |
|---|---|
| codebookSubsetRestriction-r18-trpN | BIT STRING (SIZE (75)), |

},

| | |
|---|---|
| sixteen-one | SEQUENCE { |
| codebookSubsetRestriction-r18-trp1 | BIT STRING (SIZE (64)), |
| codebookSubsetRestriction-r18-trp2 | BIT STRING (SIZE (64)), |

...

| | |
|---|---|
| codebookSubsetRestriction-r18-trpN | BIT STRING (SIZE (64)), |

```
          },
        },
        ...
```

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

```
            codebookSubsetRestriction-r18-SP1 BIT STRING (SIZE (8)),
            codebookSubsetRestriction-r18-SP2 BIT STRING (SIZE (8)),
            ...
            codebookSubsetRestriction-r18-SPN BIT STRING (SIZE (8)),
          },
```

| | |
|---|---|
| two-two | SEQUENCE { |

```
            codebookSubsetRestriction-r18-SP1 BIT STRING (SIZE (27)),
            codebookSubsetRestriction-r18-SP2 BIT STRING (SIZE (27)),
            ...
            codebookSubsetRestriction-r18-SPN BIT STRING (SIZE (27)),
          },
```

| | |
|---|---|
| four-one | SEQUENCE { |

```
            codebookSubsetRestriction-r18-SP1 BIT STRING (SIZE (16)),
            codebookSubsetRestriction-r18-SP2 BIT STRING (SIZE (16)),
            ...
            codebookSubsetRestriction-r18-SPN BIT STRING (SIZE (16)),
          },
```

| | |
|---|---|
| three-two | SEQUENCE { |

```
            codebookSubsetRestriction-r18-SP1 BIT STRING (SIZE (35)),
            codebookSubsetRestriction-r18-SP2 BIT STRING (SIZE (35)),
            ...
            codebookSubsetRestriction-r18-SPN BIT STRING (SIZE (35)),
          },
```

| | |
|---|---|
| six-one | SEQUENCE { |

```
            codebookSubsetRestriction-r18-SP1 BIT STRING (SIZE (24)),
            codebookSubsetRestriction-r18-SP2 BIT STRING (SIZE (24)),
            ...
            codebookSubsetRestriction-r18-SPN BIT STRING (SIZE (24)),
          },
```

| | |
|---|---|
| four-two | SEQUENCE { |

```
            codebookSubsetRestriction-r18-SP1 BIT STRING (SIZE (43)),
            codebookSubsetRestriction-r18-SP2 BIT STRING (SIZE (43)),
            ...
            codebookSubsetRestriction-r18-SPN BIT STRING (SIZE (43)),
          },
```

| | |
|---|---|
| eight-one | SEQUENCE { |

```
            codebookSubsetRestriction-r18-SP1 BIT STRING (SIZE (32)),
            codebookSubsetRestriction-r18-SP2 BIT STRING (SIZE (32)),
            ...
            codebookSubsetRestriction-r18-SPN BIT STRING (SIZE (32)),
          },
```

| | |
|---|---|
| four-three | SEQUENCE { |

```
            codebookSubsetRestriction-r18-SP1 BIT STRING (SIZE (59)),
            codebookSubsetRestriction-r18-SP2 BIT STRING (SIZE (59)),
            ...
            codebookSubsetRestriction-r18-SPN BIT STRING (SIZE (59)),
          },
```

| | |
|---|---|
| six-two | SEQUENCE { |

```
            codebookSubsetRestriction-r18-SP1 BIT STRING (SIZE (59)),
            codebookSubsetRestriction-r18-SP2 BIT STRING (SIZE (59)),
            ...
            codebookSubsetRestriction-r18-SPN BIT STRING (SIZE (59)),
          },
```

| | |
|---|---|
| twelve-one | SEQUENCE { |

```
            codebookSubsetRestriction-r18-SP1 BIT STRING (SIZE (48)),
            codebookSubsetRestriction-r18-SP2 BIT STRING (SIZE (48)),
            ...
            codebookSubsetRestriction-r18-SPN BIT STRING (SIZE (48)),
          },
```

| | |
|---|---|
| four-four | SEQUENCE { |

```
            codebookSubsetRestriction-r18-SP1 BIT STRING (SIZE (75)),
            codebookSubsetRestriction-r18-SP2 BIT STRING (SIZE (75)),
            ...
            codebookSubsetRestriction-r18-SPN BIT STRING (SIZE (75)),
          },
```

| | |
|---|---|
| eight-two | SEQUENCE { |

```
            codebookSubsetRestriction-r18-SP1 BIT STRING (SIZE (75)),
            codebookSubsetRestriction-r18-SP2 BIT STRING (SIZE (75)),
            ...
            codebookSubsetRestriction-r18-SPN BIT STRING (SIZE (75)),
          },
```

| | |
|---|---|
| sixteen-one | SEQUENCE { |

```
            codebookSubsetRestriction-r18-SP1 BIT STRING (SIZE (64)),
            codebookSubsetRestriction-r18-SP2 BIT STRING (SIZE (64)),
            ...
            codebookSubsetRestriction-r18-SPN BIT STRING (SIZE (64)),
          },
        },
        ...
```

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

```
            codebookSubsetRestriction-r18 SEQUENCE (SIZE (1..maxNrofSPs)) OF
BIT STRING (SIZE (8)),
          },
```

| | |
|---|---|
| two-two | SEQUENCE { |

```
            codebookSubsetRestriction-r18 SEQUENCE (SIZE (1..maxNrofSPs)) OF
BIT STRING (SIZE (27)),
          },
```

| | |
|---|---|
| four-one | SEQUENCE { |

```
            codebookSubsetRestriction-r18 SEQUENCE (SIZE (1..maxNrofSPs)) OF
BIT STRING (SIZE (16)),
          },
```

| | |
|---|---|
| three-two | SEQUENCE { |

```
            codebookSubsetRestriction-r18 SEQUENCE (SIZE (1..maxNrofSPs)) OF
BIT STRING (SIZE (35)),
          },
```

| | |
|---|---|
| six-one | SEQUENCE { |

```
            codebookSubsetRestriction-r18 SEQUENCE (SIZE (1..maxNrofSPs)) OF
BIT STRING (SIZE (24)),
          },
```

| | |
|---|---|
| four-two | SEQUENCE { |

```
            codebookSubsetRestriction-r18 SEQUENCE (SIZE (1..maxNrofSPs)) OF
BIT STRING (SIZE (43)),
          },
```

| | |
|---|---|
| eight-one | SEQUENCE { |

```
            codebookSubsetRestriction-r18 SEQUENCE (SIZE (1..maxNrofSPs)) OF
BIT STRING (SIZE (32)),
          },
```

| | |
|---|---|
| four-three | SEQUENCE { |

```
            codebookSubsetRestriction-r18 SEQUENCE (SIZE (1..maxNrofSPs)) OF
BIT STRING (SIZE (59)),
          },
```

| | |
|---|---|
| six-two | SEQUENCE { |

```
            codebookSubsetRestriction-r18 SEQUENCE (SIZE (1..maxNrofSPs)) OF
BIT STRING (SIZE (59)),
          },
```

| | |
|---|---|
| twelve-one | SEQUENCE { |

```
            codebookSubsetRestriction-r18 SEQUENCE (SIZE (1..maxNrofSPs)) OF
BIT STRING (SIZE (48)),
          },
```

| | |
|---|---|
| four-four | SEQUENCE { |

```
            codebookSubsetRestriction-r18 SEQUENCE (SIZE (1..maxNrofSPs)) OF
BIT STRING (SIZE (75)),
          },
```

| | |
|---|---|
| eight-two | SEQUENCE { |

```
            codebookSubsetRestriction-r18 SEQUENCE (SIZE (1..maxNrofSPs)) OF
BIT STRING (SIZE (75)),
          },
```

| | |
|---|---|
| sixteen-one | SEQUENCE { |

```
            codebookSubsetRestriction-r18 SEQUENCE (SIZE (1..maxNrofSPs)) OF
BIT STRING (SIZE (64)),
          },
        },
        ...
```

| | |
|---|---|
| maxNrofSPs | INTEGER ::= 4 |

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

```
          two-one
          two-two
          four-one
          ...
          sixteen-one
          },
        codebookSubsetRestriction-r18 SEQUENCE (SIZE (1..maxNrofSPs)) OF
codebookSubsetRestriction-r18-SP,
        ...
}
codebookSubsetRestriction-r18-SP BIT STRING (SIZE (X)),
...
```

| | |
|---|---|
| maxNrofSPs | INTEGER ::= 4 |

X :== INTEGER (8,16,24,27,32,35,43,48,59,64,75)

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

```
          two-one
          two-two
          four-one
          ...
          sixteen-one
          },
        codebookSubsetRestriction-r18-SP1 BIT STRING (SIZE (X)),
        codebookSubsetRestriction-r18-SP2 BIT STRING (SIZE (X)),
        ...
        codebookSubsetRestriction-r18-SPN BIT STRING (SIZE (X)),
      ...
}
X === INTEGER (8,16,24,27,32,35,43,48,59,64,75)
```

As shown in the example above, the bit width for B_{2,r} is changed from 2N₁N₂×4 to 2N₁N₂×2, and the bit width for B_{1,r} is maintained as 11 bits for N₂>1 or 0 bits for N₂=1.

In one example, the first parameter ‘n1-n2’ is TRP-common (or TRP-group common), i.e., the same value of (N₁, N₂) for all TRPs is configured with the first parameter. The second higher-layer parameter ‘codebookSubsetRestriction-r18’ is a bit-map parameter used to indicate restrictions on vector groups and (average) coefficient amplitudes associated with the vectors in the groups. The bit-map parameter ‘codebookSubsetRestriction-r18’ forms the bit sequence Bᵣ=B₁B_{2,r} for each TRP r=1, . . . , N_{TRP} (or TRP group), but the vector group indices g^{(k)} are common for all TRPs, i.e., one g^{(k)} for all TRPs (similar to as in clause 5.2.2.2.3 of TS 38.214 [9]). Bits b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾ indicate the maximum allowed average amplitude, γ_{i+pL,r} (p=0,1), with i∈{0, 1, . . . , L−1}, of the coefficients associated with the vector in group g^{(k)} indexed by x₁, x₂, for example, where the maximum amplitudes are given in Table 5.2.2.2.5-6 of TS 38.214 [9] and the average coefficient amplitude associated with the vector in group g^{(k)} is less than or equal to γ_{i+pL,r}. One example is as follows:

$$\sqrt{\frac{1}{{\sum }_{f = 0}^{{M}_{υ} - 1} {k}_{l , i + p L , f , r}^{( 3 )}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + pL , r} .$$

where k_{l,i+pL,f,r}⁽³⁾∈{0,1} is part of the bitmap indicator for TRP r, and indicates whether the corresponding coefficient is zero (when bit value=0) or non-zero (when bit value=1), p_{l,p,r}⁽¹⁾ is a (first) reference amplitude, and p_{l,i+pL,f,r}⁽²⁾ is a (second) differential amplitude coefficient, as described in 5.2.2.2.5 of TS 38.214.

For example, a UE that does not report the parameter ‘softAmpRestriction-r18’=‘supported’ in its capability signaling is not expected to be configured with b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=01 or 10.

In one example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

```
            codebookSubsetRestriction-r18-trp1 BIT STRING (SIZE (16)),
            codebookSubsetRestriction-r18-trp2 BIT STRING (SIZE (16)),
            ...
            codebookSubsetRestriction-r18-trpN BIT STRING (SIZE (16)),
          },
```

| | |
|---|---|
| two-two | SEQUENCE { |

```
            codebookSubsetRestriction-r18-trp1 BIT STRING (SIZE (43)),
            codebookSubsetRestriction-r18-trp2 BIT STRING (SIZE (32)),
            ...
            codebookSubsetRestriction-r18-trpN BIT STRING (SIZE (32)),
          },
```

| | |
|---|---|
| four-one | SEQUENCE { |

```
            codebookSubsetRestriction-r18-trp1 BIT STRING (SIZE (32)),
            codebookSubsetRestriction-r18-trp2 BIT STRING (SIZE (32)),
            ...
            codebookSubsetRestriction-r18-trpN BIT STRING (SIZE (32)),
          },
```

| | |
|---|---|
| three-two | SEQUENCE { |

```
            codebookSubsetRestriction-r18-trp1 BIT STRING (SIZE (59)),
            codebookSubsetRestriction-r18-trp2 BIT STRING (SIZE (48)),
            ...
            codebookSubsetRestriction-r18-trpN BIT STRING (SIZE (48)),
          },
```

| | |
|---|---|
| six-one | SEQUENCE { |

```
            codebookSubsetRestriction-r18-trp1 BIT STRING (SIZE (48)),
            codebookSubsetRestriction-r18-trp2 BIT STRING (SIZE (48)),
            ...
            codebookSubsetRestriction-r18-trpN BIT STRING (SIZE (48)),
          },
```

| | |
|---|---|
| four-two | SEQUENCE { |

```
            codebookSubsetRestriction-r18-trp1 BIT STRING (SIZE (75)),
            codebookSubsetRestriction-r18-trp2 BIT STRING (SIZE (64)),
            ...
            codebookSubsetRestriction-r18-trpN BIT STRING (SIZE (64)),
          },
```

| | |
|---|---|
| eight-one | SEQUENCE { |

```
            codebookSubsetRestriction-r18-trp1 BIT STRING (SIZE (64)),
            codebookSubsetRestriction-r18-trp2 BIT STRING (SIZE (64)),
            ...
            codebookSubsetRestriction-r18-trpN BIT STRING (SIZE (64)),
          },
```

| | |
|---|---|
| four-three | SEQUENCE { |

```
            codebookSubsetRestriction-r18-trp1 BIT STRING (SIZE (107)),
            codebookSubsetRestriction-r18-trp2 BIT STRING (SIZE (96)),
            ...
            codebookSubsetRestriction-r18-trpN BIT STRING (SIZE (96)),
          },
```

| | |
|---|---|
| six-two | SEQUENCE { |

```
            codebookSubsetRestriction-r18-trp1 BIT STRING (SIZE (107)),
            codebookSubsetRestriction-r18-trp2 BIT STRING (SIZE (96)),
            ...
            codebookSubsetRestriction-r18-trpN BIT STRING (SIZE (96)),
          },
```

| | |
|---|---|
| twelve-one | SEQUENCE { |

```
            codebookSubsetRestriction-r18-trp1 BIT STRING (SIZE (96)),
            codebookSubsetRestriction-r18-trp2 BIT STRING (SIZE (96)),
            ...
            codebookSubsetRestriction-r18-trpN BIT STRING (SIZE (96)),
          },
```

| | |
|---|---|
| four-four | SEQUENCE { |

```
            codebookSubsetRestriction-r18-trp1 BIT STRING (SIZE (139)),
            codebookSubsetRestriction-r18-trp2 BIT STRING (SIZE (128)),
            ...
            codebookSubsetRestriction-r18-trpN BIT STRING (SIZE (128)),
          },
```

| | |
|---|---|
| eight-two | SEQUENCE { |

```
            codebookSubsetRestriction-r18-trp1 BIT STRING (SIZE (139)),
            codebookSubsetRestriction-r18-trp2 BIT STRING (SIZE (128)),
            ...
            codebookSubsetRestriction-r18-trpN BIT STRING (SIZE (128)),
          },
```

| | |
|---|---|
| sixteen-one | SEQUENCE { |

```
            codebookSubsetRestriction-r18-trp1 BIT STRING (SIZE (128)),
            codebookSubsetRestriction-r18-trp2 BIT STRING (SIZE (128)),
            ...
            codebookSubsetRestriction-r18-trpN BIT STRING (SIZE (128)),
          },
        },
```

In one example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

```
            codebookSubsetRestriction-r18-SP1 BIT STRING (SIZE (16)),
            codebookSubsetRestriction-r18-SP2 BIT STRING (SIZE (16)),
            ...
            codebookSubsetRestriction-r18-SPN BIT STRING (SIZE (16)),
          },
```

| | |
|---|---|
| two-two | SEQUENCE { |

```
            codebookSubsetRestriction-r18-SP1 BIT STRING (SIZE (43)),
            codebookSubsetRestriction-r18-SP2 BIT STRING (SIZE (32)),
            ...
            codebookSubsetRestriction-r18-SPN BIT STRING (SIZE (32)),
          },
```

| | |
|---|---|
| four-one | SEQUENCE { |

```
            codebookSubsetRestriction-r18-SP1 BIT STRING (SIZE (32)),
            codebookSubsetRestriction-r18-SP2 BIT STRING (SIZE (32)),
            ...
            codebookSubsetRestriction-r18-SPN BIT STRING (SIZE (32)),
          },
```

| | |
|---|---|
| three-two | SEQUENCE { |

```
            codebookSubsetRestriction-r18-SP1 BIT STRING (SIZE (59)),
            codebookSubsetRestriction-r18-SP2 BIT STRING (SIZE (48)),
            ...
            codebookSubsetRestriction-r18-SPN BIT STRING (SIZE (48)),
          },
```

| | |
|---|---|
| six-one | SEQUENCE { |

```
            codebookSubsetRestriction-r18-SP1 BIT STRING (SIZE (48)),
            codebookSubsetRestriction-r18-SP2 BIT STRING (SIZE (48)),
            ...
            codebookSubsetRestriction-r18-SPN BIT STRING (SIZE (48)),
          },
```

| | |
|---|---|
| four-two | SEQUENCE { |

```
            codebookSubsetRestriction-r18-SP1 BIT STRING (SIZE (75)),
            codebookSubsetRestriction-r18-SP2 BIT STRING (SIZE (64)),
            ...
            codebookSubsetRestriction-r18-SPN BIT STRING (SIZE (64)),
          },
```

| | |
|---|---|
| eight-one | SEQUENCE { |

```
            codebookSubsetRestriction-r18-SP1 BIT STRING (SIZE (64)),
            codebookSubsetRestriction-r18-SP2 BIT STRING (SIZE (64)),
            ...
            codebookSubsetRestriction-r18-SPN BIT STRING (SIZE (64)),
          },
```

| | |
|---|---|
| four-three | SEQUENCE { |

```
            codebookSubsetRestriction-r18-SP1 BIT STRING (SIZE (107)),
            codebookSubsetRestriction-r18-SP2 BIT STRING (SIZE (96)),
            ...
            codebookSubsetRestriction-r18-SPN BIT STRING (SIZE (96)),
          },
```

| | |
|---|---|
| six-two | SEQUENCE { |

```
            codebookSubsetRestriction-r18-SP1 BIT STRING (SIZE (107)),
            codebookSubsetRestriction-r18-SP2 BIT STRING (SIZE (96)),
            ...
            codebookSubsetRestriction-r18-SPN BIT STRING (SIZE (96)),
          },
```

| | |
|---|---|
| twelve-one | SEQUENCE { |

```
            codebookSubsetRestriction-r18-SP1 BIT STRING (SIZE (96)),
            codebookSubsetRestriction-r18-SP2 BIT STRING (SIZE (96)),
            ...
            codebookSubsetRestriction-r18-SPN BIT STRING (SIZE (96)),
          },
```

| | |
|---|---|
| four-four | SEQUENCE { |

```
            codebookSubsetRestriction-r18-SP1 BIT STRING (SIZE (139)),
            codebookSubsetRestriction-r18-SP2 BIT STRING (SIZE (128)),
            ...
            codebookSubsetRestriction-r18-SPN BIT STRING (SIZE (128)),
          },
```

| | |
|---|---|
| eight-two | SEQUENCE { |

```
            codebookSubsetRestriction-r18-SP1 BIT STRING (SIZE (139)),
            codebookSubsetRestriction-r18-SP2 BIT STRING (SIZE (128)),
            ...
            codebookSubsetRestriction-r18-SPN BIT STRING (SIZE (128)),
          },
```

| | |
|---|---|
| sixteen-one | SEQUENCE { |

```
            codebookSubsetRestriction-r18-SP1 BIT STRING (SIZE (128)),
            codebookSubsetRestriction-r18-SP2 BIT STRING (SIZE (128)),
            ...
            codebookSubsetRestriction-r18-SPN BIT STRING (SIZE (128)),
          },
        },
```

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

```
            codebookSubsetRestriction-r18 SEQUENCE (SIZE (1..maxNrofSPs)) OF
BIT STRING (SIZE (16)),
          },
```

| | |
|---|---|
| two-two | SEQUENCE { |

```
            codebookSubsetRestrictionCommon-r18 BIT STRING (SIZE (11)),
            codebookSubsetRestriction-r18 SEQUENCE (SIZE (1..maxNrofSPs)) OF
BIT STRING (SIZE (32)),
          },
```

| | |
|---|---|
| four-one | SEQUENCE { |

```
            codebookSubsetRestriction-r18 SEQUENCE (SIZE (1..maxNrofSPs)) OF
BIT STRING (SIZE (32)),
          },
```

| | |
|---|---|
| three-two | SEQUENCE { |

```
            codebookSubsetRestrictionCommon-r18 BIT STRING (SIZE (11)),
            codebookSubsetRestriction-r18 SEQUENCE (SIZE (1..maxNrofSPs)) OF
BIT STRING (SIZE (48)),
          },
```

| | |
|---|---|
| six-one | SEQUENCE { |

```
            codebookSubsetRestriction-r18 SEQUENCE (SIZE (1..maxNrofSPs)) OF
BIT STRING (SIZE (48)),
          },
```

| | |
|---|---|
| four-two | SEQUENCE { |

```
            codebookSubsetRestrictionCommon-r18 BIT STRING (SIZE (11)),
            codebookSubsetRestriction-r18 SEQUENCE (SIZE (1..maxNrofSPs)) OF
BIT STRING (SIZE (64)),
          },
```

| | |
|---|---|
| eight-one | SEQUENCE { |

```
            codebookSubsetRestriction-r18 SEQUENCE (SIZE (1..maxNrofSPs)) OF
BIT STRING (SIZE (64)),
          },
```

| | |
|---|---|
| four-three | SEQUENCE { |

```
            codebookSubsetRestrictionCommon-r18 BIT STRING (SIZE (11)),
            codebookSubsetRestriction-r18 SEQUENCE (SIZE (1..maxNrofSPs)) OF
BIT STRING (SIZE (96)),
          },
```

| | |
|---|---|
| six-two | SEQUENCE { |
| | codebookSubsetRestrictionCommon-r18 BIT STRING (SIZE (11)), |

```
            codebookSubsetRestriction-r18 SEQUENCE (SIZE (1..maxNrofSPs)) OF
BIT STRING (SIZE (96)),
          },
```

| | |
|---|---|
| twelve-one | SEQUENCE { |

```
            codebookSubsetRestriction-r18 SEQUENCE (SIZE (1..maxNrofSPs)) OF
BIT STRING (SIZE (96)),
          },
```

| | |
|---|---|
| four-four | SEQUENCE { |
| | codebookSubsetRestrictionCommon-r18 BIT STRING (SIZE (11)), |

```
            codebookSubsetRestriction-r18 SEQUENCE (SIZE (1..maxNrofSPs)) OF
BIT STRING (SIZE (128)),
          },
```

| | |
|---|---|
| eight-two | SEQUENCE { |
| | codebookSubsetRestrictionCommon-r18 BIT STRING (SIZE (11)), |

```
            codebookSubsetRestriction-r18 SEQUENCE (SIZE (1..maxNrofSPs)) OF
BIT STRING (SIZE (128)),
          },
```

| | |
|---|---|
| sixteen-one | SEQUENCE { |

```
            codebookSubsetRestriction-r18 SEQUENCE (SIZE (1..maxNrofSPs)) OF
BIT STRING (SIZE (128)),
          },
        },
        ...
```

| | |
|---|---|
| maxNrofSPs | INTEGER ::= 4 |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

```
          two-one
          two-two
          four-one
          ...
          sixteen-one
          },
        codebookSubsetRestrictionCommon-r18 BIT STRING (SIZE (11)),
        codebookSubsetRestriction-r18 SEQUENCE (SIZE (1..maxNrofSPs)) OF
codebookSubsetRestriction-r18-SP,
        ...
}
codebookSubsetRestriction-r18-SP BIT STRING (SIZE (X)),
...
```

| | |
|---|---|
| maxNrofSPs | INTEGER ::= 4 |

X :== INTEGER (16,32,48,64,96,128)

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In another example, the higher-layer parameters ‘n1-n2’ and ‘codebookSubsetRestriction-r18’ can be as follows.

| CodebookConfig-r18 ::= | SEQUENCE { |
|---|---|
| codebookType | CHOICE { |
| type2 | SEQUENCE { |
| ... | |
| n1-n2 | CHOICE { |

```
          two-one
          two-two
          four-one
          ...
          sixteen-one
          },
        codebookSubsetRestrictionCommon-r18 BIT STRING (SIZE (11)),
        codebookSubsetRestriction-r18-SP1 BIT STRING (SIZE (X)),
        codebookSubsetRestriction-r18-SP2 BIT STRING (SIZE (X)),
        ...
        codebookSubsetRestriction-r18-SPN BIT STRING (SIZE (X)),
      ...
}
X :== INTEGER (16,32,48,64,96,128)
```

In one example, the first parameter ‘n1-n2’ is TRP-common (or TRP-group common), i.e., the same value of (N₁, N₂) for all TRPs is configured with the first parameter. The second higher-layer parameter ‘codebookSubsetRestriction-r18’ is a bit-map parameter used to indicate restrictions on vector groups and (average) coefficient amplitudes associated with the vectors in the groups. For each TRP r=1, . . . , N_{TRP} (or TRP group), the bit-map parameter ‘codebookSubsetRestriction-r18’ forms the bit sequence Bᵣ=B_{1,r}B₂, and the vector group indices g^{(k,r)} (similar to as in clause 5.2.2.2.3 of TS 38.214 [9]). Bits b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾ indicate the maximum allowed average amplitude, γ_{i+pL} (p=0,1), with i∈{0, 1, . . . , L−1}, of the coefficients associated with the vector in group g^{(k,r)} indexed by x₁, x₂, for example, where the maximum amplitudes are given in Table 5.2.2.2.5-6 of TS 38.214 [9] and the average coefficient amplitude associated with the vector in group g^{(k,r)} is less than or equal to γ_{i+pL}. One example is as follows:

$$\sqrt{\frac{1}{{\sum }_{f = 0}^{{M}_{υ} - 1} {k}_{l , i + p L , f , r}^{( 3 )}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + pL , r} .$$

where k_{l,i+pL,f,r}⁽³⁾∈{0,1} is part of the bitmap indicator for TRP r, and indicates whether the corresponding coefficient is zero (when bit value=0) or non-zero (when bit value=1), p_{l,p,r}⁽¹⁾ is a (first) reference amplitude, and p_{l,i+pL,f,r}⁽²⁾ is a (second) differential amplitude coefficient, as described in 5.2.2.2.5 of TS 38.214.

In another example, the average coefficient amplitude associated with the vectors in groups g^{(k,r)} for ∀r over CSI-RS resources (TRPs) is less than or equal to γ_{i+pL}. One example is as follows:

$$\sqrt{\frac{1}{{\sum }_{r = 1}^{{N}_{T R P}} {\sum }_{f = 0}^{{M}_{υ} - 1} {k}_{l , i + p L , f , r}^{( 3 )}} {\sum }_{r = 1}^{{N}_{T R P}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + p L} .$$

For example, a UE that does not report the parameter ‘softAmpRestriction-r18’=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

In one example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| codebookSubsetRestriction-r18 | BIT STRING (SIZE (16)), |

},

| | |
|---|---|
| two-two | SEQUENCE { |

| | |
|---|---|
| codebookSubsetRestriction-r18-trp1 | BIT STRING (SIZE (43)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| four-one | SEQUENCE { |

| | |
|---|---|
| codebookSubsetRestriction-r18 | BIT STRING (SIZE (32)), |

},

| | |
|---|---|
| three-two | SEQUENCE { |

| | |
|---|---|
| codebookSubsetRestriction-r18-trp1 | BIT STRING (SIZE (59)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| six-one | SEQUENCE { |

| | |
|---|---|
| codebookSubsetRestriction-r18 | BIT STRING (SIZE (48)), |

},

| | |
|---|---|
| four-two | SEQUENCE { |

| | |
|---|---|
| codebookSubsetRestriction-r18-trp1 | BIT STRING (SIZE (75)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| eight-one | SEQUENCE { |

| | |
|---|---|
| codebookSubsetRestriction-r18 | BIT STRING (SIZE (64)), |

},

| | |
|---|---|
| four-three | SEQUENCE { |

| | |
|---|---|
| codebookSubsetRestriction-r18-trp1 | BIT STRING (SIZE (107)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| six-two | SEQUENCE { |

| | |
|---|---|
| codebookSubsetRestriction-r18-trp1 | BIT STRING (SIZE (107)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| twelve-one | SEQUENCE { |

| | |
|---|---|
| codebookSubsetRestriction-r18 | BIT STRING (SIZE (96)), |

},

| | |
|---|---|
| four-four | SEQUENCE { |

| | |
|---|---|
| codebookSubsetRestriction-r18-trp1 | BIT STRING (SIZE (139)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| eight-two | SEQUENCE { |

| | |
|---|---|
| codebookSubsetRestriction-r18-trp1 | BIT STRING (SIZE (139)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| sixteen-one | SEQUENCE { |

| | |
|---|---|
| codebookSubsetRestriction-r18 | BIT STRING (SIZE (128)), |

```
          },
        },
```

In one example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| codebookSubsetRestriction-r18 | BIT STRING (SIZE (16)), |

},

| | |
|---|---|
| two-two | SEQUENCE { |

| | |
|---|---|
| codebookSubsetRestriction-r18-SP1 | BIT STRING (SIZE (43)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| four-one | SEQUENCE { |

| | |
|---|---|
| codebookSubsetRestriction-r18 | BIT STRING (SIZE (32)), |

},

| | |
|---|---|
| three-two | SEQUENCE { |

| | |
|---|---|
| codebookSubsetRestriction-r18-SP1 | BIT STRING (SIZE (59)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| six-one | SEQUENCE { |

| | |
|---|---|
| codebookSubsetRestriction-r18 | BIT STRING (SIZE (48)), |

},

| | |
|---|---|
| four-two | SEQUENCE { |

| | |
|---|---|
| codebookSubsetRestriction-r18-SP1 | BIT STRING (SIZE (75)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| eight-one | SEQUENCE { |

| | |
|---|---|
| codebookSubsetRestriction-r18 | BIT STRING (SIZE (64)), |

},

| | |
|---|---|
| four-three | SEQUENCE { |

| | |
|---|---|
| codebookSubsetRestriction-r18-SP1 | BIT STRING (SIZE (107)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| six-two | SEQUENCE { |

| | |
|---|---|
| codebookSubsetRestriction-r18-SP1 | BIT STRING (SIZE (107)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| twelve-one | SEQUENCE { |

| | |
|---|---|
| codebookSubsetRestriction-r18 | BIT STRING (SIZE (96)), |

},

| | |
|---|---|
| four-four | SEQUENCE { |

| | |
|---|---|
| codebookSubsetRestriction-r18-SP1 | BIT STRING (SIZE (139)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| eight-two | SEQUENCE { |

| | |
|---|---|
| codebookSubsetRestriction-r18-SP1 | BIT STRING (SIZE (139)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| sixteen-one | SEQUENCE { |

| | |
|---|---|
| codebookSubsetRestriction-r18 | BIT STRING (SIZE (128)), |

```
          },
        },
```

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| codebookSubsetRestriction-r18 | SEQUENCE (SIZE (1..maxNrofSPs)) OF |

BIT STRING (SIZE (16)),
},

| | |
|---|---|
| two-two | SEQUENCE { |

codebookSubsetRestrictionCommon-r18 BIT STRING (SIZE (32)),

| | |
|---|---|
| codebookSubsetRestriction-r18 | SEQUENCE (SIZE (1..maxNrofSPs)) OF |

BIT STRING (SIZE (11)),
},

| | |
|---|---|
| four-one | SEQUENCE { |

| | |
|---|---|
| codebookSubsetRestriction-r18 | SEQUENCE (SIZE (1..maxNrofSPs)) OF |

BIT STRING (SIZE (32)),
},

| | |
|---|---|
| three-two | SEQUENCE { |

codebookSubsetRestrictionCommon-r18 BIT STRING (SIZE (48)),

| | |
|---|---|
| codebookSubsetRestriction-r18 | SEQUENCE (SIZE (1..maxNrofSPs)) OF |

BIT STRING (SIZE (11)),
},

| | |
|---|---|
| six-one | SEQUENCE { |

| | |
|---|---|
| codebookSubsetRestriction-r18 | SEQUENCE (SIZE (1..maxNrofSPs)) OF |

BIT STRING (SIZE (48)),
},

| | |
|---|---|
| four-two | SEQUENCE { |

codebookSubsetRestrictionCommon-r18 BIT STRING (SIZE (64)),

| | |
|---|---|
| codebookSubsetRestriction-r18 | SEQUENCE (SIZE (1..maxNrofSPs)) OF |

BIT STRING (SIZE (11)),
},

| | |
|---|---|
| eight-one | SEQUENCE { |

| | |
|---|---|
| codebookSubsetRestriction-r18 | SEQUENCE (SIZE (1..maxNrofSPs)) OF |

BIT STRING (SIZE (64)),
},

| | |
|---|---|
| four-three | SEQUENCE { |

codebookSubsetRestrictionCommon-r18 BIT STRING (SIZE (96)),

| | |
|---|---|
| codebookSubsetRestriction-r18 | SEQUENCE (SIZE (1..maxNrofSPs)) OF |

BIT STRING (SIZE (11)),
},

| | |
|---|---|
| six-two | SEQUENCE { |
| | codebookSubsetRestrictionCommon-r18 BIT STRING (SIZE (96)), |

| | |
|---|---|
| codebookSubsetRestriction-r18 | SEQUENCE (SIZE (1..maxNrofSPs)) OF |

BIT STRING (SIZE (11)),
},

| | |
|---|---|
| twelve-one | SEQUENCE { |

| | |
|---|---|
| codebookSubsetRestriction-r18 | SEQUENCE (SIZE (1..maxNrofSPs)) OF |

BIT STRING (SIZE (96)),
},

| | |
|---|---|
| four-four | SEQUENCE { |
| | codebookSubsetRestrictionCommon-r18 BIT STRING (SIZE (128)), |

| | |
|---|---|
| codebookSubsetRestriction-r18 | SEQUENCE (SIZE (1..maxNrofSPs)) OF |

BIT STRING (SIZE (11)),
},

| | |
|---|---|
| eight-two | SEQUENCE { |
| | codebookSubsetRestrictionCommon-r18 BIT STRING (SIZE (128)), |

| | |
|---|---|
| codebookSubsetRestriction-r18 | SEQUENCE (SIZE (1..maxNrofSPs)) OF |

BIT STRING (SIZE (11)),
},

| | |
|---|---|
| sixteen-one | SEQUENCE { |

| | |
|---|---|
| codebookSubsetRestriction-r18 | SEQUENCE (SIZE (1..maxNrofSPs)) OF |

```
BIT STRING (SIZE (128)),
          },
        }
        ...
```

| | |
|---|---|
| maxNrofSPs | INTEGER ::= 4 |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In another example, the higher-layer parameters ‘n1-n2’ and ‘codebookSubsetRestriction-r18’ can be as follows.

| | |
|---|---|
| CodebookConfig-r18 ::= | SEQUENCE { |

| | |
|---|---|
| codebookType | CHOICE { |
| type2 | SEQUENCE { |

...

| n1-n2 | CHOICE { |
|---|---|
| two-one | |
| two-two | |
| four-one | |
| ... | |
| sixteen-one | |
| }, | |
| codebookSubsetRestrictionCommon-r18 BIT STRING (SIZE (X)), | |
| codebookSubsetRestriction-r18 | SEQUENCE (SIZE (1..maxNrofSPs)) OF |

codebookSubsetRestriction-r18-SP,

...

}

| | |
|---|---|
| codebookSubsetRestriction-r18-SP | BIT STRING (SIZE (11)), |

...

| | |
|---|---|
| maxNrofSPs | INTEGER ::= 4 |

...

| | |
|---|---|
| X :== | INTEGER (16,32,48,64,96,128) |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In another example, the higher-layer parameters ‘n1-n2’ and ‘codebookSubsetRestriction-r18’ can be as follows.

| | |
|---|---|
| CodebookConfig-r18 ::= | SEQUENCE { |

| | |
|---|---|
| codebookType | CHOICE { |
| type2 | SEQUENCE { |

...

| n1-n2 | CHOICE { |
|---|---|
| two-one | |
| two-two | |
| four-one | |
| ... | |
| sixteen-one | |
| }, | |
| codebookSubsetRestrictionCommon-r18 BIT STRING (SIZE (X)), | |
| codebookSubsetRestriction-r18-SP1 | BIT STRING (SIZE (11)), |
| codebookSubsetRestriction-r18-SP2 | BIT STRING (SIZE (11)), |
| ... | |
| codebookSubsetRestriction-r18-SPN | BIT STRING (SIZE (11)), |

...
}

| | |
|---|---|
| X :== | INTEGER (16,32,48,64,96,128) |

In one example, it is the same example as herein except that only hard amplitude restriction is allowed to configure (not allowing to configure soft amplitude restriction), where the hard amplitude restriction refers that its associated amplitudes can be either restricted to all 0 or no restricted, (hence freely selected using the configured codebook).

For example, it is not allowed to configure b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10 with a table such as the following table.

| | Maximum |
|---|---|
| | Average |
| | Coefficient |
| Bit | Amplitude |
| b₂^{(k, 2(N}^{₁}^{x}^{₂}^{+x}^{₁}⁾⁺¹⁾b₂^{(k, 2(N}^{₁}^{x}^{₂}^{+x}^{₁}⁾⁾ | γ_{i+pL} |
| 00 | 0 |
| 01 | \sqrt{¼} |
| 10 | \sqrt{½} |
| 11 | 1 |

In another example, there is no such a table since the hard restriction allows to configure either its associated amplitudes to be 0 or under no restriction (hence no equation on γ_{i+pL,r}) For example, a higher-layer parameter to indicate the hard restriction can be according to the following: bit ‘0’ corresponds to its associated amplitudes to be 0, and bit ‘1’ corresponds to it associated amplitudes having no restriction.

In another example, it is allowed to configure b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=0 or 1 with a table such as the following table.

| | Maximum |
|---|---|
| | Average |
| | Coefficient |
| Bit | Amplitude |
| b₂^{(k, 2(N}^{₁}^{x}^{₂}^{+x}^{₁}⁾⁺¹⁾b₂^{(k, 2(N}^{₁}^{x}^{₂}^{+x}^{₁}⁾⁾ | γ_{i+pL} |
| 0 | 0 |
| 1 | 1 |

In one example, for each example of higher-layer parameters (RRC signaling, or information elements) shown herein, the size of bit string can be computed based on 2-bits for B₂ (instead of 4-bits for B₂).

In one example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| codebookSubsetRestriction-r18 | BIT STRING (SIZE (8)), |

},

| | |
|---|---|
| two-two | SEQUENCE { |

| | |
|---|---|
| codebookSubsetRestriction-r18-trp1 | BIT STRING (SIZE (27)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| four-one | SEQUENCE { |

| | |
|---|---|
| codebookSubsetRestriction-r18 | BIT STRING (SIZE (16)), |

},

| | |
|---|---|
| three-two | SEQUENCE { |

| | |
|---|---|
| codebookSubsetRestriction-r18-trp1 | BIT STRING (SIZE (35)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| six-one | SEQUENCE { |

| | |
|---|---|
| codebookSubsetRestriction-r18 | BIT STRING (SIZE (24)), |

},

| | |
|---|---|
| four-two | SEQUENCE { |

| | |
|---|---|
| codebookSubsetRestriction-r18-trp1 | BIT STRING (SIZE (43)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| eight-one | SEQUENCE { |

| | |
|---|---|
| codebookSubsetRestriction-r18 | BIT STRING (SIZE (32)), |

},

| | |
|---|---|
| four-three | SEQUENCE { |

| | |
|---|---|
| codebookSubsetRestriction-r18-trp1 | BIT STRING (SIZE (59)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| six-two | SEQUENCE { |

| | |
|---|---|
| codebookSubsetRestriction-r18-trp1 | BIT STRING (SIZE (59)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| twelve-one | SEQUENCE { |

| | |
|---|---|
| codebookSubsetRestriction-r18 | BIT STRING (SIZE (48)), |

},

| | |
|---|---|
| four-four | SEQUENCE { |

| | |
|---|---|
| codebookSubsetRestriction-r18-trp1 | BIT STRING (SIZE (75)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| eight-two | SEQUENCE { |

| | |
|---|---|
| codebookSubsetRestriction-r18-trp1 | BIT STRING (SIZE (75)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| sixteen-one | SEQUENCE { |

| | |
|---|---|
| codebookSubsetRestriction-r18 | BIT STRING (SIZE (64)), |

```
          },
        },
```

In one example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| codebookSubsetRestriction-r18 | BIT STRING (SIZE (8)), |

},

| | |
|---|---|
| two-two | SEQUENCE { |

| | |
|---|---|
| codebookSubsetRestriction-r18-SP1 | BIT STRING (SIZE (27)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| four-one | SEQUENCE { |

| | |
|---|---|
| codebookSubsetRestriction-r18 | BIT STRING (SIZE (16)), |

},

| | |
|---|---|
| three-two | SEQUENCE { |

| | |
|---|---|
| codebookSubsetRestriction-r18-SP1 | BIT STRING (SIZE (35)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| six-one | SEQUENCE { |

| | |
|---|---|
| codebookSubsetRestriction-r18 | BIT STRING (SIZE (24)), |

},

| | |
|---|---|
| four-two | SEQUENCE { |

| | |
|---|---|
| codebookSubsetRestriction-r18-SP1 | BIT STRING (SIZE (43)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| eight-one | SEQUENCE { |

| | |
|---|---|
| codebookSubsetRestriction-r18 | BIT STRING (SIZE (32)), |

},

| | |
|---|---|
| four-three | SEQUENCE { |

| | |
|---|---|
| codebookSubsetRestriction-r18-SP1 | BIT STRING (SIZE (59)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| six-two | SEQUENCE { |

| | |
|---|---|
| codebookSubsetRestriction-r18-SP1 | BIT STRING (SIZE (59)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| twelve-one | SEQUENCE { |

| | |
|---|---|
| codebookSubsetRestriction-r18 | BIT STRING (SIZE (48)), |

},

| | |
|---|---|
| four-four | SEQUENCE { |

| | |
|---|---|
| codebookSubsetRestriction-r18-SP1 | BIT STRING (SIZE (75)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| eight-two | SEQUENCE { |

| | |
|---|---|
| codebookSubsetRestriction-r18-SP1 | BIT STRING (SIZE (75)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| sixteen-one | SEQUENCE { |

| | |
|---|---|
| codebookSubsetRestriction-r18 | BIT STRING (SIZE (64)), |

```
          },
        },
```

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| codebookSubsetRestriction-r18 | SEQUENCE (SIZE (1..maxNrofSPs)) OF |

BIT STRING (SIZE (8)),
},

| | |
|---|---|
| two-two | SEQUENCE { |

codebookSubsetRestrictionCommon-r18 BIT STRING (SIZE (16)),

| | |
|---|---|
| codebookSubsetRestriction-r18 | SEQUENCE (SIZE (1..maxNrofSPs)) OF |

BIT STRING (SIZE (11)),
},

| | |
|---|---|
| four-one | SEQUENCE { |
| codebookSubsetRestriction-r18 | SEQUENCE (SIZE (1..maxNrofSPs)) OF |

BIT STRING (SIZE (16)),

| | |
|---|---|
| three-two | SEQUENCE { |

codebookSubsetRestrictionCommon-r18 BIT STRING (SIZE (24)),

| | |
|---|---|
| codebookSubsetRestriction-r18 | SEQUENCE (SIZE (1..maxNrofSPs)) OF |

BIT STRING (SIZE (11)),
},

| | |
|---|---|
| six-one | SEQUENCE { |
| codebookSubsetRestriction-r18 | SEQUENCE (SIZE (1..maxNrofSPs)) OF |

BIT STRING (SIZE (24)),
},

| | |
|---|---|
| four-two | SEQUENCE { |

codebookSubsetRestrictionCommon-r18 BIT STRING (SIZE (32)),

| | |
|---|---|
| codebookSubsetRestriction-r18 | SEQUENCE (SIZE (1..maxNrofSPs)) OF |

BIT STRING (SIZE (11)),
},

| | |
|---|---|
| eight-one | SEQUENCE { |
| codebookSubsetRestriction-r18 | SEQUENCE (SIZE (1..maxNrofSPs)) OF |

BIT STRING (SIZE (32)),
},

| | |
|---|---|
| four-three | SEQUENCE { |

codebookSubsetRestrictionCommon-r18 BIT STRING (SIZE (48)),

| | |
|---|---|
| codebookSubsetRestriction-r18 | SEQUENCE (SIZE (1..maxNrofSPs)) OF |

BIT STRING (SIZE (11)),
},

| | |
|---|---|
| six-two | SEQUENCE { |

codebookSubsetRestrictionCommon-r18 BIT STRING (SIZE (48)),

| | |
|---|---|
| codebookSubsetRestriction-r18 | SEQUENCE (SIZE (1..maxNrofSPs)) OF |

BIT STRING (SIZE (11)),
},

| | |
|---|---|
| twelve-one | SEQUENCE { |
| codebookSubsetRestriction-r18 | SEQUENCE (SIZE (1..maxNrofSPs)) OF |

BIT STRING (SIZE (48)),
},

| | |
|---|---|
| four-four | SEQUENCE { |

codebookSubsetRestrictionCommon-r18 BIT STRING (SIZE (64)),

| | |
|---|---|
| codebookSubsetRestriction-r18 | SEQUENCE (SIZE (1..maxNrofSPs)) OF |

BIT STRING (SIZE (11)),
},

| | |
|---|---|
| eight-two | SEQUENCE { |

codebookSubsetRestrictionCommon-r18 BIT STRING (SIZE (64)),

| | |
|---|---|
| codebookSubsetRestriction-r18 | SEQUENCE (SIZE (1..maxNrofSPs)) OF |

BIT STRING (SIZE (11)),
},

| | |
|---|---|
| sixteen-one | SEQUENCE { |
| codebookSubsetRestriction-r18 | SEQUENCE (SIZE (1..maxNrofSPs)) OF |

```
BIT STRING (SIZE (128)),
          },
        },
        ...
```

| | |
|---|---|
| maxNrofSPs | INTEGER ::= 4 |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In another example, the higher-layer parameters ‘n1-n2’ and ‘codebookSubsetRestriction-r18’ can be as follows.

| | |
|---|---|
| CodebookConfig-r18 ::= | SEQUENCE { |

| | |
|---|---|
| codebookType | CHOICE { |
| type2 | SEQUENCE { |

...

| n1-n2 | CHOICE { |
|---|---|
| two-one | |
| two-two | |
| four-one | |
| ... | |
| sixteen-one | |
| }, | |
| codebookSubsetRestrictionCommon-r18 BIT STRING (SIZE (X)), | |
| codebookSubsetRestriction-r18 | SEQUENCE (SIZE (1..maxNrofSPs)) OF |

codebookSubsetRestriction-r18-SP,

...

}

| | |
|---|---|
| codebookSubsetRestriction-r18-SP | BIT STRING (SIZE (11)), |

...

| | |
|---|---|
| maxNrofSPs | INTEGER ::= 4 |

...

| | |
|---|---|
| X :== | INTEGER (8,16,24,32,48,64) |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In another example, the higher-layer parameters ‘n1-n2’ and ‘codebookSubsetRestriction-r18’ can be as follows.

| | |
|---|---|
| CodebookConfig-r18 ::= | SEQUENCE { |

| | |
|---|---|
| codebookType | CHOICE { |
| type2 | SEQUENCE { |

...

| n1-n2 | CHOICE { |
|---|---|
| two-one | |
| two-two | |
| four-one | |
| ... | |
| sixteen-one | |
| }, | |
| codebookSubsetRestrictionCommon-r18 BIT STRING (SIZE (X)), | |
| codebookSubsetRestriction-r18-SP1 | BIT STRING (SIZE (11)), |
| codebookSubsetRestriction-r18-SP2 | BIT STRING (SIZE (11)), |
| ... | |
| codebookSubsetRestriction-r18-SPN | BIT STRING (SIZE (11)), |

...
}

| | |
|---|---|
| X :== | INTEGER (8,16,24,32,48,64) |

As shown in the example above, the bit width for B₂ is changed from 2N₁N₂×4 to 2N₁N₂×2, and the bit width for B_{1,r} is maintained as 11 bits for N₂>1 or 0 bits for N₂=1.

In one example, the first parameter ‘n1-n2’ is TRP-common (or TRP-group common), i.e., the same value of (N₁, N₂) for all TRPs is configured with the first parameter. The second higher-layer parameter ‘codebookSubsetRestriction-r18’ is a bit-map parameter used to indicate restrictions on vector groups and (average) coefficient amplitudes associated with the vectors in the groups. The bit-map parameter ‘codebookSubsetRestriction-r18’ forms the bit sequence B=B₁B₂, and the vector group indices g^{(k)} (similar to as in clause 5.2.2.2.3 of TS 38.214 [9]) and is TRP-common, i.e., the same value for all TRPs. Bits b₂^{(k,2(N}^{₁}^{x}^{₂}^{+x}^{₁}⁾⁺¹⁾b₂^{(k,2(N}^{₁}^{x}^{₂}^{+x}^{₁}⁾⁾ indicate the maximum allowed average amplitude, γ_{i+pL} (p=0,1), with i∈{0, 1, . . . , L−1}, of the coefficients associated with the vector in group g^{(k)} indexed by x₁, x₂, for example, where the maximum amplitudes are given in Table 5.2.2.2.5-6 of TS 38.214 [9] and the average coefficient amplitude associated with the vector in group g^{(k)} is less than or equal to γ_{i+pL}. One example is as follows:

$$\sqrt{\frac{1}{{\sum }_{f = 0}^{{M}_{υ} - 1} {k}_{l , i + p L , f , r}^{( 3 )}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + pL} .$$

where k_{l,i+pL,f,r}⁽³⁾∈{0,1} is part of the bitmap indicator for TRP r, and indicates whether the corresponding coefficient is zero (when bit value=0) or non-zero (when bit value=1), p_{l,p,r}⁽¹⁾ is a (first) reference amplitude, and p_{l,i+pL,f,r}⁽²⁾ is a (second) differential amplitude coefficient, as described in 5.2.2.2.5 of TS 38.214.

For example, a UE that does not report the parameter ‘softAmpRestriction-r18’=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

In one example, the higher-layer parameters ‘n1-n2’ and ‘codebookSubsetRestriction-r18’ can be as follows.

| CodebookConfig-r18 ::= | SEQUENCE { |
|---|---|
| codebookType | CHOICE { |
| type2 | SEQUENCE { |
| ... | |
| n1-n2 | CHOICE { |
| two-one | SEQUENCE { |

| | |
|---|---|
| codebookSubsetRestriction-r18 | BIT STRING (SIZE (16)), |

| }, | |
|---|---|
| two-two | SEQUENCE { |

| | |
|---|---|
| codebookSubsetRestriction-r18 | BIT STRING (SIZE (43)), |

| }, | |
|---|---|
| four-one | SEQUENCE { |

| | |
|---|---|
| codebookSubsetRestriction-r18 | BIT STRING (SIZE (32)), |

| }, | |
|---|---|
| three-two | SEQUENCE { |

| | |
|---|---|
| codebookSubsetRestriction-r18 | BIT STRING (SIZE (59)), |

| }, | |
|---|---|
| six-one | SEQUENCE { |

| | |
|---|---|
| codebookSubsetRestriction-r18 | BIT STRING (SIZE (48)), |

| }, | |
|---|---|
| four-two | SEQUENCE { |

| | |
|---|---|
| codebookSubsetRestriction-r18 | BIT STRING (SIZE (75)), |

| }, | |
|---|---|
| eight-one | SEQUENCE { |

| | |
|---|---|
| codebookSubsetRestriction-r18 | BIT STRING (SIZE (64)), |

| }, | |
|---|---|
| four-three | SEQUENCE { |

| | |
|---|---|
| codebookSubsetRestriction-r18 | BIT STRING (SIZE (107)), |

| }, | |
|---|---|
| six-two | SEQUENCE { |

| | |
|---|---|
| codebookSubsetRestriction-r18 | BIT STRING (SIZE (107)), |

| }, | |
|---|---|
| twelve-one | SEQUENCE { |

| | |
|---|---|
| codebookSubsetRestriction-r18 | BIT STRING (SIZE (96)), |

| }, | |
|---|---|
| four-four | SEQUENCE { |

| | |
|---|---|
| codebookSubsetRestriction-r18 | BIT STRING (SIZE (139)), |

| }, | |
|---|---|
| eight-two | SEQUENCE { |

| | |
|---|---|
| codebookSubsetRestriction-r18 | BIT STRING (SIZE (139)), |

| }, | |
|---|---|
| sixteen-one | SEQUENCE { |

| | |
|---|---|
| codebookSubsetRestriction-r18 | BIT STRING (SIZE (128)), |

```
          },
        },
```

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

| two-one | |
|---|---|
| two-two | |
| four-one | |
| ... | |
| sixteen-one | |
| }, | |
| codebookSubsetRestriction-r18 | BIT STRING (SIZE |
| | (X)), |

...

}
...

| | |
|---|---|
| X :== | INTEGER (16,32,43,48,59,64,75,96,107,128,139) |

In one example, the first parameter ‘n1-n2’ is TRP-common (or TRP-group common), i.e., the same value of (N₁, N₂) for all TRPs is configured with the first parameter. The second higher-layer parameter ‘codebookSubsetRestriction-r18’ is a bit-map parameter used to indicate restrictions on vector groups only. For each TRP r=1, . . . , N_{TRP} (or TRP group), the bit-map parameter ‘codebookSubsetRestriction-r18’ forms the bit sequence B_{1,r}, and configures the vector group indices g^{(k,r)} (similar to as in clause 5.2.2.2.3 of TS 38.214 [9]). In other words, there is no amplitude restriction, i.e., no B₂ is defined.

In one example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

two-one,

| | |
|---|---|
| two-two | SEQUENCE { |

| | |
|---|---|
| codebookSubsetRestriction-r18-trp1 | BIT STRING (SIZE (11)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

```
          },
          four-one,
```

| | |
|---|---|
| three-two | SEQUENCE { |

| | |
|---|---|
| codebookSubsetRestriction-r18-trp1 | BIT STRING (SIZE (11)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

```
          },
          six-one,
```

| | |
|---|---|
| four-two | SEQUENCE { |

| | |
|---|---|
| codebookSubsetRestriction-r18-trp1 | BIT STRING (SIZE (11)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

```
          },
          eight-one,
```

| | |
|---|---|
| four-three | SEQUENCE { |

| | |
|---|---|
| codebookSubsetRestriction-r18-trp1 | BIT STRING (SIZE (11)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| six-two | SEQUENCE { |

| | |
|---|---|
| codebookSubsetRestriction-r18-trp1 | BIT STRING (SIZE (11)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

```
          },
          twelve-one,
```

| | |
|---|---|
| four-four | SEQUENCE { |

| | |
|---|---|
| codebookSubsetRestriction-r18-trp1 | BIT STRING (SIZE (11)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

},

| | |
|---|---|
| eight-two | SEQUENCE { |

| | |
|---|---|
| codebookSubsetRestriction-r18-trp1 | BIT STRING (SIZE (11)), |
| codebookSubsetRestriction-r18-trp2 | BIT STRING (SIZE (11)), |

...

| | |
|---|---|
| codebookSubsetRestriction-r18-trpN | BIT STRING (SIZE (11)), |

```
          },
          sixteen-one,
        },
```

In one example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

two-one,

| | |
|---|---|
| two-two | SEQUENCE { |

| | |
|---|---|
| codebookSubsetRestriction-r18-SP1 | BIT STRING (SIZE (11)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

```
          },
          four-one,
```

| | |
|---|---|
| three-two | SEQUENCE { |

| | |
|---|---|
| codebookSubsetRestriction-r18-SP1 | BIT STRING (SIZE (11)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

```
          },
          six-one,
```

| | |
|---|---|
| four-two | SEQUENCE { |

| | |
|---|---|
| codebookSubsetRestriction-r18-SP1 | BIT STRING (SIZE (11)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

```
          },
          eight-one,
```

| | |
|---|---|
| four-three | SEQUENCE { |

| | |
|---|---|
| codebookSubsetRestriction-r18-SP1 | BIT STRING (SIZE (11)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| six-two | SEQUENCE { |

| | |
|---|---|
| codebookSubsetRestriction-r18-SP1 | BIT STRING (SIZE (11)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

```
          },
          twelve-one,
```

| | |
|---|---|
| four-four | SEQUENCE { |

| | |
|---|---|
| codebookSubsetRestriction-r18-SP1 | BIT STRING (SIZE (11)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

},

| | |
|---|---|
| eight-two | SEQUENCE { |

| | |
|---|---|
| codebookSubsetRestriction-r18-SP1 | BIT STRING (SIZE (11)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

```
          },
          sixteen-one,
        },
```

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

two-one,

| | |
|---|---|
| two-two | SEQUENCE { |

| | |
|---|---|
| codebookSubsetRestriction-r18 | SEQUENCE (SIZE (1..maxNrofSPs)) OF |

```
BIT STRING (SIZE (11)),
          },
          four-one,
```

| | |
|---|---|
| three-two | SEQUENCE { |

| | |
|---|---|
| codebookSubsetRestriction-r18 | SEQUENCE (SIZE (1..maxNrofSPs)) OF |

```
BIT STRING (SIZE (11)),
          },
          six-one,
```

| | |
|---|---|
| four-two | SEQUENCE { |

| | |
|---|---|
| codebookSubsetRestriction-r18 | SEQUENCE (SIZE (1..maxNrofSPs)) OF |

```
BIT STRING (SIZE (11)),
          },
          eight-one,
```

| | |
|---|---|
| four-three | SEQUENCE { |

| | |
|---|---|
| codebookSubsetRestriction-r18 | SEQUENCE (SIZE (1..maxNrofSPs)) OF |

BIT STRING (SIZE (11)),
},

| | |
|---|---|
| six-two | SEQUENCE { |

| | |
|---|---|
| codebookSubsetRestriction-r18 | SEQUENCE (SIZE |

```
(1..maxNrofSPs)) OF BIT STRING (SIZE (11)),
          },
          twelve-one,
```

| | |
|---|---|
| four-four | SEQUENCE { |

| | |
|---|---|
| codebookSubsetRestriction-r18 | SEQUENCE (SIZE |

(1..maxNrofSPs)) OF BIT STRING (SIZE (11)),
},

| | |
|---|---|
| eight-two | SEQUENCE { |

| | |
|---|---|
| codebookSubsetRestriction-r18 | SEQUENCE (SIZE |

```
(1..maxNrofSPs)) OF BIT STRING (SIZE (11)),
          },
          sixteen-one,
        },
        ...
```

| | |
|---|---|
| maxNrofSPs | INTEGER ::= 4 |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

```
          two-one
          two-two
          four-one
          ...
          sixteen-one
          },
```

| | |
|---|---|
| codebookSubsetRestriction-r18 | SEQUENCE (SIZE (1..maxNrofSPs)) OF |

codebookSubsetRestriction-r18-SP,
...
}

| | |
|---|---|
| codebookSubsetRestriction-r18-SP | BIT STRING (SIZE (11)), |

...

| | |
|---|---|
| maxNrofSPs | INTEGER ::= 4 |

...

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In another example, the higher-layer parameters ‘n1-n2’ and ‘codebookSubsetRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

```
          two-one
          two-two
          four-one
          ...
          sixteen-one
          },
```

| | |
|---|---|
| codebookSubsetRestriction-r18-SP1 | BIT STRING (SIZE (11)), |
| codebookSubsetRestriction-r18-SP2 | BIT STRING (SIZE (11)), |

...

| | |
|---|---|
| codebookSubsetRestriction-r18-SPN | BIT STRING (SIZE (11)), |

...
}

In one embodiment, a UE is configured with higher layer parameter codebookType set to, e.g., ‘typeII-r18-cjt’. Two high-layer parameters are used, one to configure N₁, N₂ values and another to configure codebook subset restrictions, respectively. For example, a first higher-layer parameter can be denoted as ‘n1-n2’ and a second higher-layer parameter can be denoted as ‘codebookSubsetRestriction-r18’. Here, ‘n1-n2’ is TRP-specific, i.e., the value of (N₁, N₂) is configured for each TRP.

In one example, the higher-layer parameter ‘n1-n2’ can be as follows. The other higher-layer parameter ‘codebookSubsetRestriction-r18’ can be according to one of the examples shown herein.

| CodebookConfig-r18 ::= | SEQUENCE { |
|---|---|
| codebookType | CHOICE { |
| type2 | SEQUENCE { |
| ... | |
| n1-n2-SP#1 | CHOICE { |
| two-one | |
| two-two | |
| four-one | |
| ... | |
| sixteen-one | |
| }, | |
| n1-n2-SP#2 | CHOICE { |
| two-one | |
| two-two | |
| four-one | |
| ... | |
| sixteen-one | |
| }, | |
| ... | |
| n1-n2-SP#N | CHOICE { |

```
          two-one
          two-two
          four-one
          ...
          sixteen-one
          },
            }
```

In one example, the higher-layer parameter ‘n1-n2’ can be as follows. The other higher-layer parameter ‘codebookSubsetRestriction-r18’ can be according to one of the examples shown herein.

| | |
|---|---|
| CodebookConfig-r18 ::= | SEQUENCE { |
| codebookType | CHOICE { |
| type2 | SEQUENCE { |

...

| | |
|---|---|
| n1-n2-r18 | SEQUENCE (SIZE (1..maxNrofSPs)) OF n1-n2, |

...

}

| | |
|---|---|
| n1-n2 | CHOICE { |
| | two-one |
| | two-two |
| | four-one |
| | ... |
| | sixteen-one |
| | }, |

...

| | |
|---|---|
| maxNrofSPs | INTEGER ::= 4 |

In one example, the first parameter ‘n1-n2’ is TRP-specific, i.e., the value of (N₁, N₂) is configured for each TRP, details as above. The second higher-layer parameter ‘codebookSubsetRestriction-r18’ is a bit-map parameter used to indicate restrictions on vector groups and (average) coefficient amplitudes associated with the vectors in the groups, the details as described herein.

In one example, the first parameter ‘n1-n2’ is TRP-specific, i.e., the value of (N₁, N₂) is configured for each TRP, details as above. The second higher-layer parameter ‘codebookSubsetRestriction-r18’ is a bit-map parameter used to indicate restrictions on vector groups and (average) coefficient amplitudes associated with the vectors in the groups, the details as described herein.

In one example, the first parameter ‘n1-n2’ is TRP-specific, i.e., the value of (N₁, N₂) is configured for each TRP, details as above. The second higher-layer parameter ‘codebookSubsetRestriction-r18’ is a bit-map parameter used to indicate restrictions on vector groups and (average) coefficient amplitudes associated with the vectors in the groups, the details as described herein.

In one example, the first parameter ‘n1-n2’ is TRP-specific, i.e., the value of (N₁, N₂) is configured for each TRP, details as above. The second higher-layer parameter ‘codebookSubsetRestriction-r18’ is a bit-map parameter used to indicate restrictions on vector groups and (average) coefficient amplitudes associated with the vectors in the groups, the details as described herein.

In one example, the first parameter ‘n1-n2’ is TRP-specific, i.e., the value of (N₁, N₂) is configured for each TRP, details as above. The second higher-layer parameter ‘codebookSubsetRestriction-r18’ is a bit-map parameter used to indicate restrictions on vector groups, and the details as described herein.

In one embodiment, a UE is configured with higher layer parameter codebookType set to, e.g., ‘typeII-r18-cjt’. Three high-layer parameters are used to configure (N₁, N₂), vector group restriction, and coefficient amplitude restriction, respectively. For example, a first higher-layer parameter can be denoted as ‘n1-n2’, a second higher-layer parameter can be denoted as ‘vectorGroupRestriction-r18’, and a third higher-layer parameter can be denoted as ‘amplitudeRestriction-r18’, respectively.

In one example, the first parameter ‘n1-n2’ is TRP-common (or TRP-group common), i.e., the same value of (N₁, N₂) for all TRPs is configured with the first parameter. The second higher-layer parameter ‘vectorGroupRestriction-r18’ is a bit-map parameter used to indicate restrictions on vector groups, and the third higher-layer parameter ‘amplitudeRestriction-r18’ is a bit-map parameter used to indicate restriction on (average) coefficient amplitudes associated with the vectors in the groups. For each TRP r=1, . . . , N_{TRP} (or TRP group), the bit-map parameter ‘vectorGroupRestriction-r18’ forms the bit sequence B_{1,r}, and configures the vector group indices g^{(k,r)} (similar to as in clause 5.2.2.2.3 of TS 38.214 [9]). The bit-map parameter ‘amplitudeRestriction-r18’ forms the bit sequence B_{2,r} for each TRP r=1, . . . , N_{TRP} (or TRP group). Bits b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾ indicate the maximum allowed average amplitude, γ_{i+pL,r} (p=0,1), with i∈{0, 1, . . . , L−1}, of the coefficients associated with the vector in group g^{(k,r)} indexed by x₁, x₂, for example, where the maximum amplitudes are given in Table 5.2.2.2.5-6 of TS 38.214 [9] and the average coefficient amplitude associated with the vector in group g^{(k,r)} is less than or equal to γ_{i+pL,r}. One example is as follows:

$$\sqrt{\frac{1}{{\sum }_{f = 0}^{{M}_{υ} - 1} {k}_{l , i + p L , f , r}^{( 3 )}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + pL , r} .$$

where k_{l,i+pL,f,r}⁽³⁾∈{0,1} is part of the bitmap indicator for TRP r, and indicates whether the corresponding coefficient is zero (when bit value=0) or non-zero (when bit value=1), p_{l,p,r}⁽¹⁾ is a (first) reference amplitude, and p_{l,i+pL,f,r}⁽²⁾ is a (second) differential amplitude coefficient, as described in 5.2.2.2.5 of TS 38.214.

For example, a UE that does not report the parameter ‘softAmpRestriction-r18’=‘supported’ in its capability signaling is not expected to be configured with b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=01 or 10.

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| amplitude Restriction-r18-trp1 | BIT STRING (SIZE (16)), |
| amplitude Restriction-r18-trp2 | BIT STRING (SIZE (16)), |

...

| | |
|---|---|
| amplitude Restriction-r18-trpN | BIT STRING (SIZE (16)), |

},

| | |
|---|---|
| two-two | SEQUENCE { |

| | |
|---|---|
| vectorGroupRestriction-r18-trp1 | BIT STRING (SIZE (11)), |
| amplitude Restriction-r18-trp1 | BIT STRING (SIZE (32)), |
| vectorGroupRestriction-r18-trp2 | BIT STRING (SIZE (11)), |
| amplitude Restriction-r18-trp2 | BIT STRING (SIZE (32)), |

...

| | |
|---|---|
| vectorGroupRestriction-r18-trpN | BIT STRING (SIZE (11)), |
| amplitudeRestriction-r18-trpN | BIT STRING (SIZE (32)), |

},

| | |
|---|---|
| four-one | SEQUENCE { |

| | |
|---|---|
| amplitudeRestriction-r18-trp1 | BIT STRING (SIZE (32)), |
| amplitudeRestriction-r18-trp2 | BIT STRING (SIZE (32)), |

...

| | |
|---|---|
| amplitudeRestriction-r18-trpN | BIT STRING (SIZE (32)), |

},

| | |
|---|---|
| three-two | SEQUENCE { |

| | |
|---|---|
| vectorGroupRestriction-r18-trp1 | BIT STRING (SIZE (11)), |
| amplitudeRestriction-r18-trp1 | BIT STRING (SIZE (48)), |
| vectorGroupRestriction-r18-trp2 | BIT STRING (SIZE (11)), |
| amplitudeRestriction-r18-trp2 | BIT STRING (SIZE (48)), |

...

| | |
|---|---|
| vectorGroupRestriction-r18-trpN | BIT STRING (SIZE (11)), |
| amplitudeRestriction-r18-trpN | BIT STRING (SIZE (48)), |

},

| | |
|---|---|
| six-one | SEQUENCE { |

| | |
|---|---|
| amplitudeRestriction-r18-trp1 | BIT STRING (SIZE (48)), |
| amplitudeRestriction-r18-trp2 | BIT STRING (SIZE (48)), |

...

| | |
|---|---|
| amplitudeRestriction-r18-trpN | BIT STRING (SIZE (48)), |

},

| | |
|---|---|
| four-two | SEQUENCE { |

| | |
|---|---|
| vectorGroupRestriction-r18-trp1 | BIT STRING (SIZE (11)), |
| amplitudeRestriction-r18-trp1 | BIT STRING (SIZE (64)), |
| vectorGroupRestriction-r18-trp2 | BIT STRING (SIZE (11)), |
| amplitude Restriction-r18-trp2 | BIT STRING (SIZE (64)), |

...

| | |
|---|---|
| vectorGroupRestriction-r18-trpN | BIT STRING (SIZE (11)), |
| amplitudeRestriction-r18-trpN | BIT STRING (SIZE (64)), |

},

| | |
|---|---|
| eight-one | SEQUENCE { |

| | |
|---|---|
| amplitudeRestriction-r18-trp1 | BIT STRING (SIZE (64)), |
| amplitudeRestriction-r18-trp2 | BIT STRING (SIZE (64)), |

...

| | |
|---|---|
| amplitudeRestriction-r18-trpN | BIT STRING (SIZE (64)), |

},

| | |
|---|---|
| four-three | SEQUENCE { |

| | |
|---|---|
| vectorGroupRestriction-r18-trp1 | BIT STRING (SIZE (11)), |
| amplitudeRestriction-r18-trp1 | BIT STRING (SIZE (96)), |
| vectorGroupRestriction-r18-trp2 | BIT STRING (SIZE (11)), |
| amplitudeRestriction-r18-trp2 | BIT STRING (SIZE (96)), |

...

| | |
|---|---|
| vectorGroupRestriction-r18-trpN | BIT STRING (SIZE (11)), |
| amplitudeRestriction-r18-trpN | BIT STRING (SIZE (96)), |

},

| | |
|---|---|
| six-two | SEQUENCE { |

| | |
|---|---|
| vectorGroupRestriction-r18-trp1 | BIT STRING (SIZE (11)), |
| amplitude Restriction-r18-trp1 | BIT STRING (SIZE (96)), |
| vectorGroupRestriction-r18-trp2 | BIT STRING (SIZE (11)), |
| amplitudeRestriction-r18-trp2 | BIT STRING (SIZE (96)), |

...

| | |
|---|---|
| vectorGroupRestriction-r18-trpN | BIT STRING (SIZE (11)), |
| amplitude Restriction-r18-trpN | BIT STRING (SIZE (96)), |

},

| | |
|---|---|
| twelve-one | SEQUENCE { |

| | |
|---|---|
| amplitude Restriction-r18-trp1 | BIT STRING (SIZE (96)), |
| amplitude Restriction-r18-trp2 | BIT STRING (SIZE (96)), |

...

| | |
|---|---|
| amplitudeRestriction-r18-trpN | BIT STRING (SIZE (96)), |

},

| | |
|---|---|
| four-four | SEQUENCE { |

| | |
|---|---|
| vectorGroupRestriction-r18-trp1 | BIT STRING (SIZE (11)), |
| amplitude Restriction-r18-trp1 | BIT STRING (SIZE (128)), |
| vectorGroupRestriction-r18-trp2 | BIT STRING (SIZE (11)), |
| amplitude Restriction-r18-trp2 | BIT STRING (SIZE (128)), |

...

| | |
|---|---|
| vectorGroupRestriction-r18-trpN | BIT STRING (SIZE (11)), |
| amplitudeRestriction-r18-trpN | BIT STRING (SIZE (128)), |

},

| | |
|---|---|
| eight-two | SEQUENCE { |

| | |
|---|---|
| vectorGroupRestriction-r18-trp1 | BIT STRING (SIZE (11)), |
| amplitude Restriction-r18-trp1 | BIT STRING (SIZE (128)), |
| vectorGroupRestriction-r18-trp2 | BIT STRING (SIZE (11)), |
| amplitude Restriction-r18-trp2 | BIT STRING (SIZE (128)), |

...

| | |
|---|---|
| vectorGroupRestriction-r18-trpN | BIT STRING (SIZE (11)), |
| amplitude Restriction-r18-trpN | BIT STRING (SIZE (128)), |

},

| | |
|---|---|
| sixteen-one | SEQUENCE { |

| | |
|---|---|
| amplitudeRestriction-r18-trp1 | BIT STRING (SIZE (128)), |
| amplitudeRestriction-r18-trp2 | BIT STRING (SIZE (128)), |

...

| | |
|---|---|
| amplitudeRestriction-r18-trpN | BIT STRING (SIZE (128)), |

```
          },
        },
        ...
```

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| amplitudeRestriction-r18-SP1 | BIT STRING (SIZE (16)), |
| amplitudeRestriction-r18-SP2 | BIT STRING (SIZE (16)), |

...

| | |
|---|---|
| amplitudeRestriction-r18-SPN | BIT STRING (SIZE (16)), |

},

| | |
|---|---|
| two-two | SEQUENCE { |

| | |
|---|---|
| vectorGroupRestriction-r18-SP1 | BIT STRING (SIZE (11)), |
| amplitudeRestriction-r18-SP1 | BIT STRING (SIZE (32)), |
| vectorGroupRestriction-r18-SP2 | BIT STRING (SIZE (11)), |
| amplitudeRestriction-r18-SP2 | BIT STRING (SIZE (32)), |

...

| | |
|---|---|
| vectorGroupRestriction-r18-SPN | BIT STRING (SIZE (11)), |
| amplitudeRestriction-r18-SPN | BIT STRING (SIZE (32)), |

},

| | |
|---|---|
| four-one | SEQUENCE { |

| | |
|---|---|
| amplitudeRestriction-r18-SP1 | BIT STRING (SIZE (32)), |
| amplitudeRestriction-r18-SP2 | BIT STRING (SIZE (32)), |

...

| | |
|---|---|
| amplitude Restriction-r18-SPN | BIT STRING (SIZE (32)), |

},

| | |
|---|---|
| three-two | SEQUENCE { |

| | |
|---|---|
| vectorGroupRestriction-r18-SP1 | BIT STRING (SIZE (11)), |
| amplitudeRestriction-r18-SP1 | BIT STRING (SIZE (48)), |
| vectorGroupRestriction-r18-SP2 | BIT STRING (SIZE (11)), |
| amplitudeRestriction-r18-SP2 | BIT STRING (SIZE (48)), |

...

| | |
|---|---|
| vectorGroupRestriction-r18-SPN | BIT STRING (SIZE (11)), |
| amplitudeRestriction-r18-SPN | BIT STRING (SIZE (48)), |

},

| | |
|---|---|
| six-one | SEQUENCE { |

| | |
|---|---|
| amplitudeRestriction-r18-SP1 | BIT STRING (SIZE (48)), |
| amplitudeRestriction-r18-SP2 | BIT STRING (SIZE (48)), |

...

| | |
|---|---|
| amplitudeRestriction-r18-SPN | BIT STRING (SIZE (48)), |

},

| | |
|---|---|
| four-two | SEQUENCE { |

| | |
|---|---|
| vectorGroupRestriction-r18-SP1 | BIT STRING (SIZE (11)), |
| amplitudeRestriction-r18-SP1 | BIT STRING (SIZE (64)), |
| vectorGroupRestriction-r18-SP2 | BIT STRING (SIZE (11)), |
| amplitudeRestriction-r18-SP2 | BIT STRING (SIZE (64)), |

...

| | |
|---|---|
| vectorGroupRestriction-r18-SPN | BIT STRING (SIZE (11)), |
| amplitudeRestriction-r18-SPN | BIT STRING (SIZE (64)), |

},

| | |
|---|---|
| eight-one | SEQUENCE { |

| | |
|---|---|
| amplitudeRestriction-r18-SP1 | BIT STRING (SIZE (64)), |
| amplitudeRestriction-r18-SP2 | BIT STRING (SIZE (64)), |

...

| | |
|---|---|
| amplitudeRestriction-r18-SPN | BIT STRING (SIZE (64)), |

},

| | |
|---|---|
| four-three | SEQUENCE { |

| | |
|---|---|
| vectorGroupRestriction-r18-SP1 | BIT STRING (SIZE (11)), |
| amplitudeRestriction-r18-SP1 | BIT STRING (SIZE (96)), |
| vectorGroupRestriction-r18-SP2 | BIT STRING (SIZE (11)), |
| amplitude Restriction-r18-SP2 | BIT STRING (SIZE (96)), |

...

| | |
|---|---|
| vectorGroupRestriction-r18-SPN | BIT STRING (SIZE (11)), |
| amplitude Restriction-r18-SPN | BIT STRING (SIZE (96)), |

},

| | |
|---|---|
| six-two | SEQUENCE { |

| | |
|---|---|
| vectorGroupRestriction-r18-SP1 | BIT STRING (SIZE (11)), |
| amplitude Restriction-r18-SP1 | BIT STRING (SIZE (96)), |
| vectorGroupRestriction-r18-SP2 | BIT STRING (SIZE (11)), |
| amplitudeRestriction-r18-SP2 | BIT STRING (SIZE (96)), |

...

| | |
|---|---|
| vectorGroupRestriction-r18-SPN | BIT STRING (SIZE (11)), |
| amplitude Restriction-r18-SPN | BIT STRING (SIZE (96)), |

},

| | |
|---|---|
| twelve-one | SEQUENCE { |

| | |
|---|---|
| amplitudeRestriction-r18-SP1 | BIT STRING (SIZE (96)), |
| amplitudeRestriction-r18-SP2 | BIT STRING (SIZE (96)), |

...

| | |
|---|---|
| amplitudeRestriction-r18-SPN | BIT STRING (SIZE (96)), |

},

| | |
|---|---|
| four-four | SEQUENCE { |

| | |
|---|---|
| vectorGroupRestriction-r18-SP1 | BIT STRING (SIZE (11)), |
| amplitudeRestriction-r18-SP1 | BIT STRING (SIZE (128)), |
| vectorGroupRestriction-r18-SP2 | BIT STRING (SIZE (11)), |
| amplitudeRestriction-r18-SP2 | BIT STRING (SIZE (128)), |

...

| | |
|---|---|
| vectorGroupRestriction-r18-SPN | BIT STRING (SIZE (11)), |
| amplitude Restriction-r18-SPN | BIT STRING (SIZE (128)), |

},

| | |
|---|---|
| eight-two | SEQUENCE { |

| | |
|---|---|
| vectorGroupRestriction-r18-SP1 | BIT STRING (SIZE (11)), |
| amplitudeRestriction-r18-SP1 | BIT STRING (SIZE (128)), |
| vectorGroupRestriction-r18-SP2 | BIT STRING (SIZE (11)), |
| amplitudeRestriction-r18-SP2 | BIT STRING (SIZE (128)), |

...

| | |
|---|---|
| vectorGroupRestriction-r18-SPN | BIT STRING (SIZE (11)), |
| amplitudeRestriction-r18-SPN | BIT STRING (SIZE (128)), |

},

| | |
|---|---|
| sixteen-one | SEQUENCE { |

| | |
|---|---|
| amplitude Restriction-r18-SP1 | BIT STRING (SIZE (128)), |
| amplitudeRestriction-r18-SP2 | BIT STRING (SIZE (128)), |

...

| | |
|---|---|
| amplitudeRestriction-r18-SPN | BIT STRING (SIZE (128)), |

```
          },
        },
...
```

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| amplitudeRestriction-r18 | SEQUENCE (SIZE (1..maxNrofSPs)) OF BIT |

STRING (SIZE (16)),
},

| | |
|---|---|
| two-two | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (32)),
},

| | |
|---|---|
| four-one | SEQUENCE { |

| | |
|---|---|
| amplitudeRestriction-r18 | SEQUENCE (SIZE (1..maxNrofSPs)) OF BIT |

STRING (SIZE (32)),
},

| | |
|---|---|
| three-two | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (48)),
},

| | |
|---|---|
| six-one | SEQUENCE { |

| | |
|---|---|
| amplitudeRestriction-r18 | SEQUENCE (SIZE (1..maxNrofSPs)) OF BIT |

STRING (SIZE (48)),
},

| | |
|---|---|
| four-two | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (64)),
},

| | |
|---|---|
| eight-one | SEQUENCE { |

| | |
|---|---|
| amplitudeRestriction-r18 | SEQUENCE (SIZE (1..maxNrofSPs)) OF BIT |

STRING (SIZE (64)),
},

| | |
|---|---|
| four-three | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (96)),
},

| | |
|---|---|
| six-two | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (96)),
},

| | |
|---|---|
| twelve-one | SEQUENCE { |

| | |
|---|---|
| amplitudeRestriction -r18 | SEQUENCE (SIZE (1..maxNrofSPs)) OF BIT |

STRING (SIZE (96)),
},

| | |
|---|---|
| four-four | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (128)),
},

| | |
|---|---|
| eight-two | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (128)),
},

| | |
|---|---|
| sixteen-one | SEQUENCE { |

| | |
|---|---|
| amplitudeRestriction-r18 | SEQUENCE (SIZE (1..maxNrofSPs)) OF BIT |

```
STRING (SIZE (128)),
          },
        },
        ...
```

| | |
|---|---|
| maxNrofSPs | INTEGER ::= 4 |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

| two-one | |
|---|---|
| two-two | |
| four-one | |
| ... | |
| sixteen-one | |
| }, | |
| vectorGroupRestriction-r18 | SEQUENCE (SIZE (1..maxNrofSPs)) OF BIT |

STRING (SIZE (11)),

| | |
|---|---|
| amplitudeRestriction-r18 | SEQUENCE (SIZE (1..maxNrofSPs)) OF BIT |

STRING (SIZE (X)),

...

}

| | |
|---|---|
| maxNrofSPs | INTEGER ::= 4 |

...

| | |
|---|---|
| X :== | INTEGER (16,32,48,64,96,128) |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

| two-one | |
|---|---|
| two-two | |
| four-one | |
| ... | |
| sixteen-one | |
| }, | |
| vectorGroupRestriction-r18-SP1 | BIT STRING (SIZE (11)), |
| amplitudeRestriction-r18-SP1 | BIT STRING (SIZE (X)), |
| vectorGroupRestriction-r18-SP2 | BIT STRING (SIZE (11)), |
| amplitudeRestriction-r18-SP2 | BIT STRING (SIZE (X)), |
| ... | |
| vectorGroupRestriction-r18-SPN | BIT STRING (SIZE (11)), |
| amplitudeRestriction-r18-SPN | BIT STRING (SIZE (X)), |

...
}

| | |
|---|---|
| X :== | INTEGER (16,32,48,64,96,128) |

In one example, it is the same example as herein except that only hard amplitude restriction is allowed to configure (not allowing to configure soft amplitude restriction), where the hard amplitude restriction refers that its associated amplitudes can be either restricted to all 0 or no restricted, (hence freely selected using the configured codebook).

For example, it is not allowed to configure b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=01 or 10 with a table such as the following table.

| | Maximum |
|---|---|
| | Average |
| | Coefficient |
| Bit | Amplitude |
| b_{2, r}^{(k, 2(N}^{₁}^{x}^{₂}^{+x}^{₁}⁾⁺¹⁾b_{2, r}^{(k, 2(N}^{₁}^{x}^{₂}^{+x}^{₁}⁾⁾ | γ_{i+pL, r} |
| 00 | 0 |
| 01 | \sqrt{¼} |
| 10 | \sqrt{½} |
| 11 | 1 |

In another example, there is no such a table since the hard restriction allows to configure either its associated amplitudes to be 0 or under no restriction. For example, a higher-layer parameter to indicate the hard restriction can be according to the following: bit ‘0’ corresponds to its associated amplitudes to be 0, and bit ‘1’ corresponds to it associated amplitudes having no restriction.

In another example, it is allowed to configure b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=0 or 1 with a table such as the following table.

| | Maximum |
|---|---|
| | Average |
| | Coefficient |
| Bit | Amplitude |
| b_{2, r}^{(k, 2(N}^{₁}^{x}^{₂}^{+x}^{₁}⁾⁺¹⁾b_{2, r}^{(k, 2(N}^{₁}^{x}^{₂}^{+x}^{₁}⁾⁾ | γ_{i+pL, r} |
| 0 | 0 |
| 1 | 1 |

In one example, for each example of higher-layer parameters (RRC signaling, or information elements) shown herein, the size of bit string can be computed based on 2-bits for B_{2,r} (instead of 4-bits for B_{2,r}).

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| amplitudeRestriction-r18-trp1 | BIT STRING (SIZE (8)), |
| amplitudeRestriction-r18-trp2 | BIT STRING (SIZE (8)), |

...

| | |
|---|---|
| amplitudeRestriction-r18-trpN | BIT STRING (SIZE (8)), |

},

| | |
|---|---|
| two-two | SEQUENCE { |

| | |
|---|---|
| vectorGroupRestriction-r18-trp1 | BIT STRING (SIZE (11)), |
| amplitudeRestriction-r18-trp1 | BIT STRING (SIZE (16)), |
| vectorGroupRestriction-r18-trp2 | BIT STRING (SIZE (11)), |
| amplitudeRestriction-r18-trp2 | BIT STRING (SIZE (16)), |

...

| | |
|---|---|
| vectorGroupRestriction-r18-trpN | BIT STRING (SIZE (11)), |
| amplitudeRestriction-r18-trpN | BIT STRING (SIZE (16)), |

},

| | |
|---|---|
| four-one | SEQUENCE { |

| | |
|---|---|
| amplitudeRestriction-r18-trp1 | BIT STRING (SIZE (16)), |
| amplitudeRestriction-r18-trp2 | BIT STRING (SIZE (16)), |

...

| | |
|---|---|
| amplitudeRestriction-r18-trpN | BIT STRING (SIZE (16)), |

},

| | |
|---|---|
| three-two | SEQUENCE { |

| | |
|---|---|
| vectorGroupRestriction-r18-trp1 | BIT STRING (SIZE (11)), |
| amplitudeRestriction-r18-trp1 | BIT STRING (SIZE (24)), |
| vectorGroupRestriction-r18-trp2 | BIT STRING (SIZE (11)), |
| amplitudeRestriction-r18-trp2 | BIT STRING (SIZE (24)), |

...

| | |
|---|---|
| vectorGroupRestriction-r18-trpN | BIT STRING (SIZE (11)), |
| amplitudeRestriction-r18-trpN | BIT STRING (SIZE (24)), |

},

| | |
|---|---|
| six-one | SEQUENCE { |

| | |
|---|---|
| amplitudeRestriction-r18-trp1 | BIT STRING (SIZE (24)), |
| amplitudeRestriction-r18-trp2 | BIT STRING (SIZE (24)), |

...

| | |
|---|---|
| amplitudeRestriction-r18-trpN | BIT STRING (SIZE (24)), |

},

| | |
|---|---|
| four-two | SEQUENCE { |

| | |
|---|---|
| vectorGroupRestriction-r18-trp1 | BIT STRING (SIZE (11)), |
| amplitudeRestriction-r18-trp1 | BIT STRING (SIZE (32)), |
| vectorGroupRestriction-r18-trp2 | BIT STRING (SIZE (11)), |
| amplitudeRestriction-r18-trp2 | BIT STRING (SIZE (32)), |

...

| | |
|---|---|
| vectorGroupRestriction-r18-trpN | BIT STRING (SIZE (11)), |
| amplitudeRestriction-r18-trpN | BIT STRING (SIZE (32)), |

},

| | |
|---|---|
| eight-one | SEQUENCE { |

| | |
|---|---|
| amplitudeRestriction-r18-trp1 | BIT STRING (SIZE (32)), |
| amplitudeRestriction-r18-trp2 | BIT STRING (SIZE (32)), |

...

| | |
|---|---|
| amplitudeRestriction-r18-trpN | BIT STRING (SIZE (32)), |

},

| | |
|---|---|
| four-three | SEQUENCE { |

| | |
|---|---|
| vectorGroupRestriction-r18-trp1 | BIT STRING (SIZE (11)), |
| amplitudeRestriction-r18-trp1 | BIT STRING (SIZE (48)), |
| vectorGroupRestriction-r18-trp2 | BIT STRING (SIZE (11)), |
| amplitudeRestriction-r18-trp2 | BIT STRING (SIZE (48)), |

...

| | |
|---|---|
| vectorGroupRestriction-r18-trpN | BIT STRING (SIZE (11)), |
| amplitudeRestriction-r18-trpN | BIT STRING (SIZE (48)), |

},

| | |
|---|---|
| six-two | SEQUENCE { |

| | |
|---|---|
| vectorGroupRestriction-r18-trp1 | BIT STRING (SIZE (11)), |
| amplitudeRestriction-r18-trp1 | BIT STRING (SIZE (48)), |
| vectorGroupRestriction-r18-trp2 | BIT STRING (SIZE (11)), |
| amplitudeRestriction-r18-trp2 | BIT STRING (SIZE (48)), |

...

| | |
|---|---|
| vectorGroupRestriction-r18-trpN | BIT STRING (SIZE (11)), |
| amplitudeRestriction-r18-trpN | BIT STRING (SIZE (48)), |

},

| | |
|---|---|
| twelve-one | SEQUENCE { |

| | |
|---|---|
| amplitudeRestriction-r18-trp1 | BIT STRING (SIZE (48)), |
| amplitudeRestriction-r18-trp2 | BIT STRING (SIZE (48)), |

...

| | |
|---|---|
| amplitudeRestriction-r18-trpN | BIT STRING (SIZE (48)), |

},

| | |
|---|---|
| four-four | SEQUENCE { |

| | |
|---|---|
| vectorGroupRestriction-r18-trp1 | BIT STRING (SIZE (11)), |
| amplitudeRestriction-r18-trp1 | BIT STRING (SIZE (64)), |
| vectorGroupRestriction-r18-trp2 | BIT STRING (SIZE (11)), |
| amplitudeRestriction-r18-trp2 | BIT STRING (SIZE (64)), |

...

| | |
|---|---|
| vectorGroupRestriction-r18-trpN | BIT STRING (SIZE (11)), |
| amplitudeRestriction-r18-trpN | BIT STRING (SIZE (64)), |

},

| | |
|---|---|
| eight-two | SEQUENCE { |

| | |
|---|---|
| vectorGroupRestriction-r18-trp1 | BIT STRING (SIZE (11)), |
| amplitudeRestriction-r18-trp1 | BIT STRING (SIZE (64)), |
| vectorGroupRestriction-r18-trp2 | BIT STRING (SIZE (11)), |
| amplitudeRestriction-r18-trp2 | BIT STRING (SIZE (64)), |

...

| | |
|---|---|
| vectorGroupRestriction-r18-trpN | BIT STRING (SIZE (11)), |
| amplitudeRestriction-r18-trpN | BIT STRING (SIZE (64)), |

},

| | |
|---|---|
| sixteen-one | SEQUENCE { |

| | |
|---|---|
| amplitudeRestriction-r18-trp1 | BIT STRING (SIZE (64)), |
| amplitudeRestriction-r18-trp2 | BIT STRING (SIZE (64)), |

...

| | |
|---|---|
| amplitudeRestriction-r18-trpN | BIT STRING (SIZE (64)), |

```
          },
        },
        ...
```

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| amplitudeRestriction-r18-SP1 | BIT STRING (SIZE (8)), |
| amplitudeRestriction-r18-SP2 | BIT STRING (SIZE (8)), |

...

| | |
|---|---|
| amplitudeRestriction-r18-SPN | BIT STRING (SIZE (8)), |

},

| | |
|---|---|
| two-two | SEQUENCE { |

| | |
|---|---|
| vectorGroupRestriction-r18-SP1 | BIT STRING (SIZE (11)), |
| amplitudeRestriction-r18-SP1 | BIT STRING (SIZE (16)), |
| vectorGroupRestriction-r18-SP2 | BIT STRING (SIZE (11)), |
| amplitudeRestriction-r18-SP2 | BIT STRING (SIZE (16)), |

...

| | |
|---|---|
| vectorGroupRestriction-r18-SPN | BIT STRING (SIZE (11)), |
| amplitude Restriction-r18-SPN | BIT STRING (SIZE (16)), |

},

| | |
|---|---|
| four-one | SEQUENCE { |

| | |
|---|---|
| amplitudeRestriction-r18-SP1 | BIT STRING (SIZE (16)), |
| amplitudeRestriction-r18-SP2 | BIT STRING (SIZE (16)), |

...

| | |
|---|---|
| amplitudeRestriction-r18-SPN | BIT STRING (SIZE (16)), |

},

| | |
|---|---|
| three-two | SEQUENCE { |

| | |
|---|---|
| vectorGroupRestriction-r18-SP1 | BIT STRING (SIZE (11)), |
| amplitudeRestriction-r18-SP1 | BIT STRING (SIZE (24)), |
| vectorGroupRestriction-r18-SP2 | BIT STRING (SIZE (11)), |
| amplitudeRestriction-r18-SP2 | BIT STRING (SIZE (24)), |

...

| | |
|---|---|
| vectorGroupRestriction-r18-SPN | BIT STRING (SIZE (11)), |
| amplitude Restriction-r18-SPN | BIT STRING (SIZE (24)), |

},

| | |
|---|---|
| six-one | SEQUENCE { |

| | |
|---|---|
| amplitudeRestriction-r18-SP1 | BIT STRING (SIZE (24)), |
| amplitudeRestriction-r18-SP2 | BIT STRING (SIZE (24)), |

...

| | |
|---|---|
| amplitudeRestriction-r18-SPN | BIT STRING (SIZE (24)), |

},

| | |
|---|---|
| four-two | SEQUENCE { |

| | |
|---|---|
| vectorGroupRestriction-r18-SP1 | BIT STRING (SIZE (11)), |
| amplitudeRestriction-r18-SP1 | BIT STRING (SIZE (32)), |
| vectorGroupRestriction-r18-SP2 | BIT STRING (SIZE (11)), |
| amplitudeRestriction-r18-SP2 | BIT STRING (SIZE (32)), |

...

| | |
|---|---|
| vectorGroupRestriction-r18-SPN | BIT STRING (SIZE (11)), |
| amplitudeRestriction-r18-SPN | BIT STRING (SIZE (32)), |

},

| | |
|---|---|
| eight-one | SEQUENCE { |

| | |
|---|---|
| amplitudeRestriction-r18-SP1 | BIT STRING (SIZE (32)), |
| amplitudeRestriction-r18-SP2 | BIT STRING (SIZE (32)), |

...

| | |
|---|---|
| amplitudeRestriction-r18-SPN | BIT STRING (SIZE (32)), |

},

| | |
|---|---|
| four-three | SEQUENCE { |

| | |
|---|---|
| vectorGroupRestriction-r18-SP1 | BIT STRING (SIZE (11)), |
| amplitudeRestriction-r18-SP1 | BIT STRING (SIZE (48)), |
| vectorGroupRestriction-r18-SP2 | BIT STRING (SIZE (11)), |
| amplitudeRestriction-r18-SP2 | BIT STRING (SIZE (48)), |

...

| | |
|---|---|
| vectorGroupRestriction-r18-SPN | BIT STRING (SIZE (11)), |
| amplitude Restriction-r18-SPN | BIT STRING (SIZE (48)), |

},

| | |
|---|---|
| six-two | SEQUENCE { |

| | |
|---|---|
| vectorGroupRestriction-r18-SP1 | BIT STRING (SIZE (11)), |
| amplitudeRestriction-r18-SP1 | BIT STRING (SIZE (48)), |
| vectorGroupRestriction-r18-SP2 | BIT STRING (SIZE (11)), |
| amplitudeRestriction-r18-SP2 | BIT STRING (SIZE (48)), |

...

| | |
|---|---|
| vectorGroupRestriction-r18-SPN | BIT STRING (SIZE (11)), |
| amplitude Restriction-r18-SPN | BIT STRING (SIZE (48)), |

},

| | |
|---|---|
| twelve-one | SEQUENCE { |

| | |
|---|---|
| amplitudeRestriction-r18-SP1 | BIT STRING (SIZE (48)), |
| amplitudeRestriction-r18-SP2 | BIT STRING (SIZE (48)), |

...

| | |
|---|---|
| amplitudeRestriction-r18-SPN | BIT STRING (SIZE (48)), |

},

| | |
|---|---|
| four-four | SEQUENCE { |

| | |
|---|---|
| vectorGroupRestriction-r18-SP1 | BIT STRING (SIZE (11)), |
| amplitude Restriction-r18-SP1 | BIT STRING (SIZE (64)), |
| vectorGroupRestriction-r18-SP2 | BIT STRING (SIZE (11)), |
| amplitudeRestriction-r18-SP2 | BIT STRING (SIZE (64)), |

...

| | |
|---|---|
| vectorGroupRestriction-r18-SPN | BIT STRING (SIZE (11)), |
| amplitudeRestriction-r18-SPN | BIT STRING (SIZE (64)), |

},

| | |
|---|---|
| eight-two | SEQUENCE { |

| | |
|---|---|
| vectorGroupRestriction-r18-SP1 | BIT STRING (SIZE (11)), |
| amplitudeRestriction-r18-SP1 | BIT STRING (SIZE (64)), |
| vectorGroupRestriction-r18-SP2 | BIT STRING (SIZE (11)), |
| amplitudeRestriction-r18-SP2 | BIT STRING (SIZE (64)), |

...

| | |
|---|---|
| vectorGroupRestriction-r18-SPN | BIT STRING (SIZE (11)), |
| amplitude Restriction-r18-SPN | BIT STRING (SIZE (64)), |

},

| | |
|---|---|
| sixteen-one | SEQUENCE { |

| | |
|---|---|
| amplitudeRestriction-r18-SP1 | BIT STRING (SIZE (64)), |
| amplitudeRestriction-r18-SP2 | BIT STRING (SIZE (64)), |

..

| | |
|---|---|
| amplitudeRestriction-r18-SPN | BIT STRING (SIZE (64)), |

```
          },
        },
...
```

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| amplitudeRestriction-r18 | SEQUENCE (SIZE (1..maxNrofSPs)) OF BIT |

STRING (SIZE (8)),
},

| | |
|---|---|
| two-two | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (16)),
},

| | |
|---|---|
| four-one | SEQUENCE { |

| | |
|---|---|
| amplitudeRestriction-r18 | SEQUENCE (SIZE (1..maxNrofSPs)) OF BIT |

STRING (SIZE (16)),
},

| | |
|---|---|
| three-two | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (24)),
},

| | |
|---|---|
| six-one | SEQUENCE { |

| | |
|---|---|
| amplitude Restriction-r18 | SEQUENCE (SIZE (1..maxNrofSPs)) OF BIT |

STRING (SIZE (24)),
},

| | |
|---|---|
| four-two | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitude Restriction-r18 | SEQUENCE (SIZE (1..maxNrofSPs)) OF BIT |

STRING (SIZE (32)),
},

| | |
|---|---|
| eight-one | SEQUENCE { |

| | |
|---|---|
| amplitude Restriction-r18 | SEQUENCE (SIZE (1..maxNrofSPs)) OF BIT |

STRING (SIZE (32)),
},

| | |
|---|---|
| four-three | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (48)),
},

| | |
|---|---|
| six-two | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitude Restriction-r18 | SEQUENCE (SIZE (1..maxNrofSPs)) OF BIT |

STRING (SIZE (48)),
},

| | |
|---|---|
| twelve-one | SEQUENCE { |

| | |
|---|---|
| amplitudeRestriction -r18 | SEQUENCE (SIZE (1..maxNrofSPs)) OF BIT |

STRING (SIZE (48)),
},

| | |
|---|---|
| four-four | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (64)),
},

| | |
|---|---|
| eight-two | SEQUENCE { |

| | |
|---|---|
| vectorGroupRestriction-r18 | SEQUENCE (SIZE (1..maxNrofSPs)) OF |

BIT STRING (SIZE (11)),

| | |
|---|---|
| amplitudeRestriction-r18 | SEQUENCE (SIZE (1..maxNrofSPs)) OF BIT |

STRING (SIZE (64)),
},

| | |
|---|---|
| sixteen-one | SEQUENCE { |

| | |
|---|---|
| amplitudeRestriction-r18 | SEQUENCE (SIZE (1..maxNrofSPs)) OF BIT |

```
STRING (SIZE (64)),
          },
        },
        ...
```

| | |
|---|---|
| maxNrofSPs | INTEGER ::= 4 |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

| two-one | |
|---|---|
| two-two | |
| four-one | |
| ... | |
| sixteen-one | |
| }, | |
| vectorGroupRestriction-r18 | SEQUENCE (SIZE (1..maxNrofSPs)) OF BIT |

STRING (SIZE (11)),

| | |
|---|---|
| amplitudeRestriction-r18 | SEQUENCE (SIZE (1..maxNrofSPs)) OF BIT |

STRING (SIZE (X)),

...

}

| | |
|---|---|
| maxNrofSPs | INTEGER ::= 4 |

...

| | |
|---|---|
| X :== | INTEGER (8,16,24,32,48,64) |

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |

| two-one | |
|---|---|
| two-two | |
| four-one | |
| ... | |
| sixteen-one | |
| }, | |
| vectorGroupRestriction-r18-SP1 | BIT STRING (SIZE (11)), |
| amplitudeRestriction-r18-SP1 | BIT STRING (SIZE (X)), |
| vectorGroupRestriction-r18-SP2 | BIT STRING (SIZE (11)), |
| amplitudeRestriction-r18-SP2 | BIT STRING (SIZE (X)), |
| ... | |
| vectorGroupRestriction-r18-SPN | BIT STRING (SIZE (11)), |
| amplitudeRestriction-r18-SPN | BIT STRING (SIZE (X)), |

...
}

| | |
|---|---|
| X :== | INTEGER (8,16,24,32,48,64) |

As shown in the example above, the bit width for B_{2,r} is changed from 2N₁N₂×4 to 2N₁N₂×2, and the bit width for B_{1,r} is maintained as 11 bits for N₂>1 or 0 bits for N₂=1.

In one example, the first parameter ‘n1-n2’ is TRP-common (or TRP-group common), i.e., the same value of (N₁, N₂) for all TRPs is configured with the first parameter. The second higher-layer parameter ‘vectorGroupRestriction-r18’ is a bit-map parameter used to indicate restrictions on vector groups, and the third higher-layer parameter ‘amplitudeRestriction-r18’ is a bit-map parameter used to indicate restriction on (average) coefficient amplitudes associated with the vectors in the groups. The bit-map parameter ‘vectorGroupRestriction-r18’ forms the bit sequence B₁ and configures the vector group indices g^{(k)} common for all TRPs, i.e., one value for all TRPs (similar to as in clause 5.2.2.2.3 of TS 38.214 [9]). The bit-map parameter ‘amplitudeRestriction-r18’ forms the bit sequence B_{2,r} for each TRP r=1, . . . , N_{TRP} (or TRP group). Bits b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾ indicate the maximum allowed average amplitude, γ_{i+pL,r} (p=0,1), with i∈{0, 1, . . . , L−1}, of the coefficients associated with the vector in group g^{(k,r)} indexed by x₁, x₂, for example, where the maximum amplitudes are given in Table 5.2.2.2.5-6 of TS 38.214 [9] and the average coefficient amplitude associated with the vector in group g^{(k,r)} is less than or equal to γ_{i+pL,r}. One example is as follows:

$$\sqrt{\frac{1}{{\sum }_{f = 0}^{{M}_{υ} - 1} {k}_{l , i + p L , f , r}^{( 3 )}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + pL , r} .$$

where k_{l,i+pL,f,r}⁽³⁾∈{0,1} is part of the bitmap indicator for TRP r, and indicates whether the corresponding coefficient is zero (when bit value=0) or non-zero (when bit value=1), p_{l,p,r}⁽¹⁾ is a (first) reference amplitude, and p_{l,i+pL,f,r}⁽²⁾ is a (second) differential amplitude coefficient, as described in 5.2.2.2.5 of TS 38.214.

For example, a UE that does not report the parameter ‘softAmpRestriction-r18’=‘supported’ in its capability signaling is not expected to be configured with b_{2,r}^{(k,2(N}^{₁}^{x}^{₂}^{+x}^{₁}⁾⁺¹⁾b_{2,r}^{(k,2(N}^{₁}^{x}^{₂}^{+x}^{₁}⁾⁾=01 or 10.

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| amplitudeRestriction-r18-trp1 | BIT STRING (SIZE (16)), |
| amplitudeRestriction-r18-trp2 | BIT STRING (SIZE (16)), |

...

| | |
|---|---|
| amplitudeRestriction-r18-trpN | BIT STRING (SIZE (16)), |

},

| | |
|---|---|
| two-two | SEQUENCE { |

| | |
|---|---|
| vectorGroupRestriction-r18 | BIT STRING (SIZE (11)), |
| amplitudeRestriction-r18-trp1 | BIT STRING (SIZE (32)), |
| amplitudeRestriction-r18-trp2 | BIT STRING (SIZE (32)), |

...

| | |
|---|---|
| amplitudeRestriction-r18-trpN | BIT STRING (SIZE (32)), |

},

| | |
|---|---|
| four-one | SEQUENCE { |

| | |
|---|---|
| amplitudeRestriction-r18-trp1 | BIT STRING (SIZE (32)), |
| amplitudeRestriction-r18-trp2 | BIT STRING (SIZE (32)), |

...

| | |
|---|---|
| amplitudeRestriction-r18-trpN | BIT STRING (SIZE (32)), |

},

| | |
|---|---|
| three-two | SEQUENCE { |

| | |
|---|---|
| vectorGroupRestriction-r18 | BIT STRING (SIZE (11)), |
| amplitudeRestriction-r18-trp1 | BIT STRING (SIZE (48)), |
| amplitudeRestriction-r18-trp2 | BIT STRING (SIZE (48)), |

...

| | |
|---|---|
| amplitudeRestriction-r18-trpN | BIT STRING (SIZE (48)), |

},

| | |
|---|---|
| six-one | SEQUENCE { |

| | |
|---|---|
| amplitudeRestriction-r18-trp1 | BIT STRING (SIZE (48)), |
| amplitudeRestriction-r18-trp2 | BIT STRING (SIZE (48)), |

...

| | |
|---|---|
| amplitudeRestriction-r18-trpN | BIT STRING (SIZE (48)), |

},

| | |
|---|---|
| four-two | SEQUENCE { |

| | |
|---|---|
| vectorGroupRestriction-r18 | BIT STRING (SIZE (11)), |
| amplitudeRestriction-r18-trp1 | BIT STRING (SIZE (64)), |
| amplitudeRestriction-r18-trp2 | BIT STRING (SIZE (64)), |

...

| | |
|---|---|
| amplitudeRestriction-r18-trpN | BIT STRING (SIZE (64)), |

},

| | |
|---|---|
| eight-one | SEQUENCE { |

| | |
|---|---|
| amplitudeRestriction-r18-trp1 | BIT STRING (SIZE (64)), |
| amplitudeRestriction-r18-trp2 | BIT STRING (SIZE (64)), |

...

| | |
|---|---|
| amplitudeRestriction-r18-trpN | BIT STRING (SIZE (64)), |

},

| | |
|---|---|
| four-three | SEQUENCE { |

| | |
|---|---|
| vectorGroupRestriction-r18 | BIT STRING (SIZE (11)), |
| amplitudeRestriction-r18-trp1 | BIT STRING (SIZE (96)), |
| amplitudeRestriction-r18-trp2 | BIT STRING (SIZE (69)), |

...

| | |
|---|---|
| amplitudeRestriction-r18-trpN | BIT STRING (SIZE (96)), |

},

| | |
|---|---|
| six-two | SEQUENCE { |

| | |
|---|---|
| vectorGroupRestriction-r18 | BIT STRING (SIZE (11)), |
| amplitudeRestriction-r18-trp1 | BIT STRING (SIZE (96)), |
| amplitudeRestriction-r18-trp2 | BIT STRING (SIZE (96)), |

...

| | |
|---|---|
| amplitudeRestriction-r18-trpN | BIT STRING (SIZE (96)), |

},

| | |
|---|---|
| twelve-one | SEQUENCE { |

| | |
|---|---|
| amplitudeRestriction-r18-trp1 | BIT STRING (SIZE (96)), |
| amplitudeRestriction-r18-trp2 | BIT STRING (SIZE (96)), |

...

| | |
|---|---|
| amplitudeRestriction-r18-trpN | BIT STRING (SIZE (96)), |

},

| | |
|---|---|
| four-four | SEQUENCE { |

| | |
|---|---|
| vectorGroupRestriction-r18 | BIT STRING (SIZE (11)), |
| amplitudeRestriction-r18-trp1 | BIT STRING (SIZE (128)), |
| amplitudeRestriction-r18-trp2 | BIT STRING (SIZE (128)), |

...

| | |
|---|---|
| amplitudeRestriction-r18-trpN | BIT STRING (SIZE (128)), |

},

| | |
|---|---|
| eight-two | SEQUENCE { |

| | |
|---|---|
| vectorGroupRestriction-r18 | BIT STRING (SIZE (11)), |
| amplitudeRestriction-r18-trp1 | BIT STRING (SIZE (128)), |
| amplitudeRestriction-r18-trp2 | BIT STRING (SIZE (128)), |

...

| | |
|---|---|
| amplitudeRestriction-r18-trpN | BIT STRING (SIZE (128)), |

},

| | |
|---|---|
| sixteen-one | SEQUENCE { |

| | |
|---|---|
| amplitudeRestriction-r18-trp1 | BIT STRING (SIZE (96)), |
| amplitudeRestriction-r18-trp2 | BIT STRING (SIZE (96)), |

...

| | |
|---|---|
| amplitudeRestriction-r18-trpN | BIT STRING (SIZE (96)), |

```
          },
        },
        ...
```

In one example, the higher-layer parameters ‘n1-n2’, ‘vectorGroupRestriction-r18’, and ‘amplitudeRestriction-r18’ can be as follows.

| | |
|---|---|
| CodebookConfig-r18 ::= | SEQUENCE { |
| codebookType | CHOICE { |
| type2 | SEQUENCE { |

...

| | |
|---|---|
| n1-n2 | CHOICE { |
| two-one | SEQUENCE { |

| | |
|---|---|
| amplitudeRestriction-r18-SP1 | BIT STRING (SIZE (16)), |
| amplitudeRestriction-r18-SP2 | BIT STRING (SIZE (16)), |

...

| | |
|---|---|
| amplitudeRestriction-r18-SPN | BIT STRING (SIZE (16)), |

},

| | |
|---|---|
| two-two | SEQUENCE { |

| | |
|---|---|
| vectorGroupRestriction-r18 | BIT STRING (SIZE (11)), |
| amplitudeRestriction-r18-SP1 | BIT STRING (SIZE (32)), |
| amplitudeRestriction-r18-SP2 | BIT STRING (SIZE (32)), |

...

| | |
|---|---|
| amplitudeRestriction-r18-SPN | BIT STRING (SIZE (32)), |

},

| | |
|---|---|
| four-one | SEQUENCE { |

| | |
|---|---|
| amplitudeRestriction-r18-SP1 | BIT STRING (SIZE (32)), |
| amplitudeRestriction-r18-SP2 | BIT STRING (SIZE (32)), |

...

| | |
|---|---|
| amplitudeRestriction-r18-SPN | BIT STRING (SIZE (32)), |

},

| | |
|---|---|
| three-two | SEQUENCE { |

| | |
|---|---|
| vectorGroupRestriction-r18 | BIT STRING (SIZE (11)), |
| amplitudeRestriction-r18-SP1 | BIT STRING (SIZE (48)), |
| amplitudeRestriction-r18-SP2 | BIT STRING (SIZE (48)), |

...

| | |
|---|---|
| amplitudeRestriction-r18-SPN | BIT STRING (SIZE (48)), |

},

| | |
|---|---|
| six-one | SEQUENCE { |

| | |
|---|---|
| amplitudeRestriction-r18-SP1 | BIT STRING (SIZE (48)), |
| amplitudeRestriction-r18-SP2 | BIT STRING (SIZE (48)), |

...

| | |
|---|---|
| amplitudeRestriction-r18-SPN | BIT STRING (SIZE (48)), |

},

| | |
|---|---|
| four-two | SEQUENCE { |

| | |
|---|---|
| vectorGroupRestriction-r18 | BIT STRING (SIZE (11)), |
| amplitudeRestriction-r18-SP1 | BIT STRING (SIZE (64)), |
| amplitudeRestriction-r18-SP2 | BIT STRING (SIZE (64)), |

...

| | |
|---|---|
| amplitudeRestriction-r18-SPN | BIT STRING (SIZE (64)), |

},

| | |
|---|---|
| eight-one | SEQUENCE { |

| | |
|---|---|
| amplitudeRestriction-r18-SP1 | BIT STRING (SIZE (64)), |
| amplitudeRestriction-r18-SP2 | BIT STRING (SIZE (64)), |

...

| | |
|---|---|
| amplitudeRestriction-r18-SPN | BIT STRING (SIZE (64)), |

},

| | |
|---|---|
| four-three | SEQUENCE { |

| | |
|---|---|
| vectorGroupRestriction-r18 | BIT STRING (SIZE (11)), |
| amplitudeRestriction-r18-SP1 | BIT STRING (SIZE (96)), |
| amplitudeRestriction-r18-SP2 | BIT STRING (SIZE (96)), |

...

| | |
|---|---|
| amplitudeRestriction-r18-SPN | BIT STRING (SIZE (96)), |

},

| | |
|---|---|
| six-two | SEQUENCE { |

| | |
|---|---|
| vectorGroupRestriction-r18 | BIT STRING (SIZE (11)), |
| amplitudeRestriction-r18-SP1 | BIT STRING (SIZE (96)), |
| amplitudeRestriction-r18-SP2 | BIT STRING (SIZE (96)), |

...

| | |
|---|---|
| amplitudeRestriction-r18-SPN | BIT STRING (SIZE (96)), |

},

| | |
|---|---|
| twelve-one | SEQUENCE { |

| | |
|---|---|
| amplitudeRestriction-r18-SP1 | BIT STRING (SIZE (96)), |
| amplitudeRestriction-r18-SP2 | BIT STRING (SIZE (96)), |

...

| | |
|---|---|
| amplitudeRestriction-r18-SPN | BIT STRING (SIZE (96)), |

},

| | |
|---|---|
| four-four | SEQUENCE { |

| | |
|---|---|
| vectorGroupRestriction-r18 | BIT STRING (SIZE (11)), |
| amplitudeRestriction-r18-SP1 | BIT STRING (SIZE (128)), |
| amplitudeRestriction-r18-SP2 | BIT STRING (SIZE (128)), |

...

| | |
|---|---|
| amplitudeRestriction-r18-SPN | BIT STRING (SIZE (128)), |

},

| | |
|---|---|
| eight-two | SEQUENCE { |

| | |
|---|---|
| vectorGroupRestriction-r18 | BIT STRING (SIZE (11)), |
| amplitudeRestriction-r18-SP1 | BIT STRING (SIZE (128)), |
| amplitudeRestriction-r18-SP2 | BIT STRING (SIZE (128)), |

...

| | |
|---|---|
| amplitudeRestriction-r18-SPN | BIT STRING (SIZE (128)), |

},

| | |
|---|---|
| sixteen-one | SEQUENCE { |

| | |
|---|---|
| amplitudeRestriction-r18-SP1 | BIT STRING (SIZE (96)), |
| amplitudeRestriction-r18-SP2 | BIT STRING (SIZE (96)), |

...

| | |
|---|---|
| amplitudeRestriction-r18-SPN | BIT STRING (SIZE (96)), |

```
          },
        },
        ...
```

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one SEQUENCE {
            amplitudeRestriction-r18 SEQUENCE (SIZE
(1..maxNrofSPs)) OF BIT STRING (SIZE (16)),
          },
          two-two SEQUENCE {
              vectorGroupRestriction-r18 BIT STRING (SIZE (11)),
            amplitudeRestriction-r18 SEQUENCE (SIZE
(1..maxNrofSPs)) OF BIT STRING (SIZE (32)),
          },
          four-one SEQUENCE {
            amplitudeRestriction-r18 SEQUENCE (SIZE
(1..maxNrofSPs)) OF BIT STRING (SIZE (32)),
          },
          three-two SEQUENCE {
            vectorGroupRestriction-r18 BIT STRING (SIZE (11)),
            amplitudeRestriction-r18 SEQUENCE (SIZE
(1..maxNrofSPs)) OF BIT STRING (SIZE (48)),
          },
          six-one SEQUENCE {
            amplitudeRestriction-r18 SEQUENCE (SIZE
(1..maxNrofSPs)) OF BIT STRING (SIZE (48)),
          },
          four-two SEQUENCE {
            vectorGroupRestriction-r18 BIT STRING (SIZE (11)),
            amplitudeRestriction-r18 SEQUENCE (SIZE
(1..maxNrofSPs)) OF BIT STRING (SIZE (64)),
          },
          eight-one SEQUENCE {
            amplitudeRestriction-r18 SEQUENCE (SIZE
(1..maxNrofSPs)) OF BIT STRING (SIZE (64)),
          },
          four-three SEQUENCE {
            vectorGroupRestriction-r18 BIT STRING (SIZE (11)),
            amplitudeRestriction-r18 SEQUENCE (SIZE
(1..maxNrofSPs)) OF BIT STRING (SIZE (96)),
          },
          six-two SEQUENCE {
            vectorGroupRestriction-r18 BIT STRING (SIZE (11)),
            amplitudeRestriction-r18 SEQUENCE (SIZE
(1..maxNrofSPs)) OF BIT STRING (SIZE (96)),
          },
          twelve-one SEQUENCE {
            amplitudeRestriction -r18 SEQUENCE (SIZE
(1..maxNrofSPs)) OF BIT STRING (SIZE (96)),
          },
          four-four SEQUENCE {
            vectorGroupRestriction-r18 BIT STRING (SIZE (11)),
            amplitudeRestriction-r18 SEQUENCE (SIZE
(1..maxNrofSPs)) OF BIT STRING (SIZE (128)),
          },
          eight-two SEQUENCE {
            vectorGroupRestriction-r18 BIT STRING (SIZE (11)),
            amplitudeRestriction-r18 SEQUENCE (SIZE
(1..maxNrofSPs)) OF BIT STRING (SIZE (128)),
          },
          sixteen-one SEQUENCE {
            amplitudeRestriction-r18 SEQUENCE (SIZE
(1..maxNrofSPs)) OF BIT STRING (SIZE (128)),
          },
        },
        ...
maxNrofSPs INTEGER ::= 4
```

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one
          two-two
          four-one
          ...
          sixteen-one
          },
        vectorGroupRestriction-r18 BIT STRING (SIZE (11)),
        amplitudeRestriction-r18 SEQUENCE (SIZE
(1..maxNrofSPs)) OF BIT STRING (SIZE (X)),
        ...
}
maxNrofSPs INTEGER ::= 4
...
X :== INTEGER (16,32,48,64,96,128)
```

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one
          two-two
          four-one
          ...
          sixteen-one
          },
        vectorGroupRestriction-r18 BIT STRING (SIZE (11)),
        amplitudeRestriction-r18-SP1 BIT STRING (SIZE (X)),
        amplitudeRestriction-r18-SP2 BIT STRING (SIZE (X)),
        ...
        amplitudeRestriction-r18-SPN BIT STRING (SIZE (X)),
      ...
}
X :== INTEGER (16,32,48,64,96,128)
```

In one example, the first parameter ‘n1-n2’ is TRP-common (or TRP-group common), i.e., the same value of (N₁, N₂) for all TRPs is configured with the first parameter. The second higher-layer parameter ‘vectorGroupRestriction-r18’ is a bit-map parameter used to indicate restrictions on vector groups, and the third higher-layer parameter ‘amplitudeRestriction-r18’ is a bit-map parameter used to indicate restriction on (average) coefficient amplitudes associated with the vectors in the groups. For each TRP r=1, . . . , N_{TRP} (or TRP group), the bit-map parameter ‘vectorGroupRestriction-r18’ forms the bit sequence B_{1,r} and configures the vector group indices g^{(k,r)} (similar to as in clause 5.2.2.2.3 of TS 38.214 [9]). The bit-map parameter ‘amplitudeRestriction-r18’ forms the bit sequence B₂ common for all TRPs, i.e., one value for all TRPs. Bits b₂^{(k,2(N}^{₁}^{x}^{₂}^{+x}^{₁}⁾⁺¹⁾b₂^{(k,2(N}^{₁}^{x}^{₂}^{+x}^{₁}⁾⁾ indicate the maximum allowed average amplitude, γ_{i+pL} (p=0,1), with i∈{0, 1, . . . , L−1}, of the coefficients associated with the vector in group g^{(k)} indexed by x₁, x₂, for example, where the maximum amplitudes are given in Table 5.2.2.2.5-6 of TS 38.214 [9] and the average coefficient amplitude associated with the vector in group g^{(k)} is less than or equal to γ_{i+pL}. One example is as follows:

$$\sqrt{\frac{1}{{\sum }_{f = 0}^{{M}_{υ} - 1} {k}_{l , i + p L , f , r}^{( 3 )}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + pL} .$$

In another example, the average coefficient amplitude associated with the vectors in groups g^{(k,r)} for ∀r over CSI-RS resources (TRPs) is less than or equal to γ_{i+pL}. One example is as follows:

$$\sqrt{\frac{1}{{\sum }_{r = 1}^{{N}_{T R P}} {\sum }_{f = 0}^{{M}_{υ} - 1} {k}_{l , i + p L , f , r}^{( 3 )}} {\sum }_{r = 1}^{{N}_{T R P}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + p L} .$$

For example, a UE that does not report the parameter ‘softAmpRestriction-r18’=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one SEQUENCE {
            amplitudeRestriction-r18 BIT STRING (SIZE (16)),
          },
          two-two SEQUENCE {
            vectorGroupRestriction-r18-trp1 BIT STRING (SIZE
            (11)),
            amplitudeRestriction-r18 BIT STRING (SIZE (32)),
            vectorGroupRestriction-r18-trp2 BIT STRING (SIZE
            (11)),
            ...
            vectorGroupRestriction-r18-trpN BIT STRING (SIZE
            (11)),
          },
          four-one SEQUENCE {
            amplitudeRestriction-r18 BIT STRING (SIZE (32)),
          },
          three-two SEQUENCE {
            vectorGroupRestriction-r18-trp1 BIT STRING (SIZE
            (11)),
            amplitudeRestriction-r18 BIT STRING (SIZE (48)),
            vectorGroupRestriction-r18-trp2 BIT STRING (SIZE
            (11)),
            ...
            vectorGroupRestriction-r18-trpN BIT STRING (SIZE
            (11)),
          },
          six-one SEQUENCE {
            amplitudeRestriction-r18 BIT STRING (SIZE (48)),
          },
          four-two SEQUENCE {
            vectorGroupRestriction-r18-trp1 BIT STRING (SIZE
            (11)),
            amplitudeRestriction-r18 BIT STRING (SIZE (64)),
            vectorGroupRestriction-r18-trp2 BIT STRING (SIZE
            (11)),
            ...
            vectorGroupRestriction-r18-trpN BIT STRING (SIZE
            (11)),
          },
          eight-one SEQUENCE {
            amplitudeRestriction-r18 BIT STRING (SIZE (64)),
          },
          four-three SEQUENCE {
            vectorGroupRestriction-r18-trp1 BIT STRING (SIZE
            (11)),
            amplitudeRestriction-r18 BIT STRING (SIZE (96)),
            vectorGroupRestriction-r18-trp2 BIT STRING (SIZE
            (11)),
            ...
            vectorGroupRestriction-r18-trpN BIT STRING (SIZE
            (11)),
          },
          six-two SEQUENCE {
            vectorGroupRestriction-r18-trp1 BIT STRING (SIZE
            (11)),
            amplitudeRestriction-r18 BIT STRING (SIZE (96)),
            vectorGroupRestriction-r18-trp2 BIT STRING (SIZE
            (11)),
            ...
            vectorGroupRestriction-r18-trpN BIT STRING (SIZE
            (11)),
          },
          twelve-one SEQUENCE {
            amplitudeRestriction-r18 BIT STRING (SIZE (96)),
          },
          four-four SEQUENCE {
            vectorGroupRestriction-r18-trp1 BIT STRING (SIZE
            (11)),
            amplitudeRestriction-r18 BIT STRING (SIZE (128)),
            vectorGroupRestriction-r18-trp2 BIT STRING (SIZE
            (11)),
            ...
            vectorGroupRestriction-r18-trp4 BIT STRING (SIZE
            (11)),
          },
          eight-two SEQUENCE {
            vectorGroupRestriction-r18-trp1 BIT STRING (SIZE
            (11)),
            amplitudeRestriction-r18 BIT STRING (SIZE (128)),
            vectorGroupRestriction-r18-trp2 BIT STRING (SIZE
            (11)),
            ...
            vectorGroupRestriction-r18-trpN BIT STRING (SIZE
            (11)),
          },
          sixteen-one SEQUENCE {
            amplitudeRestriction-r18 BIT STRING (SIZE (128)),
          },
        },
        ...
```

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one SEQUENCE {
            amplitudeRestriction-r18 BIT STRING (SIZE (16)),
          },
          two-two SEQUENCE {
            vectorGroupRestriction-r18-SP1 BIT STRING (SIZE
            (11)),
            amplitudeRestriction-r18 BIT STRING (SIZE (32)),
            vectorGroupRestriction-r18-SP2 BIT STRING (SIZE
            (11)),
            ...
            vectorGroupRestriction-r18-SP4 BIT STRING (SIZE
            (11)),
          },
          four-one SEQUENCE {
            amplitudeRestriction-r18 BIT STRING (SIZE (32)),
          },
          three-two SEQUENCE {
            vectorGroupRestriction-r18-SP1 BIT STRING (SIZE
            (11)),
            amplitudeRestriction-r18 BIT STRING (SIZE (48)),
            vectorGroupRestriction-r18-SP2 BIT STRING (SIZE
            (11)),
            ...
            vectorGroupRestriction-r18-SP4 BIT STRING (SIZE
            (11)),
          },
          six-one SEQUENCE {
            amplitudeRestriction-r18 BIT STRING (SIZE (48)),
          },
          four-two SEQUENCE {
            vectorGroupRestriction-r18-SP1 BIT STRING (SIZE
            (11)),
            amplitudeRestriction-r18 BIT STRING (SIZE (64)),
            vectorGroupRestriction-r18-SP2 BIT STRING (SIZE
            (11)),
            ...
            vectorGroupRestriction-r18-SP4 BIT STRING (SIZE
            (11)),
          },
          eight-one SEQUENCE {
            amplitudeRestriction-r18 BIT STRING (SIZE (64)),
          },
          four-three SEQUENCE {
            vectorGroupRestriction-r18-SP1 BIT STRING (SIZE
            (11)),
            amplitudeRestriction-r18 BIT STRING (SIZE (96)),
            vectorGroupRestriction-r18-SP2 BIT STRING (SIZE
            (11)),
            ...
            vectorGroupRestriction-r18-SP4 BIT STRING (SIZE
            (11)),
          },
          six-two SEQUENCE {
            vectorGroupRestriction-r18-SP1 BIT STRING (SIZE
            (11)),
            amplitudeRestriction-r18 BIT STRING (SIZE (96)),
            vectorGroupRestriction-r18-SP2 BIT STRING (SIZE
            (11)),
            ...
            vectorGroupRestriction-r18-SP4 BIT STRING (SIZE
            (11)),
          },
          twelve-one SEQUENCE {
            amplitudeRestriction-r18 BIT STRING (SIZE (96)),
          },
          four-four SEQUENCE {
            vectorGroupRestriction-r18-SP1 BIT STRING (SIZE
            (11)),
            amplitudeRestriction-r18 BIT STRING (SIZE (128)),
            vectorGroupRestriction-r18-SP2 BIT STRING (SIZE
            (11)),
            ...
            vectorGroupRestriction-r18-SP4 BIT STRING (SIZE
            (11)),
          },
          eight-two SEQUENCE {
            vectorGroupRestriction-r18-SP1 BIT STRING (SIZE
            (11)),
            amplitudeRestriction-r18 BIT STRING (SIZE (128)),
            vectorGroupRestriction-r18-SP2 BIT STRING (SIZE
            (11)),
            ...
            vectorGroupRestriction-r18-SP4 BIT STRING (SIZE
            (11)),
          },
          sixteen-one SEQUENCE {
            amplitudeRestriction-r18 BIT STRING (SIZE (128)),
          },
        },
...
```

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one SEQUENCE {
            amplitudeRestriction-r18 BIT STRING (SIZE (16)),
          },
          two-two SEQUENCE {
            vectorGroupRestriction-r18 SEQUENCE (SIZE
(1..maxNrofSPs)) OF BIT STRING (SIZE (11))
            amplitudeRestriction-r18 BIT STRING (SIZE (32)),
          },
          four-one SEQUENCE {
            amplitudeRestriction-r18 BIT STRING (SIZE (32)),
          },
          three-two SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (48)),
          },
          six-one SEQUENCE {
            amplitudeRestriction-r18 BIT STRING (SIZE (48)),
          },
          four-two SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (64)),
          },
          eight-one SEQUENCE {
            amplitudeRestriction-r18 BIT STRING (SIZE (64)),
          },
          four-three SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (96)),
          },
          six-two SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (96)),
          },
          twelve-one SEQUENCE {
            amplitudeRestriction-r18 BIT STRING (SIZE (96)),
          },
          four-four SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (128)),
          },
          eight-two SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (128)),
          },
          sixteen-one SEQUENCE {
            amplitudeRestriction-r18 BIT STRING (SIZE (128)),
          },
        },
        ...
maxNrofSPs INTEGER ::= 4
```

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one
          two-two
          four-one
          ...
          sixteen-one
          },
        vectorGroupRestriction-r18 SEQUENCE (SIZE
(1..maxNrofSPs)) OF BIT STRING (SIZE (11)),
        amplitudeRestriction-r18 BIT STRING (SIZE (X)),
        ...
}
maxNrofSPs INTEGER ::= 4
...
X :== INTEGER (16,32,48,64,96,128)
```

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one
          two-two
          four-one
          ...
          sixteen-one
          },
        vectorGroupRestriction-r18-SP1 BIT STRING (SIZE (11)),
            vectorGroupRestriction-r18-SP2 BIT STRING (SIZE
            (11)),
            ...
            vectorGroupRestriction-r18-SPN BIT STRING (SIZE
            (11)),
        amplitudeRestriction-r18 BIT STRING (SIZE (X)),
      ...
}
X :== INTEGER (16,32,48,64,96,128)
```

In one example, it is the same example as herein except that only hard amplitude restriction is allowed to configure (not allowing to configure soft amplitude restriction), where the hard amplitude restriction refers that its associated amplitudes can be either restricted to all 0 or no restricted, (hence freely selected using the configured codebook).

For example, it is not allowed to configure b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10 with a table such as the following table.

| | Maximum |
|---|---|
| | Average |
| | Coefficient |
| Bit | Amplitude |
| b₂^{(k, 2(N}^{₁}^{x}^{₂}^{+x}^{₁}⁾⁺¹⁾b₂^{(k, 2(N}^{₁}^{x}^{₂}^{+x}^{₁}⁾⁾ | γ_{i+pL} |
| 00 | 0 |
| 01 | \sqrt{¼} |
| 10 | \sqrt{½} |
| 11 | 1 |

In another example, there is no such a table since the hard restriction allows to configure either its associated amplitudes to be 0 or under no restriction. For example, a higher-layer parameter to indicate the hard restriction can be according to the following: bit ‘0’ corresponds to its associated amplitudes to be 0, and bit ‘1’ corresponds to it associated amplitudes having no restriction.

In another example, it is allowed to configure b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=0 or 1 with a table such as the following table.

| | Maximum |
|---|---|
| | Average |
| | Coefficient |
| Bit | Amplitude |
| b₂^{(k, 2(N}^{₁}^{x}^{₂}^{+x}^{₁}⁾⁺¹⁾b₂^{(k, 2(N}^{₁}^{x}^{₂}^{+x}^{₁}⁾⁾ | γ_{i+pL} |
| 0 | 0 |
| 1 | 1 |

In one example, for each example of higher-layer parameters (RRC signaling, or information elements) shown herein, the size of bit string can be computed based on 2-bits for B₂ (instead of 4-bits for B₂).

In one example, the higher-layer parameters ‘n1-n2’, ‘vectorGroupRestriction-r18’ and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one SEQUENCE {
            amplitudeRestriction-r18 BIT STRING (SIZE (8)),
          },
          two-two SEQUENCE {
            vectorGroupRestriction-r18-trp1 BIT STRING (SIZE
            (11)),
            amplitudeRestriction-r18 BIT STRING (SIZE (16)),
            vectorGroupRestriction-r18-trp2 BIT STRING (SIZE
            (11)),
            ...
            vectorGroupRestriction-r18-trpN BIT STRING (SIZE
            (11)),
          },
          four-one SEQUENCE {
            amplitudeRestriction-r18 BIT STRING (SIZE (16)),
          },
          three-two SEQUENCE {
            vectorGroupRestriction-r18-trp1 BIT STRING (SIZE
            (11)),
            amplitudeRestriction-r18 BIT STRING (SIZE (24)),
            vectorGroupRestriction-r18-trp2 BIT STRING (SIZE
            (11)),
            ...
            vectorGroupRestriction-r18-trpN BIT STRING (SIZE
            (11)),
          },
          six-one SEQUENCE {
            amplitudeRestriction-r18 BIT STRING (SIZE (24)),
          },
          four-two SEQUENCE {
            vectorGroupRestriction-r18-trp1 BIT STRING (SIZE
            (11)),
            amplitudeRestriction-r18 BIT STRING (SIZE (32)),
            vectorGroupRestriction-r18-trp2 BIT STRING (SIZE
            (11)),
            ...
            vectorGroupRestriction-r18-trpN BIT STRING (SIZE
            (11)),
          },
          eight-one SEQUENCE {
            amplitudeRestriction-r18 BIT STRING (SIZE (32)),
          },
          four-three SEQUENCE {
            vectorGroupRestriction-r18-trp1 BIT STRING (SIZE
            (11)),
            amplitudeRestriction-r18 BIT STRING (SIZE (48)),
            vectorGroupRestriction-r18-trp2 BIT STRING (SIZE
            (11)),
            ...
            vectorGroupRestriction-r18-trpN BIT STRING (SIZE
            (11)),
          },
          six-two SEQUENCE {
            vectorGroupRestriction-r18-trp1 BIT STRING (SIZE
            (11)),
            amplitudeRestriction-r18 BIT STRING (SIZE (48)),
            vectorGroupRestriction-r18-trp2 BIT STRING (SIZE
            (11)),
            ...
            vectorGroupRestriction-r18-trpN BIT STRING (SIZE
            (11)),
          },
          twelve-one SEQUENCE {
            amplitudeRestriction-r18 BIT STRING (SIZE (48)),
          },
          four-four SEQUENCE {
            vectorGroupRestriction-r18-trp1 BIT STRING (SIZE
            (11)),
            amplitudeRestriction-r18 BIT STRING (SIZE (64)),
            vectorGroupRestriction-r18-trp2 BIT STRING (SIZE
            (11)),
            ...
            vectorGroupRestriction-r18-trp4 BIT STRING (SIZE
            (11)),
          },
          eight-two SEQUENCE {
            vectorGroupRestriction-r18-trp1 BIT STRING (SIZE
            (11)),
            amplitudeRestriction-r18 BIT STRING (SIZE (64)),
            vectorGroupRestriction-r18-trp2 BIT STRING (SIZE
            (11)),
            ...
            vectorGroupRestriction-r18-trpN BIT STRING (SIZE
            (11)),
          },
          sixteen-one SEQUENCE {
            amplitudeRestriction-r18 BIT STRING (SIZE (64)),
          },
        },
        ...
```

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one SEQUENCE {
            amplitudeRestriction-r18 BIT STRING (SIZE (8)),
          },
          two-two SEQUENCE {
            vectorGroupRestriction-r18-SP1 BIT STRING (SIZE
            (11)),
            amplitudeRestriction-r18 BIT STRING (SIZE (16)),
            vectorGroupRestriction-r18-SP2 BIT STRING (SIZE
            (11)),
            ...
            vectorGroupRestriction-r18-SP4 BIT STRING (SIZE
            (11)),
          },
          four-one SEQUENCE {
            amplitudeRestriction-r18 BIT STRING (SIZE (16)),
          },
          three-two SEQUENCE {
            vectorGroupRestriction-r18-SP1 BIT STRING (SIZE
            (11)),
            amplitudeRestriction-r18 BIT STRING (SIZE (24)),
            vectorGroupRestriction-r18-SP2 BIT STRING (SIZE
            (11)),
            ...
            vectorGroupRestriction-r18-SP4 BIT STRING (SIZE
            (11)),
          },
          six-one SEQUENCE {
            amplitudeRestriction-r18 BIT STRING (SIZE (24)),
          },
          four-two SEQUENCE {
            vectorGroupRestriction-r18-SP1 BIT STRING (SIZE
            (11)),
            amplitudeRestriction-r18 BIT STRING (SIZE (32)),
            vectorGroupRestriction-r18-SP2 BIT STRING (SIZE
            (11)),
            ...
            vectorGroupRestriction-r18-SP4 BIT STRING (SIZE
            (11)),
          },
          eight-one SEQUENCE {
            amplitudeRestriction-r18 BIT STRING (SIZE (32)),
          },
          four-three SEQUENCE {
            vectorGroupRestriction-r18-SP1 BIT STRING (SIZE
            (11)),
            amplitudeRestriction-r18 BIT STRING (SIZE (48)),
            vectorGroupRestriction-r18-SP2 BIT STRING (SIZE
            (11)),
            ...
            vectorGroupRestriction-r18-SP4 BIT STRING (SIZE
            (11)),
          },
          six-two SEQUENCE {
            vectorGroupRestriction-r18-SP1 BIT STRING (SIZE
            (11)),
            amplitudeRestriction-r18 BIT STRING (SIZE (48)),
            vectorGroupRestriction-r18-SP2 BIT STRING (SIZE
            (11)),
            ...
            vectorGroupRestriction-r18-SP4 BIT STRING (SIZE
            (11)),
          },
          twelve-one SEQUENCE {
            amplitudeRestriction-r18 BIT STRING (SIZE (48)),
          },
          four-four SEQUENCE {
            vectorGroupRestriction-r18-SP1 BIT STRING (SIZE
            (11)),
            amplitudeRestriction-r18 BIT STRING (SIZE (64)),
            vectorGroupRestriction-r18-SP2 BIT STRING (SIZE
            (11)),
            ...
            vectorGroupRestriction-r18-SP4 BIT STRING (SIZE
            (11)),
          },
          eight-two SEQUENCE {
            vectorGroupRestriction-r18-SP1 BIT STRING (SIZE
            (11)),
            amplitudeRestriction-r18 BIT STRING (SIZE (64)),
            vectorGroupRestriction-r18-SP2 BIT STRING (SIZE
            (11)),
            ...
            vectorGroupRestriction-r18-SP4 BIT STRING (SIZE
            (11)),
          },
          sixteen-one SEQUENCE {
            amplitudeRestriction-r18 BIT STRING (SIZE (64)),
          },
        },
...
```

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one SEQUENCE {
            amplitudeRestriction-r18 BIT STRING (SIZE (8)),
          },
          two-two SEQUENCE {
            vectorGroupRestriction-r18 SEQUENCE (SIZE
(1..maxNrofSPs)) OF BIT STRING (SIZE (11))
            amplitudeRestriction-r18 BIT STRING (SIZE (16)),
          },
          four-one SEQUENCE {
            amplitudeRestriction-r18 BIT STRING (SIZE (16)),
          },
          three-two SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (24)),
          },
          six-one SEQUENCE {
            amplitudeRestriction-r18 BIT STRING (SIZE (24)),
          },
          four-two SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (32)),
          },
          eight-one SEQUENCE {
            amplitudeRestriction-r18 BIT STRING (SIZE (32)),
          },
          four-three SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (48)),
          },
          six-two SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (48)),
          },
          twelve-one SEQUENCE {
            amplitudeRestriction-r18 BIT STRING (SIZE (48)),
          },
          four-four SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (64)),
          },
          eight-two SEQUENCE {
            vectorGroupRestriction-r18 SEQUENCE (SIZE
(1..maxNrofSPs)) OF BIT STRING (SIZE (11)),
            amplitudeRestriction-r18 BIT STRING (SIZE (64)),
          },
          sixteen-one SEQUENCE {
            amplitudeRestriction-r18 BIT STRING (SIZE (64)),
          },
        },
        ...
maxNrofSPs INTEGER ::= 4
```

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

```
CodebookConfig-r18 ::=  SEQUENCE {
  codebookType  CHOICE {
    type2  SEQUENCE {
      ...
        n1-n2  CHOICE {
          two-one
          two-two
          four-one
          ...
          sixteen-one
          },
        vectorGroupRestriction-r18  SEQUENCE (SIZE
(1..maxNrofSPs)) OF BIT STRING (SIZE (11)),
        amplitudeRestriction-r18  BIT STRING (SIZE (X)),
        ...
}
maxNrofSPs  INTEGER ::= 4
...
X :==  INTEGER (8,16,24,32,48,64)
```

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one
          two-two
          four-one
          ...
          sixteen-one
          },
        vectorGroupRestriction-r18-SP1 BIT STRING (SIZE
        (11)),
            vectorGroupRestriction-r18-SP2 BIT STRING
            (SIZE (11)),
            ...
            vectorGroupRestriction-r18-SPN BIT STRING
            (SIZE (11)),
        amplitudeRestriction-r18 BIT STRING (SIZE (X)),
      ...
}
X :== INTEGER (8,16,24,32,48,64)
```

As shown in the example above, the bit width for B₂ is changed from 2N₁N₂×4 to 2N₁N₂×2, and the bit width for B_{1,r} is maintained as 11 bits for N₂>1 or 0 bits for N₂=1.

In one example, the first parameter ‘n1-n2’ is TRP-common (or TRP-group common), i.e., the same value of (N₁, N₂) for all TRPs is configured with the first parameter. The second higher-layer parameter ‘vectorGroupRestriction-r18’ is a bit-map parameter used to indicate restrictions on vector groups, and the third higher-layer parameter ‘amplitudeRestriction-r18’ is a bit-map parameter used to indicate restriction on (average) coefficient amplitudes associated with the vectors in the groups. The bit-map parameter ‘vectorGroupRestriction-r18’ forms the bit sequence B₁ and configures the vector group indices g^{(k)} common for all TRPs, i.e., one value for all TRPs (similar to as in clause 5.2.2.2.3 of TS 38.214 [9]). The bit-map parameter ‘amplitudeRestriction-r18’ forms the bit sequence B₂ common for all TRPs, i.e., one value for all TRPs. Bits b₂^{(k,2(N}^{₁}^{x}^{₂}^{+x}^{₁}⁾⁺¹⁾b₂^{(k,2(N}^{₁}^{x}^{₂}^{+x}^{₁}⁾⁾ indicate the maximum allowed average amplitude, γ_{i+pL} (p=0,1), with i∈{0, 1, . . . , L−1}, of the coefficients associated with the vector in group g^{(k)} indexed by x₁, x₂, for example, where the maximum amplitudes are given in Table 5.2.2.2.5-6 of TS 38.214 [9] and the average coefficient amplitude associated with the vector in group g^{(k)} is less than or equal to γ_{i+pL}. One example is as follows:

$$\sqrt{\frac{1}{{\sum }_{f = 0}^{{M}_{υ} - 1} {k}_{l , i + p L , f , r}^{( 3 )}} {\sum }_{f = 0}^{{M}_{υ} - 1} {{k}_{l , i + p L , f , r}^{( 3 )} ( {p}_{l , p , r}^{( 1 )} {p}_{l , i + p L , f , r}^{( 2 )} )}^{2}} \leq {γ}_{i + pL} .$$

For example, a UE that does not report the parameter ‘softAmpRestriction-r18’=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one SEQUENCE {
            amplitudeRestriction-r18 BIT STRING (SIZE (16)),
          },
          two-two SEQUENCE {
            vectorGroupRestriction-r18 BIT STRING (SIZE (11)),
            amplitudeRestriction-r18 BIT STRING (SIZE (32)),
          },
          four-one SEQUENCE {
            amplitudeRestriction-r18 BIT STRING (SIZE (32)),
          },
          three-two SEQUENCE {
            vectorGroupRestriction-r18 BIT STRING (SIZE (11)),
            amplitudeRestriction-r18 BIT STRING (SIZE (48)),
          },
          six-one SEQUENCE {
            amplitudeRestriction-r18 BIT STRING (SIZE (48)),
          },
          four-two SEQUENCE {
            vectorGroupRestriction-r18 BIT STRING (SIZE (11)),
            amplitudeRestriction-r18 BIT STRING (SIZE (64)),
          },
          eight-one SEQUENCE {
            amplitude Restriction-r18 BIT STRING (SIZE (64)),
          },
          four-three SEQUENCE {
            vectorGroupRestriction-r18 BIT STRING (SIZE (11)),
            amplitude Restriction-r18 BIT STRING (SIZE (96)),
          },
          six-two SEQUENCE {
            vectorGroupRestriction-r18 BIT STRING (SIZE (11)),
            amplitudeRestriction-r18 BIT STRING (SIZE (96)),
          },
          twelve-one SEQUENCE {
            amplitudeRestriction-r18 BIT STRING (SIZE (96)),
          },
          four-four SEQUENCE {
            vectorGroupRestriction-r18 BIT STRING (SIZE (11)),
            amplitudeRestriction-r18 BIT STRING (SIZE (128)),
          },
          eight-two SEQUENCE {
            vectorGroupRestriction-r18 BIT STRING (SIZE (11)),
            amplitudeRestriction-r18 BIT STRING (SIZE (128)),
          },
          sixteen-one SEQUENCE {
            amplitudeRestriction-r18 BIT STRING (SIZE (96)),
          },
        },
        ...
```

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one
          two-two
          four-one
          ...
          sixteen-one
          },
        vectorGroupRestriction-r18 BIT STRING (SIZE (11)),
        amplitudeRestriction-r18 BIT STRING (SIZE (X)),
        ...
}
...
X :== INTEGER (16,32,48,64,96,128)
```

In one example, the first parameter ‘n1-n2’ is TRP-common (or TRP-group common), i.e., the same value of (N₁, N₂) for all TRPs is configured with the first parameter. The second higher-layer parameter ‘vectorGroupRestriction-r18’ is a bit-map parameter used to indicate restrictions on vector groups. For each TRP r=1, . . . , N_{TRP} (or TRP group), the bit-map parameter ‘vectorGroupRestriction-r18’ forms the bit sequence B_{1,r} and configures the vector group indices g^{(k,r)} (similar to as in clause 5.2.2.2.3 of TS 38.214 [9]).

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one,
          two-two SEQUENCE {
            vectorGroupRestriction-r18-trp1 BIT STRING
            (SIZE (11)),
            vectorGroupRestriction-r18-trp2 BIT STRING
            (SIZE (11)),
            ...
            vectorGroupRestriction-r18-trpN BIT STRING
            (SIZE (11)),
          },
          four-one,
          three-two SEQUENCE {
            vectorGroupRestriction-r18-trp1 BIT STRING
            (SIZE (11)),
            vectorGroupRestriction-r18-trp2 BIT STRING
            (SIZE (11)),
            ...
            vectorGroupRestriction-r18-trpN BIT STRING
            (SIZE (11)),
          },
          six-one,
          four-two SEQUENCE {
            vectorGroupRestriction-r18-trp1 BIT STRING
            (SIZE (11)),
            vectorGroupRestriction-r18-trp2 BIT STRING
            (SIZE (11)),
            ...
            vectorGroupRestriction-r18-trpN BIT STRING
            (SIZE (11)),
          },
          eight-one,
          four-three SEQUENCE {
            vectorGroupRestriction-r18-trp1 BIT STRING
            (SIZE (11)),
            vectorGroupRestriction-r18-trp2 BIT STRING
            (SIZE (11)),
            ...
            vectorGroupRestriction-r18-trpN BIT STRING
            (SIZE (11)),
          },
          six-two SEQUENCE {
            vectorGroupRestriction-r18-trp1 BIT STRING
            (SIZE (11)),
            vectorGroupRestriction-r18-trp2 BIT STRING
            (SIZE (11)),
            ...
            vectorGroupRestriction-r18-trpN BIT STRING
            (SIZE (11)),
          },
          twelve-one,
          four-four SEQUENCE {
            vectorGroupRestriction-r18-trp1 BIT STRING
            (SIZE (11)),
            vectorGroupRestriction-r18-trp2 BIT STRING
            (SIZE (11)),
            ...
            vectorGroupRestriction-r18-trp4 BIT STRING
            (SIZE (11)),
          },
          eight-two SEQUENCE {
            vectorGroupRestriction-r18-trp1 BIT STRING
            (SIZE (11)),
            vectorGroupRestriction-r18-trp2 BIT STRING
            (SIZE (11)),
            ...
            vectorGroupRestriction-r18-trpN BIT STRING
            (SIZE (11)),
          },
          sixteen-one,
        },
        ...
```

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one,
          two-two SEQUENCE {
            vectorGroupRestriction-r18-SP1 BIT STRING
            (SIZE (11)),
            vectorGroupRestriction-r18-SP2 BIT STRING
            (SIZE (11)),
            ...
            vectorGroupRestriction-r18-SP4 BIT STRING
            (SIZE (11)),
          },
          four-one,
          three-two SEQUENCE {
            vectorGroupRestriction-r18-SP1 BIT STRING
            (SIZE (11)),
            vectorGroupRestriction-r18-SP2 BIT STRING
            (SIZE (11)),
            ...
            vectorGroupRestriction-r18-SP4 BIT STRING
            (SIZE (11)),
          },
          six-one,
          four-two SEQUENCE {
            vectorGroupRestriction-r18-SP1 BIT STRING
            (SIZE (11)),
            vectorGroupRestriction-r18-SP2 BIT STRING
            (SIZE (11)),
            ...
            vectorGroupRestriction-r18-SP4 BIT STRING
            (SIZE (11)),
          },
          eight-one,
          four-three SEQUENCE {
            vectorGroupRestriction-r18-SP1 BIT STRING
            (SIZE (11)),
            vectorGroupRestriction-r18-SP2 BIT STRING
            (SIZE (11)),
            ...
            vectorGroupRestriction-r18-SP4 BIT STRING
            (SIZE (11)),
          },
          six-two SEQUENCE {
            vectorGroupRestriction-r18-SP1 BIT STRING
            (SIZE (11)),
            vectorGroupRestriction-r18-SP2 BIT STRING
            (SIZE (11)),
            ...
            vectorGroupRestriction-r18-SP4 BIT STRING
            (SIZE (11)),
          },
          twelve-one,
          four-four SEQUENCE {
            vectorGroupRestriction-r18-SP1 BIT STRING
            (SIZE (11)),
            vectorGroupRestriction-r18-SP2 BIT STRING
            (SIZE (11)),
            ...
            vectorGroupRestriction-r18-SP4 BIT STRING
            (SIZE (11)),
          },
          eight-two SEQUENCE {
            vectorGroupRestriction-r18-SP1 BIT STRING
            (SIZE (11)),
            vectorGroupRestriction-r18-SP2 BIT STRING
            (SIZE (11)),
            ...
            vectorGroupRestriction-r18-SP4 BIT STRING
            (SIZE (11)),
          },
          sixteen-one,
        },
...
```

In one example, the higher-layer parameters ‘n1-n2’, ‘vectorGroupRestriction-r18’, and ‘amplitudeRestriction-r18’ can be as follows.

```
CodebookConfig-r18 ::=  SEQUENCE {
  codebookType  CHOICE {
    type2  SEQUENCE {
      ...
        n1-n2  CHOICE {
          two-one,
          two-two  SEQUENCE {
            vectorGroupRestriction-r18  SEQUENCE (SIZE
(1..maxNrofSPs)) OF BIT STRING (SIZE (11))
          },
          four-one,
          three-two  SEQUENCE {
            vectorGroupRestriction-r18  SEQUENCE (SIZE
(1..maxNrofSPs)) OF BIT STRING (SIZE (11)),
          ...
          six-one,
          four-two  SEQUENCE {
            vectorGroupRestriction-r18  SEQUENCE (SIZE
(1..maxNrofSPs)) OF BIT STRING (SIZE (11)),
          },
          eight-one,
          four-three  SEQUENCE {
            vectorGroupRestriction-r18  SEQUENCE (SIZE
(1..maxNrofSPs)) OF BIT STRING (SIZE (11)),
          },
          six-two  SEQUENCE {
            vectorGroupRestriction-r18  SEQUENCE (SIZE
(1..maxNrofSPs)) OF BIT STRING (SIZE (11)),
          },
          twelve-one,
          four-four  SEQUENCE {
            vectorGroupRestriction-r18  SEQUENCE (SIZE
(1..maxNrofSPs)) OF BIT STRING (SIZE (11)),
          },
          eight-two  SEQUENCE {
            vectorGroupRestriction-r18  SEQUENCE (SIZE
(1..maxNrofSPs)) OF BIT STRING (SIZE (11)),
          },
          sixteen-one,
        },
        ...
maxNrofSPs  INTEGER ::= 4
```

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one
          two-two
          four-one
          ...
          sixteen-one
          },
        vectorGroupRestriction-r18 SEQUENCE (SIZE
(1..maxNrofSPs)) OF BIT STRING (SIZE (11)),
        ...
}
maxNrofSPs INTEGER ::= 4
...
```

Other terminology can be used for ‘maxNrofSPs’ in the example. For example, maxNrofPortGroups can be used.

In one example, ‘maxNrofSPs’ can be defined as ‘INTEGER:=x’, where x=2, 3, or 4.

In one example, the higher-layer parameters ‘n1-n2’, ‘vectorGroupRestriction-r18’, and ‘amplitudeRestriction-r18’ can be as follows.

```
CodebookConfig-r18 ::= SEQUENCE {
  codebookType CHOICE {
    type2 SEQUENCE {
      ...
        n1-n2 CHOICE {
          two-one
          two-two
          four-one
          ...
          sixteen-one
          },
        vectorGroupRestriction-r18-SP1 BIT STRING (SIZE
        (11)),
            vectorGroupRestriction-r18-SP2 BIT STRING
            (SIZE (11)),
            ...
            vectorGroupRestriction-r18-SPN BIT STRING
            (SIZE (11)),
      ...
}
```

In one embodiment, a UE is configured with higher layer parameter codebookType set to, e.g., ‘typeII-r18-cjt’. Three high-layer parameters are used to configure (N₁, N₂), vector group restriction, and coefficient amplitude restriction, respectively. For example, a first higher-layer parameter can be denoted as ‘n1-n2’, a second higher-layer parameter can be denoted as ‘vectorGroupRestriction-r18’, and a third higher-layer parameter can be denoted as ‘amplitudeRestriction-r18’, respectively. Here, ‘n1-n2’ is TRP-specific, i.e., the value of (N₁, N₂) is configured for each TRP.

In one example, the higher-layer parameter ‘n1-n2’ can be as follows. The other higher-layer parameters ‘vectorGroupRestriction-r18’ and ‘amplitudeRestriction-r18’ can be according to one of the examples shown herein.

```
CodebookConfig-r18 ::= SEQUENCE {
  codebookType CHOICE {
    type2 SEQUENCE {
      ...
        n1-n2-SP#1 CHOICE {
          two-one
          two-two
          four-one
          ...
          sixteen-one
          },
        n1-n2-SP#2 CHOICE {
          two-one
          two-two
          four-one
          ...
          sixteen-one
          },
        ...
        n1-n2-SP#N CHOICE {
          two-one
          two-two
          four-one
          ...
          sixteen-one
          },
            }
```

In one example, the higher-layer parameter ‘n1-n2’ can be as follows. The other higher-layer parameters ‘vectorGroupRestriction-r18’ and ‘amplitudeRestriction-r18’ can be according to one of the examples shown herein.

```
CodebookConfig-r18 ::= SEQUENCE {
  codebookType CHOICE {
    type2 SEQUENCE {
      ...
      n1-n2-r18 SEQUENCE (SIZE (1..maxNrofSPs)) OF n1-n2,
        ...
}
n1-n2 CHOICE {
          two-one
          two-two
          four-one
          ...
          sixteen-one
          },
...
maxNrofSPs INTEGER ::= 4
```

In one example, the first parameter ‘n1-n2’ is TRP-specific, i.e., the value of (N₁, N₂) is configured for each TRP, details as above. The second higher-layer parameter ‘vectorGroupRestriction-r18’ is a bit-map parameter used to indicate restrictions on vector groups, and the third higher-layer parameter ‘amplitudeRestriction-r18’ is a bit-map parameter used to indicate restriction on (average) coefficient amplitudes associated with the vectors in the groups, the details as described herein.

In one example, the first parameter ‘n1-n2’ is TRP-specific, i.e., the value of (N₁, N₂) is configured for each TRP, details as above. The second higher-layer parameter ‘vectorGroupRestriction-r18’ is a bit-map parameter used to indicate restrictions on vector groups, and the third higher-layer parameter ‘amplitudeRestriction-r18’ is a bit-map parameter used to indicate restriction on (average) coefficient amplitudes associated with the vectors in the groups, the details as described herein.

In one example, the first parameter ‘n1-n2’ is TRP-specific, i.e., the value of (N₁, N₂) is configured for each TRP, details as above. The second higher-layer parameter ‘vectorGroupRestriction-r18’ is a bit-map parameter used to indicate restrictions on vector groups, and the third higher-layer parameter ‘amplitudeRestriction-r18’ is a bit-map parameter used to indicate restriction on (average) coefficient amplitudes associated with the vectors in the groups, the details as described herein.

In one example, the first parameter ‘n1-n2’ is TRP-specific, i.e., the value of (N₁, N₂) is configured for each TRP, details as above. The second higher-layer parameter ‘vectorGroupRestriction-r18’ is a bit-map parameter used to indicate restrictions on vector groups, and the third higher-layer parameter ‘amplitudeRestriction-r18’ is a bit-map parameter used to indicate restriction on (average) coefficient amplitudes associated with the vectors in the groups, the details as described herein.

In one example, the first parameter ‘n1-n2’ is TRP-specific, i.e., the value of (N₁, N₂) is configured for each TRP, details as above. The second higher-layer parameter ‘vectorGroupRestriction-r18’ is a bit-map parameter used to indicate restrictions on vector groups, and the details as described herein.

In one embodiment, or N_{TRP}=1, a UE can be configured with a first scheme among the schemes described in embodiments described herein, and, for N_{TRP}>1, the UE can be configured with a second scheme among the schemes described herein. In addition, the same rank restriction is applied across N_{TRP} CSI-RS resources.

In one example, the first scheme is a scheme for (CSI-RS-resource-specific) vector group restriction and (CSI-RS-resource-specific) soft amplitude restriction such as one of the examples described herein.

In one example, the second scheme is a scheme for CSI-RS-resource-specific vector group restriction and CSI-RS-resource-specific) hard amplitude restriction such as one of the examples described herein.

In one example, (the first scheme, the second scheme) can be according to at least one of the following examples.
(soft amplitude restriction, hard amplitude restriction)
(the first scheme, the second scheme) is designed based on the schemes described in one or more combinations of examples described herein.
(soft amplitude restriction, no amplitude restriction)
(the first scheme, the second scheme) is designed based on the schemes described in one or more combinations of examples described herein.
(no amplitude restriction, soft amplitude restriction)
(the first scheme, the second scheme) is designed based on the schemes described in one or more combinations of examples described herein.
(hard amplitude restriction, no amplitude restriction)
(the first scheme, the second scheme) is designed based on the schemes described in one or more combinations of examples described herein.
(hard amplitude restriction, soft amplitude restriction)
(the first scheme, the second scheme) is designed based on the schemes described in one or more combinations of examples described herein.

In one embodiment, a UE can be configured with codebook subset restriction according to at least one of the examples described in embodiments described herein. In addition, a UE is further configured with a higher-layer parameter for CSI-RS-resource-specific CBSR turning-off operation, where the CSI-RS-resource-specific CBSR turning-off operation refers to an operation that can be configured for turning off/on the CBSR per CSI-RS resource. In addition, the same rank restriction is applied across N_{TRP} CSI-RS resources.

In one example, at least one of the N_{TRP} configured CSI-RS resources is configured with CBSR, and remaining configured CSI-RS resources can be optionally configured with CBSR, i.e. the remaining CSI-RS resources can be configured with CBSR or can be configured without CBSR.

In one example, one of the N_{TRP} configured CSI-RS resources is always configured with CBSR, and remaining (N_{TRP}−1) configured CSI-RS resources can be optionally configured with CBSR.

In one example, CSI-RS-resource-specific vector group restriction and CSI-RS-resource-specific hard amplitude restriction are allowed to configure for the CSI-RS resources that are configured with CBSR. For example, CSI-RS-resource-specific vector group restriction and CSI-RS-resource-specific hard amplitude restriction described in examples/embodiments described herein can be configured for the CSI-RS resources that are configured with CBSR.

| | |
|---|---|
| Need | Specified |
| S | Used for (configuration) fields, whose field description or |
| | procedure specifies the UE behaviour performed upon receiving a |
| | message with the field absent (and not if field description or |
| | procedure specifies the UE behaviour when field is not |
| | configured). |
| Need | Maintain |
| M | Used for (configuration) fields that are stored by the UE i.e. |
| | not one-shot. Upon receiving a message with the field absent, |
| | the UE maintains the current value. |
| Need | No action (one-shot configuration that is not maintained) |
| N | Used for (configuration) fields that are not stored and whose |
| | presence causes a one-time action by the UE. Upon receiving |
| | message with the field absent, the UE takes no action. |
| Need | Release |
| R | Used for (configuration) fields that are stored by the UE i.e., |
| | not one-shot. Upon receiving a message with the field absent, |
| | the UE releases the current value. |

In one embodiment, for any embodiment/example shown in disclosure, there is at least one of N_{TRP} CSI-RS resources regarding CBSR with the field having Optional, Need S.

In one example, on the following parameter (or corresponding parameter as shown in each example of this disclosure), “n1-n2-codebookSubsetRestriction” is the number of antenna ports in first (n1) and second (n2) dimension and codebook subset restriction (see TS 38.214 [19] clause 5.2.2.2.3). Also, the number of bits for codebook subset restriction is CEIL(log 2(nchoosek(O1*O2,4)))+8*n1*n2 where nchoosek(a,b)=a!/(b!(a−b)!). This is according to the following example: if the field is absent, the UE will assume that the UE is not configured with any codebook subset restriction for the corresponding CSI-RS resource. The UE will also assume that (N1,N2) value for this CSI-RS resource is the same as that for a CSI-RS resource for which this field is present (configured/provided) in the associated CSI-ReportConfig. This field is present (configured/provided) for at least one of Nₜᵣₚ CSI-RS resources in the associated CSI-ReportConfig.

In one example, the parameter (or corresponding parameter as shown in each example of this disclosure), “n1-n2-codebookSubsetRestriction” is shown as follows:

```
n1-n2-codebookSubsetRestriction-r18 CHOICE {
      two-one BIT STRING (SIZE (16)),
      two-two BIT STRING (SIZE (43)),
      four-one BIT STRING (SIZE (32)),
      three-two BIT STRING (SIZE (59)),
      six-one BIT STRING (SIZE (48)),
      four-two BIT STRING (SIZE (75)),
      eight-one BIT STRING (SIZE (64)),
      four-three BIT STRING (SIZE (107)),
      six-two BIT STRING (SIZE (107)),
      twelve-one BIT STRING (SIZE (96)),
      four-four BIT STRING (SIZE (139)),
      eight-two BIT STRING (SIZE (139)),
      sixteen-one BIT STRING (SIZE (128))
    },
  OPTIONAL, -- Need S
```

In another example, the parameter (or corresponding parameter as shown in each example of this disclosure), “n1-n2-codebookSubsetRestriction” is shown as follows:

```
n1-n2-codebookSubsetRestriction-r18 CHOICE {
    two-one BIT STRING (SIZE (8)),
    two-two BIT STRING (SIZE (27)),
    four-one BIT STRING (SIZE (16)),
    three-two BIT STRING (SIZE (35)),
    six-one BIT STRING (SIZE (24)),
    four-two BIT STRING (SIZE (43)),
    eight-one BIT STRING (SIZE (32)),
    four-three BIT STRING (SIZE (59)),
    six-two BIT STRING (SIZE (59)),
    twelve-one BIT STRING (SIZE (48)),
    four-four BIT STRING (SIZE (75)),
    eight-two BIT STRING (SIZE (75)),
    sixteen-one BIT STRING (SIZE (64))
  },
    OPTIONAL, -- Need S
```

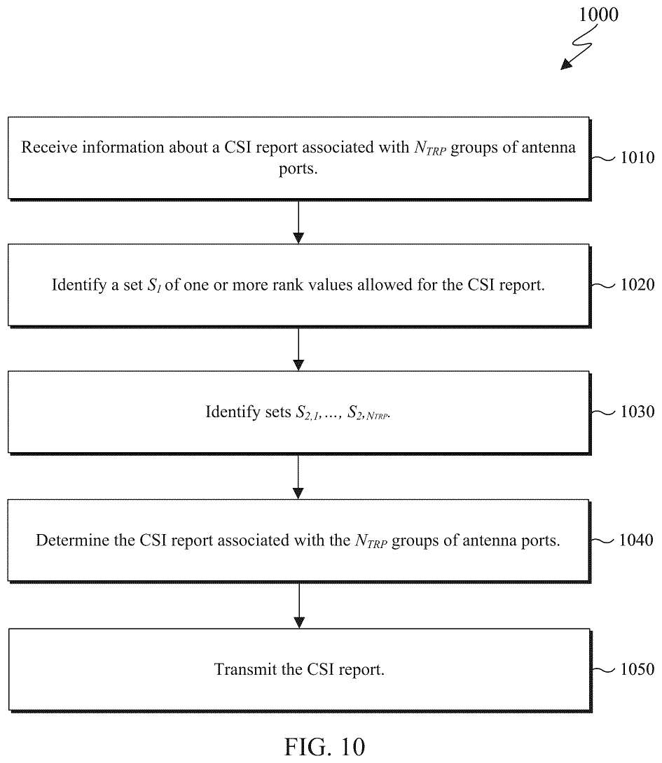

FIG. 10 illustrates an example method 1000 performed by a UE in a wireless communication system according to embodiments of the present disclosure. The method 1000 of FIG. 10 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1000 is for illustration only and other embodiments can be used without departing from the scope of the present disclosure.

The method begins with the UE receiving information about a CSI report associated with N_{TRP}>1 groups of antenna ports (1010). For example, in 1010, the information indicates (i) a CJT codebook, (ii) a rank restriction, and (iii) N_{TRP} CBSRs. The UE then identifies a set S₁ of one or more rank values allowed for the CSI report (1020). For example, in 1020, the UE identifies the set S₁ based on the rank restriction.

The UE then identifies sets S_{2,1}, . . . , S_{2,N}_{_{TRP}} (1030). For example, in 1030, the UE identifies the sets based on the N_{TRP} CBSRs. Also, for n=1, . . . , N_{TRP}, the set S_{2,n} is associated with n-th groups of antenna ports of the N_{TRP} groups of antenna ports. The set S_{2,n} includes SD basis vectors that are allowed for the CSI report.

The UE then determines the CSI report associated with the N_{TRP} groups of antenna ports (1040). For example, in 1040, the CSI report is determined based on the CJT codebook, the set S₁, and the sets S_{2,1}, . . . , S_{2,N}_{_{TRP}}. The UE then transmits the CSI report (1050).

In one or more embodiments, the information includes information about N_{TRP} NZP CSI-RS resources each associated with one of the N_{TRP} groups of antenna ports, the UE is measures the N_{TRP} NZP CSI-RS resources, and the CSI report is determined based on the measurement.

In one or more embodiments, the rank restriction indicates a set of restricted rank values that are not allowed for the CSI report and the CBSRs indicate a set of SD basis vectors that are not allowed for the CSI report.

In one or more embodiments, the rank restriction corresponds to a bit sequence r=r₃r₂r₁r₀, and when rᵢ is zero for i∈{0, 1, . . . , 3}, information associated with a rank value of i+1 is not allowed for the CSI report.

In one or more embodiments, the CBSRs correspond to a bit sequence Bₙ=B_{1,n}B_{2,n} for each antenna group n=1, . . . , N_{TRP}, where: B_{1,n} is used to indicate restriction on SD vector groups for each antenna group n=1, . . . , N_{TRP} and B_{2,n} is used to indicate restriction on SD vectors in each of the SD vector groups for each antenna group n=1, . . . , N_{TRP}.

In one or more embodiments, B_{1,n} is a bit sequence indicating four SD vector groups among O₁O₂ SD vector groups, where Oⱼ is an oversampling factor associated with length-N₁ discrete Fourier transform (DFT) vectors for j-th antenna port dimension, j∈{1,2}, and the four SD vector groups are allowed for the CSI report.

In one or more embodiments, B_{2,n} is a bit sequence, where every two-bits of B_{2,n} either having ‘00’ or ‘11’ indicates each of the SD vectors either not allowed or allowed for the CSI report.

In one or more embodiments, B_{2,n} is a bit sequence, where each bit of B_{2,n} either having ‘0’ or ‘1’ indicates each of the SD vectors either not allowed or allowed for the CSI report.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a channel state information (CSI) report associated with N_{TRP}>1 groups of antenna ports, the information indicating (i) a coherent joint transmission (CJT) codebook, (ii) a rank restriction, and (iii) N_{TRP} codebook subset restrictions (CBSRs); and
a processor operably coupled to the transceiver, the processor configured to:
identify, based on the rank restriction, a set S₁ of one or more rank values allowed for the CSI report,
identify, based on the N_{TRP} CBSRs, sets S_{2,1}, . . . , S_{2,N}_{_{TRP}}, where for n=1, . . . , N_{TRP}, the set S_{2,n} is associated with n-th groups of antenna ports of the N_{TRP} groups of antenna ports and wherein the set S_{2,n} includes spatial-domain (SD) basis vectors that are allowed for the CSI report, and
determine the CSI report associated with the N_{TRP} groups of antenna ports based on the CJT codebook, the set S₁, and the sets S_{2,1}, . . . , S_{2,N}_{_{TRP}},
wherein the transceiver is further configured to transmit the CSI report.

2. The UE of claim 1, wherein:
the information includes information about N_{TRP} non-zero power (NZP) CSI reference signal (CSI-RS) resources, each associated with one of the N_{TRP} groups of antenna ports,
the processor is further configured to measure the N_{TRP} NZP CSI-RS resources, and
the CSI report is determined based on the measurement.

3. The UE of claim 1, wherein:
the rank restriction indicates a set of restricted rank values that are not allowed for the CSI report, and
the CBSRs indicate a set of SD basis vectors that are not allowed for the CSI report.

4. The UE of claim 3, wherein:
the rank restriction corresponds to a bit sequence r=r₃r₂r₁r₀, and
when rᵢ is zero for i∈{0, 1, . . . , 3}, information associated with a rank value of i+1 is not allowed for the CSI report.

5. The UE of claim 3, wherein the CBSRs correspond to a bit sequence Bₙ=B_{1,n}B_{2,n} for each antenna group n=1, . . . , N_{TRP}, where:
B_{1,n} is used to indicate restriction on SD vector groups for each antenna group n=1, . . . , N_{TRP}, and
B_{2,n} is used to indicate restriction on SD vectors in each of the SD vector groups for each antenna group n=1, . . . , N_{TRP}.

6. The UE of claim 5, wherein B_{1,n} is a bit sequence indicating four SD vector groups among O₁O₂ SD vector groups, where:
Oⱼ is an oversampling factor associated with length-Nⱼ discrete Fourier transform (DFT) vectors for j-th antenna port dimension,
j∈{1,2}, and
the four SD vector groups are allowed for the CSI report.

7. The UE of claim 5, wherein B_{2,n} is a bit sequence, where every two-bits of B_{2,n} either having ‘00’ or ‘11’ indicates each of the SD vectors either not allowed or allowed for the CSI report.

8. The UE of claim 5, wherein B_{2,n} is a bit sequence, where each bit of B_{2,n} either having ‘0’ or ‘1’ indicates each of the SD vectors either not allowed or allowed for the CSI report.

9. A base station (BS) comprising:
a processor configured to identify information about a channel state information (CSI) report associated with N_{TRP}>1 groups of antenna ports, the information indicating (i) a coherent joint transmission (CJT) codebook, (ii) a rank restriction, and (iii) N_{TRP} codebook subset restrictions (CBSRs); and
a transceiver operably coupled to the processor, the transceiver configured to:
transmit the information the CSI report, and
receive the CSI report,
wherein the rank restriction indicates a set S₁ of one or more rank values allowed for the CSI report,
wherein the N_{TRP} CBSRs indicate sets S_{2,1}, . . . , S_{2,N}_{_{TRP}}, where for n=1, . . . , N_{TRP}, the set S_{2,n} is associated with n-th groups of antenna ports of the N_{TRP} groups of antenna ports and wherein the set S_{2,n} includes spatial-domain (SD) basis vectors that are allowed for the CSI report, and
wherein the CSI report is associated with the N_{TRP} groups of antenna ports and is based on the CJT codebook, the set S₁, and the sets S_{2,1}, . . . , S_{2,N}_{_{TRP}}.

10. The BS of claim 9, wherein:
the information includes information about N_{TRP} non-zero power (NZP) CSI reference signal (CSI-RS) resources, each associated with one of the N_{TRP} groups of antenna ports, and
the CSI report is based on the N_{TRP} NZP CSI-RS resources.

11. The BS of claim 9, wherein:
the rank restriction indicates a set of restricted rank values that are not allowed for the CSI report, and
the CBSRs indicate a set of SD basis vectors that are not allowed for the CSI report.

12. The BS of claim 11, wherein:
the rank restriction corresponds to a bit sequence r=r₃r₂r₁r₀, and
when rᵢ is zero for i∈{0, 1, . . . , 3}, information associated with a rank value of i+1 is not allowed for the CSI report.

13. The BS of claim 11, wherein the CBSRs correspond to a bit sequence Bₙ=B_{1,n}B_{2,n} for each antenna group n=1, . . . , N_{TRP}, where:
B_{1,n} is used to indicate restriction on SD vector groups for each antenna group n=1, . . . , N_{TRP}, and
B_{2,n} is used to indicate restriction on SD vectors in each of the SD vector groups for each antenna group n=1, . . . , N_{TRP}.

14. The BS of claim 13, wherein B_{1,n} is a bit sequence indicating four SD vector groups among O₁O₂ SD vector groups, where:
Oⱼ is an oversampling factor associated with length-Nⱼ discrete Fourier transform (DFT) vectors for j-th antenna port dimension,
j∈{1,2}, and
the four SD vector groups are allowed for the CSI report.

15. The BS of claim 13, wherein B_{2,n} is a bit sequence, where every two-bits of B_{2,n} either having ‘00’ or ‘11’ indicates each of the SD vectors either not allowed or allowed for the CSI report.

16. The BS of claim 13, wherein B_{2,n} is a bit sequence, where each bit of B_{2,n} either having ‘0’ or ‘1’ indicates each of the SD vectors either not allowed or allowed for the CSI report.

17. A method performed by a user equipment (UE), the method comprising:
receiving information about a channel state information (CSI) report associated with N_{TRP}>1 groups of antenna ports, the information indicating (i) a coherent joint transmission (CJT) codebook, (ii) a rank restriction, and (iii) N_{TRP} codebook subset restrictions (CBSRs);
identifying, based on the rank restriction, a set S₁ of one or more rank values allowed for the CSI report;
identifying, based on the N_{TRP} CBSRs, sets S_{2,1}, . . . , S_{2,N}_{_{TRP}}, where for n=1, . . . , N_{TRP}, the set S_{2,n} is associated with n-th groups of antenna ports of the N_{TRP} groups of antenna ports and wherein the set S_{2,n} includes spatial-domain (SD) basis vectors that are allowed for the CSI report;
determining the CSI report associated with the N_{TRP} groups of antenna ports based on the CJT codebook, the set S₁, and the sets S_{2,1}, . . . , S_{2,N}_{_{TRP}}; and
transmitting the CSI report.

18. The method of claim 17, wherein:
the information includes information about N_{TRP} non-zero power (NZP) CSI reference signal (CSI-RS) resources, each associated with one of the N_{TRP} groups of antenna ports,
the method further comprises measuring the N_{TRP} NZP CSI-RS resources, and
determining the CSI report further comprises determining the CSI report based on the measurement.

19. The method of claim 17, wherein:
the rank restriction indicates a set of restricted rank values that are not allowed for the CSI report, and
the CBSRs indicate a set of SD basis vectors that are not allowed for the CSI report.

20. The method of claim 19, wherein:
the rank restriction corresponds to a bit sequence r=r₃r₂r₁r₀, and
when rᵢ is zero for i∈{0, 1, . . . , 3}, information associated with a rank value of i+1 is not allowed for the CSI report.
